(19) United States
(12) Patent Application Publication
(10) Pub. No.: US 2025/0392711 A1
(43) Pub. Date: Dec. 25, 2025

(54) ENCODING METHOD, DECODING METHOD, BITSTREAM, ENCODER, DECODER AND STORAGE MEDIUM

(71) Applicant: GUANGDONG OPPO MOBILE TELECOMMUNICATIONS CORP., LTD., Dongguan (CN)

(72) Inventors: Junyan HUO, Dongguan (CN); Yanzhuo MA, Dongguan (CN); Fuzheng YANG, Dongguan (CN); Wenhan QIAO, Dongguan (CN); Ming LI, Dongguan (CN)

(21) Appl. No.: 19/257,821

(22) Filed: Jul. 2, 2025

Related U.S. Application Data
(63) Continuation of application No. PCT/CN2023/070559, filed on Jan. 4, 2023.

(51) Int. Cl. H04N 19/117; H04N 19/105; H04N 19/176; H04N 19/80

(52) U.S. Cl. CPC H04N 19/117; H04N 19/105; H04N 19/176; H04N 19/80

(57) ABSTRACT

An encoding method includes: determining a first template of a current block, and determining a matching template and a reference block; determining model parameters according to the first template and the matching template; performing filtering on the reference block according to the model parameters to determine a filtered reference block; determining a prediction value of the current block according to the filtered reference block; and determining a reconstructed value of the current block according to the prediction value of the current block.

### CROSS-REFERENCE TO RELATED APPLICATIONS

This application is a continuation of International Application No. PCT/CN2023/070559 filed on Jan. 4, 2023, which is incorporated herein by reference.

### TECHNICAL FIELD

The present disclosure relates to the field of video encoding and decoding technologies, and in particular, to an encoding method, a decoding method, a bitstream, an encoder, a decoder and a storage medium.

### BACKGROUND

An intra template matching prediction (Intra TMP) technology searches for, according to a preset cost function, a matching template with the minimum cost relative to a template of a coding block within a predefined search range in a current picture through a template of a coding block, and uses the best matching reconstructed block corresponding to the matching template as a prediction block of the current coding block.

In an actual encoding process, reconstructed samples of the best matching reconstructed block are usually directly used as predicted samples of the current coding block. However, due to incomplete consideration, there will be large deviations in some scenarios, resulting in low prediction accuracy.

### SUMMARY

The technical solutions of the present disclosure may be implemented as follows.

In a first aspect, embodiments of the present disclosure provide a decoding method, which is applied to a decoder, and the method includes:
determining a first template of a current block, and determining a matching template and a reference block;
determining model parameters according to the first template and the matching template;
performing filtering on the reference block according to the model parameters to determine a filtered reference block;
determining a prediction value of the current block according to the filtered reference block; and
determining a reconstructed value of the current block according to the prediction value of the current block.

In a second aspect, embodiments of the present disclosure provide an encoding method, which is applied to an encoder, and the method includes:
determining a first template of the current block, and determining a matching template and a reference block;
determining model parameters according to the first template and the matching template;
performing filtering on the reference block according to the model parameters to determine a filtered reference block;
determining a prediction value of the current block according to the filtered reference block; and
determining a prediction residual of the current block according to the prediction value of the current block.

In a third aspect, embodiments of the present disclosure provide a bitstream, and the bitstream is generated by bit encoding according to information to be encoded. The information to be encoded includes at least one of the following:
a prediction residual of a current block, a number of coefficients of a target filter, a shape of the target filter, a value of first syntax element flag information, and a value of second syntax element flag information; where the first syntax element flag information is used to indicate whether intra template matching is applied to the current block, and the second syntax element flag information is used to indicate whether a filter model is applied to the current block.

In a fourth aspect, embodiments of the present disclosure provide an encoder, and the encoder includes a first determining unit, a first filtering unit, and a first predicting unit;
the first determining unit is configured to determine a first template of a current block and to determine a matching template and a reference block, and is further configured to determine model parameters according to the first template and the matching template;
the first filtering unit is configured to perform filtering on the reference block according to the model parameters to determine a filtered reference block;
the first predicting unit is configured to determine a prediction value of the current block according to the filtered reference block; and
the first determining unit is further configured to determine a prediction residual of the current block according to the prediction value of the current block.

In a fifth aspect, embodiments of the present disclosure provide an encoder, and the encoder includes a first memory and a first processor;
the first memory is configured to store a computer program that is capable of running on the first processor; and
the first processor is configured to perform the methods described in the second aspect when running the computer program.

In a sixth aspect, embodiments of the present disclosure provide a decoder, and the decoder includes a second determining unit, a second filtering unit, and a second predicting unit;
the second determining unit is configured to determine a first template of a current block, and to determine a matching template and a reference block, and is further configured to determine model parameters according to the first template and the matching template;
the second filtering unit is configured to perform filtering on the reference block according to the model parameters to determine a filtered reference block;
the second predicting unit is configured to determine a prediction value of the current block according to the filtered reference block; and
the second determining unit is further configured to determine a reconstructed value of the current block according to the prediction value of the current block.

In a seventh aspect, embodiments of the present disclosure provide a decoder, and the decoder includes a second memory and a second processor;
the second memory is configured to store a computer program that is capable of running on the second processor; and
the second processor is configured to perform the methods described in the first aspect when running the computer program.

In an eighth aspect, embodiments of the present disclosure provide a non-transitory computer-readable storage medium and a bitstream, which has stored a computer program. The computer program which, when executed by a processor, implements the methods as described in the second aspect to generate the bitstream.

### BRIEF DESCRIPTION OF THE DRAWINGS

FIG. 1 is a schematic diagram of a prediction process of an Intra TMP technology;

FIG. 2 is a schematic diagram of a prediction process based on an Intra TMP technology;

FIGS. 3A to 3F are a schematic diagrams of template types of an Intra TMP technology;

FIG. 4A is a schematic block diagram showing components of an encoder provided in embodiments of the present disclosure;

FIG. 4B is a schematic block diagram showing components of a decoder provided in embodiments of the present disclosure;

FIG. 5 is a schematic diagram of a network architecture of an encoding and decoding system provided in embodiments of the present disclosure;

FIG. 6 is a schematic flowchart of a decoding method provided in embodiments of the present disclosure;

FIGS. 7A to 7H are schematic diagrams of partitioning a search region into different sub-regions provided in embodiments of the present disclosure;

FIG. 8 is a schematic diagram of a prediction process based on an Intra TMP-FLM technology provided in embodiments of the present disclosure;

FIG. 9 is a schematic diagram of a search process based on an Intra TMP technology provided in embodiments of the present disclosure;

FIG. 10 is a schematic diagram of parameter definition of a current block and its template provided in embodiments of the present disclosure;

FIG. 11 is a schematic diagram of a template search region provided in embodiments of the present disclosure;

FIG. 12 is a schematic diagram of a determination process of a specific search region provided in embodiments of the present disclosure;

FIG. 13 is a schematic flowchart of a search process provided in embodiments of the present disclosure;

FIG. 14 is a schematic diagram of a shape of a filter provided in embodiments of the present disclosure;

FIG. 15 is a schematic flowchart of calculating filter coefficients provided in embodiments of the present disclosure;

FIG. 16A is a schematic diagram showing a component of filter coefficients provided in embodiments of the present disclosure;

FIG. 16B is a schematic diagram showing a component of a predicted sample provided in embodiments of the present disclosure;

FIG. 17 is a schematic diagram of another determination process of a specific search region provided in embodiments of the present disclosure;

FIG. 18 is a schematic diagram of yet another determination process of a specific search region provided in embodiments of the present disclosure;

FIG. 19 is a schematic diagram of still another determination process of a specific search region provided in embodiments of the present disclosure;

FIG. 20 is a schematic flowchart of an encoding method provided in embodiments of the present disclosure;

FIG. 21 is a schematic diagram of a component structure of an encoder provided in embodiments of the present disclosure;

FIG. 22 is a schematic diagram of a specific hardware structure of an encoder provided in embodiments of the present disclosure;

FIG. 23 is a schematic diagram of a component structure of a decoder provided in embodiments of the present disclosure;

FIG. 24 is a schematic diagram of a specific hardware structure of a decoder provided in embodiments of the present disclosure; and

FIG. 25 is a schematic diagram of a component structure of an encoding and decoding system provided in embodiments of the present disclosure.

### DETAILED DESCRIPTION

In order to have a more detailed understanding of the characteristics and technical contents of the embodiments of the present disclosure, the implementation of the embodiments of the present disclosure is described in detail below with reference to the drawings. The drawings are for reference only and are not used to limit the embodiments of the present disclosure.

Unless defined otherwise, all technical and scientific terms used herein have the same meanings as those commonly understood by a person skilled in the art to which the present disclosure belongs. The terms used herein are only for the purpose of describing the embodiments of the present disclosure and are not intended to limit the present disclosure.

In the following description, “some embodiments” is referenced, which describes a subset of all possible embodiments, but it can be understood that “some embodiments” may be a same subset or different subsets of all possible embodiments and may be combined with each other without conflict. It should also be pointed out that the terms “first\second\third” involved in the embodiments of the present disclosure are only used to distinguish similar objects and do not represent a specific ordering of the objects. It can be understood that “first\second\third” can be interchanged in a specific order or sequence if allowed, so that the embodiments of the present disclosure described herein may be implemented in an order other than that illustrated or described herein.

Before the embodiments of the present disclosure are further described in detail, the nouns and terms involved in the embodiments of the present disclosure are described first. The nouns and terms involved in the embodiments of the present disclosure are subject to the following interpretations:
coding block (CB);
block matching (BM);
coding unit (CU);
block vector (BV);
sum of absolute difference (SAD);
sum of absolute transformed difference (SATD);
mean square error (MSE);
sum of squared differences (SSD);
mean absolute deviation (MAD);
mean square differences (MSD);
normalized correlation coefficient (NCC);
H.266/versatile video coding (VVC);
reference software test platform for VVC (VVC Test Model, VTM);
intra template matching prediction (Intra TMP); and
reference software test platform for beyond VVC (Enhanced Compression Model, ECM).

It can be understood that in a video picture, a first color component, a second color component, and a third color component are generally used to represent a coding block. The three color components are a luma component, a blue chroma component and a red chroma component. Specifically, the luma component is usually represented by the symbol Y, the blue chroma component is usually represented by the symbol Cb or U, and the red chroma component is usually represented by the symbol Cr or V; in this way, the video picture may be represented in YCbCr format, or may also be represented in YUV format.

It can also be understood that Intra TMP is a special intra prediction mode. Both an encoder and a decoder search for, according to a preset cost function, a matching template (T_BEST) with the minimum cost within a predefined search range in a current picture through a template (T) of a coding block. An offset of the best matching template relative to the template of the current coding block is the best block vector (BV_BEST), and then a reconstructed block (Ref Block) corresponding to the matching template is used as a prediction block of the current coding block (Cur Block). The template of the coding block is usually selected from adjacent reconstructed regions of the current coding block.

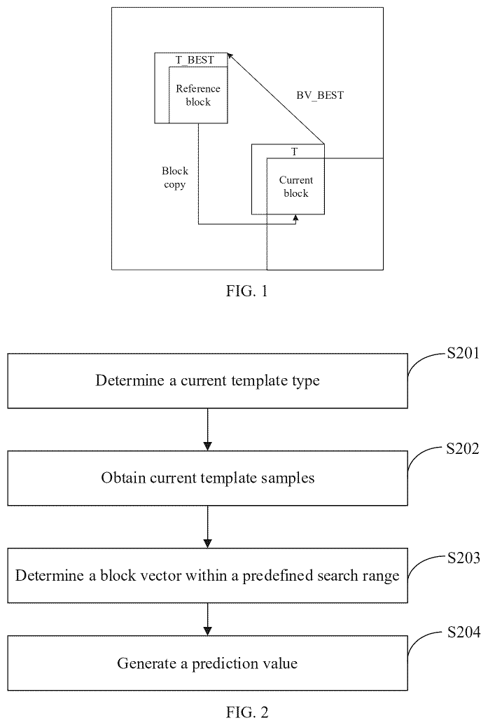

Exemplarily, the adjacent reconstructed region of the current block is taken as an example, as illustrated in FIG. 1, the region filled with vertical lines represents the reconstructed region, the block filled with grid is the current block, and the adjacent region of the current block is the first template T; the block filled with diagonal lines is the reference block, and the adjacent region of the reference block is the second template (i.e., “reference template” or “matching template”, T_BEST). An offset of the second template relative to the first template is the best block vector (BV_BEST), and in this case, block copy is performed on the reference block to be used as the prediction block of the current block.

In the embodiments of the present disclosure, the preset cost function may be sum of absolute difference (SAD), sum of absolute transformed difference (SATD), mean square error (MSE), sum of squared differences (SSD), mean absolute deviation (MAD), mean square differences (MSD), normalized correlation coefficient (NCC), or the like, which is not specifically limited here.

The sum of absolute difference (SAD) is taken as an example; in this case, the cost function is as follows:

$$SAD ( {T}_{i} ) = {\sum }_{m = 0}^{M - 1} \vert {T}_{i , m} - {T}_{m} \vert , m = 0 , 1 , … , M - 1 \qquad ( 1 )$$

where Tᵢ is a template in a search process, and M represents the number of samples in the template.

The prediction process of an Intra TMP technology is introduced in detail below.

Input of the Intra TMP technology: a position of the current block (xTbCmp, yTbCmp), a width of the current block (nTbW), and a height of the current block (nTbH).

Output of the Intra TMP technology: a prediction value of the current block (predSamples[x][y]), where x=0 . . . nTbW−1, and y=0 . . . nTbH−1.

Specifically, the prediction process of the Intra TMP technology may be partitioned into four steps: determining a current template type, obtaining reconstructed samples of the current template, determining a block vector within a predefined search range, and generating a prediction value. In this way, the prediction value of the current block may be obtained through the above process. It should be noted that the Intra TMP technology may be used to predict the luma component or the chroma component, which is not specifically limited here.

Referring to FIG. 2, it is a schematic diagram showing a prediction process based on an Intra TMP technology. As illustrated in FIG. 2, the process may include the following steps.

In S201, a current template type is determined.

It should be noted that the Intra TMP technology uses reconstructed samples adjacent to the current block as a template to search for a matching template within a predefined search region. The neighboring reconstructed samples may be top reference samples, top-left reference samples, top-right reference samples, left reference samples or bottom-left reference samples of the current block. Therefore, according to whether the neighboring reconstructed samples are available, template types may be classified, and the corresponding template type may be determined.

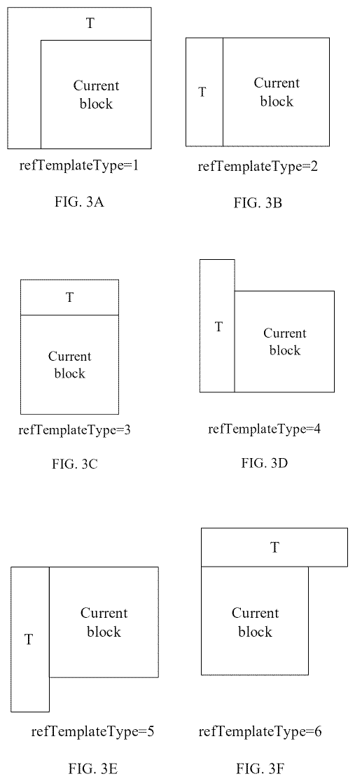

It should also be noted that refTemplateType may be used to represent a template type. FIGS. 3A to 3F is a schematic diagram showing template types of the Intra TMP technology. As illustrated in FIGS. 3A to 3B, the block filled with grid is the current block, an adjacent region of the current block is the template T, and six template types are shown here.

By way of example, the six template types are as follows:

in a case where the top-left reference samples, the top reference samples, and the left reference samples are all available, the value of refTemplateType is 1, and the template shape is illustrated in FIG. 3A;

in a case where only the left reference samples are available, the value of refTemplate Type is 2, and the template shape is illustrated in FIG. 3B;

in a case where only the top reference samples are available, the value of refTemplateType is 3, and the template shape is illustrated in FIG. 3C;

in a case where only the left reference samples and the top-left reference samples are available, the value of refTemplateType is 4, and the template shape is illustrated in FIG. 3D;

in a case where only the left reference samples and the bottom-left reference samples are available, the value of refTemplateType is 5, and the template shape is illustrated in (e) in FIG. 3;

and in a case where only the top reference samples and the top-right reference samples are available, the value of refTemplate Type is 6, and the template shape is illustrated in FIG. 3F.

In S202, current template samples are obtained.

It should be noted that the template of the Intra TMP technology may be composed of reconstructed samples in one or more regions of the top, top-right, left, bottom-left, and top-left regions of the current block. In addition, a template size may be set in advance. For example, when a left template is obtained, a template width (templateW_size) may be set to 4; or when a top template is obtained, a template height (templateH_size) may be set to 4.

It should also be noted that the value of refTemplateType may be used to determine which part of the reconstructed samples to be obtained. For example, in a case where the value of refTemplateType is 1, the reconstructed samples on the left, top-left and top sides of the current block are obtained; or in a case where the value of refTemplateType is 2, only four columns of reconstructed samples on the left side of the current block are obtained; or in a case where the value of refTemplateType is 3, only four rows of reconstructed samples on the top side of the current block are obtained.

In S203, a block vector is determined within a predefined search range.

It should be noted that a search process of the Intra TMP technology is mainly partitioned into an initialization process, determining a search region of the template in the current frame, searching and determining the best block vector within the search region.

It should also be noted that, when the best matching template is searched within the search region, a search strategy of a coarse search followed by a fine search may be adopted, or only a fine search may be performed, or only a coarse search may be performed, which is not specifically limited here.

In the embodiments of the present disclosure, the coarse search may be that a first preset size (e.g., 2) is used to determine the best coarse matching template within the search region, or a downsampled template (e.g., a downsampling factor being 2) is used to determine the best coarse matching template within the search region.

In the embodiments of the present disclosure, the fine search may be that a second preset size (e.g., 1) is used to determine the best fine matching template within the search region, or the best fine matching template is determined near the best coarse matching template after the coarse search is performed.

In the embodiments of the present disclosure, the coarse search is performed first and then the fine search is performed, which may specifically be that the best coarse matching template is determined within the search region with the first preset size (e.g., 2), and then the best fine matching template is determined near the best coarse matching template with the second preset size (e.g., 1).

In this way, after the above processes are completed, the best block vector (BV_BEST, i.e., (pX_BEST, pY_BEST)) may be obtained, where pX_BEST is a horizontal offset of the best matching template relative to the template of the current block, and is a horizontal offset of the best matching reconstructed block relative to the current block; pY_BEST is a vertical offset of the best matching template relative to the template of the current block, and is a vertical offset of the best matching reconstructed block relative to the current block.

In S204, a prediction value is generated.

Here, a simple translation copy may be used. The specific process is as follows:

$$For x = 0 … nTbW - 1 , y = 0 … nTbH - 1 ; \qquad ( 2 )$$

$$predSamples [ x ] [ y ] = recSamples [ x + pX\_BEST ] [ y + pY\_BEST ]$$

where recSamples represents the reconstructed samples of the current frame.

In brief, generally, the Intra TMP technology searches for, according to a preset cost function, a matching template relative to a template of a coding block with the minimum cost within a predefined search range in a current picture through a template of the current block, and uses the best matching reconstructed block (Ref Block) corresponding to the matching template as a prediction block of the current block (Cur Block). The template of the current block may usually be selected from adjacent reconstructed regions of the current block.

However, in the actual encoding process, reconstructed samples of the best matching reconstructed block are directly used as predicted samples of the current block, which is not an optimal solution in some cases. For example, when there is a linear illumination change between the best matching reconstructed block and the current block, if the reconstructed samples of the best matching reconstructed block are directly used as the predicted samples of the current block, there will be a large deviation, resulting in low prediction accuracy and failure to achieve the optimal prediction effect.

Based on this, embodiments of the present disclosure provide an encoding method, and the method includes: determining a first template of a current block, and determining a matching template and a reference block; determining model parameters according to the first template and the matching template; performing filtering on the reference block according to the model parameters to determine a filtered reference block; determining a prediction value of the current block according to the filtered reference block; and determining a prediction residual of the current block according to the prediction value of the current block.

Embodiments of the present disclosure further provide a decoding method, and the method includes: determining a first template of a current block, and determining a matching template and a reference block; determining model parameters according to the first template and the matching template; performing filtering on the reference block according to the model parameters to determine a filtered reference block; determining a prediction value of the current block according to the filtered reference block; and determining a reconstructed value of the current block according to the prediction value of the current block.

In this way, whether it is an encoding side or a decoding side, the first template and the matching template are used to determine the model parameters. The model parameters fully reflect the correlation between the matching template and the first template of the current block; and this correlation is applied to the reference block to filter and correct reconstructed samples of the reference block, and then the filtered reconstructed samples are used as predicted samples of the current block. Thus, it may be possible to effectively correct the prediction value of the intra template matching technology, improve prediction accuracy, and save bit rate. In addition, the encoding and decoding efficiency may also be improved, thereby improving the encoding and decoding performance.

The various embodiments of the present disclosure will be described in detail below with reference to the drawings.

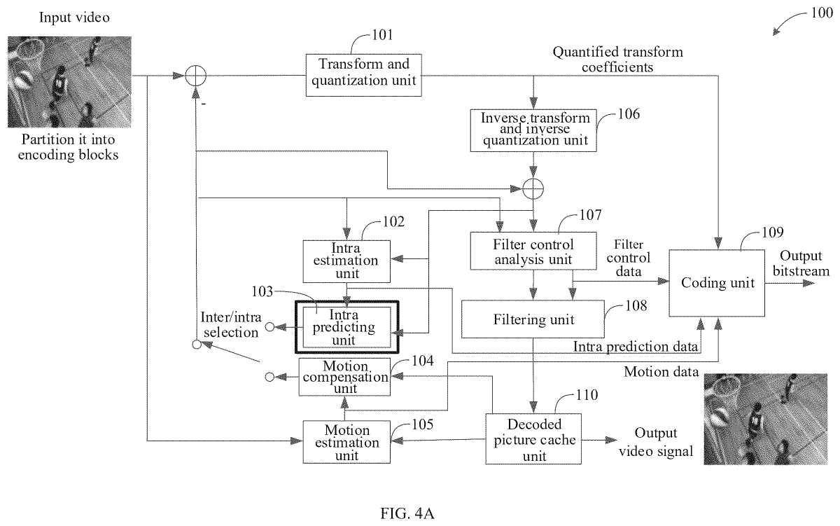

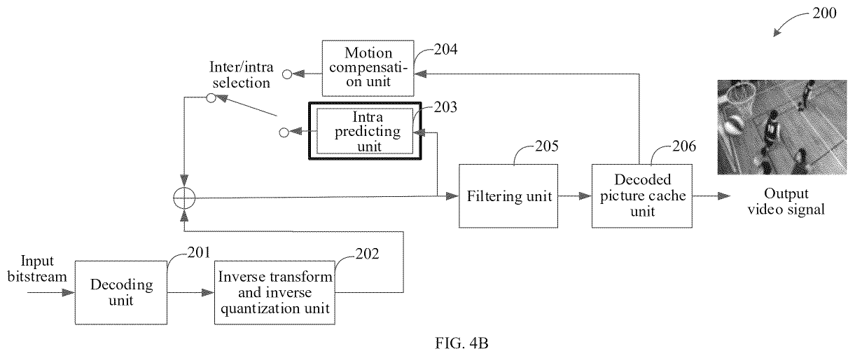

Referring to FIG. 4A, it is a schematic block diagram showing components of an encoder provided in embodiments of the present disclosure. As illustrated in FIG. 4A, the encoder (which is specifically a “video encoder”) 100 may include a transform and quantization unit 101, an intra estimation unit 102, an intra predicting unit 103, a motion compensation unit 104, a motion estimation unit 105, an inverse transform and inverse quantization unit 106, a filter control analysis unit 107, a filtering unit 108, a coding unit 109, and a decoded picture cache unit 110. The filtering unit 108 may implement deblocking filtering and sample adaptive offset (SAO) filtering, and the coding unit 109 may implement header information coding and context-based adaptive binary arithmetic coding (CABAC). For an original video signal that is input, a video coding block can be obtained by partitioning the coding tree unit (CTU), and then residual sample information obtained after intra prediction or inter prediction passes through the transform and quantization unit 101 to transform the video coding block, including transforming the residual information from the pixel domain to the transform domain, and quantizing the obtained transform coefficients to further reduce the bit rate. The intra estimation unit 102 and the intra predicting unit 103 are used to perform intra prediction on the video coding block. Specifically, the intra estimation unit 102 and the intra predicting unit 103 are used to determine an intra prediction mode to be used to encode the video coding block. The motion compensation unit 104 and the motion estimation unit 105 are used to perform inter prediction coding of the received video coding block relative to one or more blocks in one or more reference frames, so as to provide temporal prediction information. The motion estimation performed by the motion estimation unit 105 is a process for generating a motion vector, and the motion vector may estimate the motion of the video coding block; and then the motion compensation unit 104 performs the motion compensation based on the motion vector determined by the motion estimation unit 105. After the intra prediction mode is determined, the intra predicting unit 103 is further used to provide selected intra prediction data to the coding unit 109, and the motion estimation unit 105 transmits the motion vector data determined by calculating to the coding unit 109. In addition, the inverse transform and inverse quantization unit 106 is used to reconstruct the video coding block (to reconstruct the residual block in the pixel domain). The reconstructed residual block passes through the filter control analysis unit 107 and the filtering unit 108 to remove blocking artifacts, and the reconstructed residual block is then added to a predictive block in a frame of the decoded picture cache unit 110 to generate a reconstructed video coding block. The coding unit 109 is used to encode various encoding parameters and quantized transform coefficients. In the CABAC-based coding algorithm, context content may be based on an adjacent coding block and may be used to encode information indicating the determined intra prediction mode to output a bitstream of the video signal. The decoded picture cache unit 110 is used to store the reconstructed video coding block for prediction reference. As the video picture encoding proceeds, new reconstructed video coding blocks are continuously generated, and these reconstructed video coding blocks are stored in the decoded picture cache unit 110.

Referring to FIG. 4B, it is a schematic block diagram showing components of a decoder provided in embodiments of the present disclosure. As illustrated in FIG. 4B, the decoder (which is specifically a “video decoder”) 200 includes a decoding unit 201, an inverse transform and inverse quantization unit 202, an intra predicting unit 203, a motion compensation unit 204, a filtering unit 205, and a decoded picture cache unit 206. The decoding unit 201 may implement header information decoding and CABAC decoding, and the filtering unit 205 may implement deblocking filtering and SAO filtering. After the input video signal is encoded in FIG. 4A, the bitstream of the video signal is output. The bitstream is input to the decoder 200, and first passes through the decoding unit 201 to obtain decoded transform coefficients. The transform coefficients are processed by the inverse transform and inverse quantization unit 202 to generate a residual block in the pixel domain. The intra predicting unit 203 may be used to generate prediction data for the current video decoding block based on the determined intra prediction mode and the data from the previously decoded block of the current frame or picture. The motion compensation unit 204 determines prediction information for the video decoding block by analyzing the motion vector and other associated syntax elements, and uses the prediction information to generate a predictive block of the video decoding block being decoded. A decoded video block is formed by summing the residual block from the inverse transform and inverse quantization unit 202 and the corresponding predictive block generated by the intra predicting unit 203 or the motion compensation unit 204. The decoded video signal passes through the filtering unit 205 to remove the blocking artifacts, which may improve the video quality. The decoded video block is then stored in the decoded picture cache unit 206. The decoded picture cache unit 206 stores a reference picture used for subsequent intra prediction or motion compensation, and is further used for output of the video signal (that is, the restored original video signal is obtained).

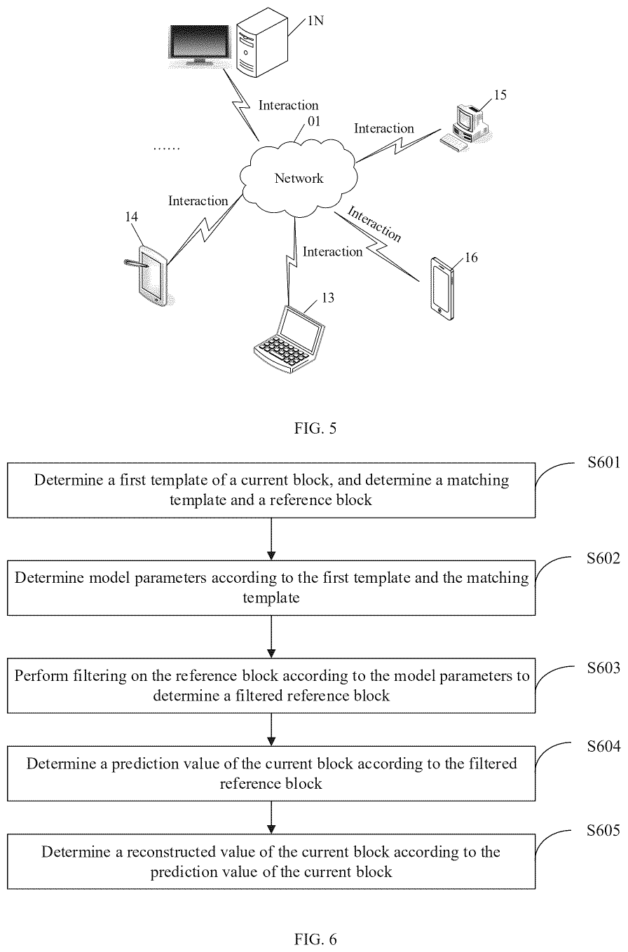

Furthermore, embodiments of the present disclosure further provide a network architecture of an encoding and decoding system including an encoder and a decoder. FIG. 5 is a schematic diagram showing a network architecture of an encoding and decoding system provided in embodiments of the present disclosure. As illustrated in FIG. 5, the network architecture includes one or more electronic devices 13 to IN, and a communication network 01, where the electronic devices 13 to IN may perform video interaction through the communication network 01. During the implementation process, the electronic devices may be various types of devices with video encoding and decoding functions. For example, the electronic devices may include smart phones, pads, personal computers, personal digital assistants, navigators, digital phones, video phones, televisions, sensor devices, or servers, which are not specifically limited here. In addition, the decoder or encoder described in the embodiments of the present disclosure may be the above-mentioned electronic devices.

It should be noted that the methods of the embodiments of the present disclosure are mainly applied to the intra predicting unit 103 illustrated in FIG. 4A and the intra predicting unit 203 illustrated in FIG. 4B. That is, the embodiments of the present disclosure may be applied to an encoder, or may be applied to a decoder, or may even be applied to both the encoder and the decoder at the same time, which is not specifically limited in the embodiments of the present disclosure.

It should also be noted that, in the case where the method is applied to the intra predicting unit 103, the “current block” specifically refers to a coding block currently to be intra-predicted; and in the case where the method is applied to the intra predicting unit 203, the “current block” specifically refers to a decoding block currently to be intra-predicted.

In a first clause, embodiments of the present disclosure provide a decoding method. The method is applied to a decoder and includes:
determining a first template of a current block, and determining a matching template and a reference block;
determining model parameters according to the first template and the matching template;
performing filtering on the reference block according to the model parameters to determine a filtered reference block;
determining a prediction value of the current block according to the filtered reference block; and
determining a reconstructed value of the current block according to the prediction value of the current block.

In a second clause, according to the first clause, determining the first template of the current block includes:
determining a template type of the current block; and
determining the first template of the current block according to the template type of the current block.

In a third clause, according to the second clause, determining the template type of the current block includes:
determining the template type of the current block according to reference samples of the current block, where
the reference samples of the current block include at least one of: left neighboring reference samples of the current block, top neighboring reference samples of the current block, top-left neighboring reference samples of the current block, bottom-left neighboring reference samples of the current block, or top-right neighboring reference samples of the current block.

In a fourth clause, according to the third clause, determining the template type of the current block includes:
if the left neighboring reference samples of the current block, the top neighboring reference samples of the current block, and the top-left neighboring reference samples of the current block are all available, determining the template type of the current block to be a first value;
if the left neighboring reference samples of the current block are available, determining the template type of the current block to be a second value;
if the top neighboring reference samples of the current block are available, determining the template type of the current block to be a third value;
if both the left neighboring reference samples of the current block and the top-left neighboring reference samples of the current block are available, determining the template type of the current block to be a fourth value;
if both the left neighboring reference samples of the current block and the bottom-left neighboring reference samples of the current block are available, determining the template type of the current block to be a fifth value; or
if both the top neighboring reference samples of the current block and the top-right neighboring reference samples of the current block are available, determining the template type of the current block to be a sixth value.

In a fifth clause, according to the first clause, determining the matching template and the reference block includes:
performing template matching within a preset search region according to the first template to determine the matching template; and
determining the reference block according to the matching template.

In a sixth clause, according to the fifth clause, performing template matching within the preset search region according to the first template to determine the matching template includes:
performing a search within the preset search region based on the first template to determine a target block vector, and determining the matching template according to the target block vector.

In a seventh clause, according to the first clause, determining the matching template and the reference block includes:
decoding a bitstream to determine motion parameters;
determining the reference block according to the motion parameters; and
determining the matching template according to the first template and the reference block.

In an eighth clause, according to the sixth clause, performing the search within the preset search region based on the first template to determine the target block vector includes: performing a first search within the preset search region to determine the target block vector; or performing a second search within the preset search region to determine the target block vector;
where a search step corresponding to the first search is greater than a search step corresponding to the second search.

In a ninth clause, according to the sixth clause, performing the search within the preset search region based on the first template to determine the target block vector includes:
performing a first search within the preset search region to determine a first block vector, and determining an initial matching template according to the first block vector; and
determining a first search region according to the initial matching template, and performing a second search within the first search region to determine the target block vector, where
a search step corresponding to the first search is greater than a search step corresponding to the second search, and the first search region is smaller than the preset search region.

In a tenth clause, according to the sixth clause, the preset search region includes at least one search sub-region; and performing the search within the preset search region based on the first template to determine the target block vector includes:
performing the search within the at least one search sub-region to determine a best block vector of each search sub-region and a corresponding matching cost value;
determining a best block vector corresponding to a minimum matching cost value according to the best block vector of each search sub-region and the corresponding matching cost value; and
using the best block vector corresponding to the minimum matching cost value as the target block vector.

In an eleventh clause, according to the tenth clause, performing the search within the preset search region based on the first template to determine the target block vector includes:
performing a first search within the at least one search sub-region to determine a best block vector of each search sub-region and a corresponding second search region;
performing a region determination according to the best block vector of each search sub-region and the corresponding second search region to determine at least two target search sub-regions participating in a second search;
performing the second search within the at least two target search sub-regions to determine a best block vector corresponding to the at least two target search sub-regions; and
using the best block vector corresponding to the at least two target search sub-regions as the target block vector.

In a twelfth clause, according to the first clause, determining the model parameters according to the first template and the matching template includes:
that the model parameters include coefficients of a target filter.

In a thirteenth clause, according to the twelfth clause, the method further includes:
determining the coefficients of the target filter according to a sample reference value in the first template and a sample reference value in the matching template.

In a fourteenth clause, according to the thirteenth clause, the method further includes:
that the coefficients of the target filter are coefficients used by the target filter in a case where a first error between an output value of the sample reference value in the matching template after being processed by the target filter and the sample reference value in the first template meets a first condition.

In a fifteenth clause, according to the fourteenth clause, the method further includes: that the first condition is that the first error is minimum.

In a sixteenth clause, according to the fourteenth clause, the method further includes: that the first condition is that the first error is within a first preset threshold range.

In a seventeenth clause, according to the fourteenth clause, the method further includes: that the first condition is that a variation of the first error is within a second preset threshold range.

In an eighteenth clause, according to the thirteenth clause, determining the coefficients of the target filter according to the sample reference value in the first template and the sample reference value in the matching template includes:
determining an autocorrelation parameter according to the sample reference value in the matching template;
determining a cross-correlation parameter according to the sample reference value in the first template and the sample reference value in the matching template; and
determining the coefficients of the target filter according to the autocorrelation parameter and the cross-correlation parameter.

In a nineteenth clause, according to the thirteenth clause, the sample reference value includes at least one of: a sample reconstructed value, a sample gradient value, or sample position information.

In a twentieth clause, according to the twelfth clause, a number of the coefficients of the target filter is equal to a first preset value.

In a twenty-first clause, according to the twelfth clause, the method further includes: decoding a bitstream to determine a number of the coefficients of the target filter.

In a twenty-second clause, according to the twelfth clause, the target filter is a one-dimensional or two-dimensional filter of a preset shape.

In a twenty-third clause, according to the twelfth clause, the method further includes: decoding a bitstream to determine a shape of the target filter.

In a twenty-fourth clause, according to the twelfth clause, performing filtering on the reference block according to the model parameters to determine the filtered reference block includes:
performing filtering on the reference block according to the model parameters to determine a first output value of the target filter; and
determining the filtered reference block based on the first output value of the target filter.

In a twenty-fifth clause, according to the twenty-fourth clause, performing filtering on the reference block according to the model parameters to determine the first output value of the target filter includes:
calculating a product of a sample reconstructed value of the reference block and a corresponding coefficient of the target filter; and
setting the first output value of the target filter to be equal to a sum of n products, where n represents a number of the coefficients of the target filter, and n is a positive integer.

In a twenty-sixth clause, according to the twenty-fourth clause, performing filtering on the reference block according to the model parameters to determine the first output value of the target filter includes:
determining a first value of a sample reconstructed value of the reference block under a first mapping relationship;
calculating a product of the first value and a corresponding coefficient of the target filter; and
setting the first output value of the target filter to be equal to a sum of n products, where n represents a number of the coefficients of the target filter, and n is a positive integer.

In a twenty-seventh clause, according to the twenty-fourth clause, determining the filtered reference block based on the first output value of the target filter includes:
determining a first offset value; and
performing an addition operation according to the first output value and the first offset value to determine the filtered reference block.

In a twenty-eighth clause, according to the twenty-seventh clause, determining the first offset value includes:
setting the first offset value to be equal to a second preset value.

In a twenty-ninth clause, according to the twenty-seventh clause, determining the first offset value includes:
if a number of the coefficients of the target filter is n, determining an (n+1)th coefficient of the target filter; and
determining the first offset value according to the (n+1)th coefficient and a second offset value.

In a thirteenth clause, according to the twenty-ninth clause, the method further includes:
setting the second offset value to be equal to a third preset value; or
setting the second offset value to be equal to a value of a sample reconstructed value of the reference block under a second mapping relationship.

In a thirty-first clause, according to the first clause, determining the prediction value of the current block according to the filtered reference block includes:
performing first processing on the filtered reference block to obtain the prediction value of the current block.

In a thirty-second clause, according to the thirty-first clause, the method further includes: that the first processing is that the prediction value of the current block is set to be equal to the filtered reference block.

In a thirty-third clause, according to the thirty-first clause, the method further includes: that the first processing is a clipping operation that limits the filtered reference block within a preset value range.

In a thirty-fourth clause, according to the first clause, the method further includes:
determining a plurality of groups of model parameters according to the first template and the matching template;
constructing a plurality of filter models according to the plurality of groups of model parameters, and performing filtering on the reference block according to the plurality of filter models to determine a plurality of filtered reference blocks respectively; and
determining the prediction value of the current block according to the plurality of filtered reference blocks.

In a thirty-fifth clause, according to the thirty-fourth clause, determining the prediction value of the current block according to the plurality of filtered reference blocks includes:
performing a weighted calculation on the plurality of filtered reference blocks to determine the prediction value of the current block.

In a thirty-sixth clause, according to the thirty-fourth clause, the method further includes: decoding a bitstream to determine a target model index value;
determining a corresponding target filter from the plurality of filter models according to the target model index value; and
performing filtering on the reference block according to the target filter to determine the prediction value of the current block.

In a thirty-seventh clause, according to the thirty-fourth clause, determining the plurality of groups of model parameters according to the first template and the matching template includes:
classifying reconstructed samples in the first template and reconstructed samples in the matching template according to a preset manner to obtain a plurality of groups of sub-templates and a plurality of groups of matching sub-templates respectively; and
determining the plurality of groups of model parameters according to the plurality of groups of sub-templates and the plurality of groups of matching sub-templates.

In a thirty-eighth clause, according to the first clause, the method further includes:
decoding a bitstream to determine a value of first syntax element flag information;
if the first syntax element flag information is used to indicate that intra template matching is applied to the current block, decoding the bitstream to determine a value of second syntax element flag information; and
if the second syntax element flag information is used to indicate that a filter model is applied to the current block, performing filtering on the reference block according to the model parameters to determine the filtered reference block; and determining the prediction value of the current block according to the filtered reference block.

In a thirty-ninth clause, according to the thirty-eighth clause, the method further includes:
if the second syntax element flag information is used to indicate that the filter model is not applied to the current block, using a reconstructed sample value in the reference block as the prediction value of the current block.

In a forty clause, according to any one of the first clause to the thirty-ninth clause, determining the reconstructed value of the current block according to the prediction value of the current block includes:
decoding a bitstream to determine a prediction residual of the current block; and
determining the reconstructed value of the current block according to the prediction value of the current block and the prediction residual of the current block.

In a forty-first clause, embodiments of the present disclosure provide an encoding method. The method is applied to an encoder and include:
determining a first template of the current block, and determining a matching template and a reference block;
determining model parameters according to the first template and the matching template;
performing filtering on the reference block according to the model parameters to determine a filtered reference block;
determining a prediction value of the current block according to the filtered reference block; and
determining a prediction residual of the current block according to the prediction value of the current block.

In a forty-second clause, according to the forty-first clause, determining the first template of the current block includes:
determining a template type of the current block; and
determining the first template of the current block according to the template type of the current block.

In a forty-third clause, according to the forty-second clause, determining the template type of the current block includes:
determining the template type of the current block according to reference samples of the current block, where
the reference samples of the current block include at least one of: left neighboring reference samples of the current block, top neighboring reference samples of the current block, top-left neighboring reference samples of the current block, bottom-left neighboring reference samples of the current block, or top-right neighboring reference samples of the current block.

In a forty-fourth clause, according to the forty-third clause, determining the template type of the current block includes:
if the left neighboring reference samples of the current block, the top neighboring reference samples of the current block, and the top-left neighboring reference samples of the current block are all available, determining the template type of the current block to be a first value;
if the left neighboring reference samples of the current block are available, determining the template type of the current block to be a second value;
if the top neighboring reference samples of the current block are available, determining the template type of the current block to be a third value;
if both the left neighboring reference samples of the current block and the top-left neighboring reference samples of the current block are available, determining the template type of the current block to be a fourth value;
if both the left neighboring reference samples of the current block and the bottom-left neighboring reference samples of the current block are available, determining the template type of the current block to be a fifth value; or
if both the top neighboring reference samples of the current block and the top-right neighboring reference samples of the current block are available, determining the template type of the current block to be a sixth value.

In a forty-fifth clause, according to the forty-first clause, determining the matching template and the reference block includes:
performing template matching within a preset search region according to the first template to determine the matching template; and
determining the reference block according to the matching template.

In a forty-sixth clause, according to the forty-fifth clause, performing template matching within the preset search region according to the first template to determine the matching template includes:
performing a search within the preset search region based on the first template to determine a target block vector, and determining the matching template according to the target block vector.

In a forty-seventh clause, according to the forty-first clause, determining the matching template and the reference block includes:
determining motion parameters and a corresponding reference block; and
determining the matching template according to the first template and the reference block;
correspondingly, where the method further includes:
encoding the motion parameters to signal obtained encoded bits into a bitstream.

In a forty-eighth clause, according to the forty-sixth clause, performing the search within the preset search region based on the first template to determine the target block vector includes: performing a first search within the preset search region to determine the target block vector; or
performing a second search within the preset search region to determine the target block vector;
where a search step corresponding to the first search is greater than a search step corresponding to the second search.

In a forty-ninth clause, according to the forty-sixth clause, performing the search within the preset search region based on the first template to determine the target block vector includes:
performing a first search within the preset search region to determine a first block vector, and determining an initial matching template according to the first block vector; and
determining a first search region according to the initial matching template, and performing a second search within the first search region to determine the target block vector, where
a search step corresponding to the first search is greater than a search step corresponding to the second search, and the first search region is smaller than the preset search region.

In a fiftieth clause, according to the forty-sixth clause, the preset search region includes at least one search sub-region; and performing the search within the preset search region based on the first template to determine the target block vector includes:
performing the search within the at least one search sub-region to determine a best block vector of each search sub-region and a corresponding matching cost value;
determining a best block vector corresponding to a minimum matching cost value according to the best block vector of each search sub-region and the corresponding matching cost value; and
using the best block vector corresponding to the minimum matching cost value as the target block vector.

In a fifty-first clause, according to the fiftieth clause, performing the search within the preset search region based on the first template to determine the target block vector includes:
performing a first search within the at least one search sub-region to determine a best block vector of each search sub-region and a corresponding second search region;
performing a region determination according to the best block vector of each search sub-region and the corresponding second search region to determine at least two target search sub-regions participating in a second search;
performing the second search within the at least two target search sub-regions to determine a best block vector corresponding to the at least two target search sub-regions; and
using the best block vector corresponding to the at least two target search sub-regions as the target block vector.

In a fifty-second clause, according to the forty-first clause, determining the model parameters according to the first template and the matching template includes:
that the model parameters include coefficients of a target filter.

In a fifty-third clause, according to the fifty-second clause, the method further includes: determining the coefficients of the target filter according to a sample reference value in the first template and a sample reference value in the matching template.

In a fifty-fourth clause, according to the fifty-third clause, the method further includes:
that the coefficients of the target filter are coefficients used by the target filter in a case where a first error between an output value of the sample reference value in the matching template after being processed by the target filter and the sample reference value in the first template meets a first condition.

In a fifty-fifth clause, according to the fifty-fourth clause, the method further includes:
that the first condition is that the first error is minimum.

In a fifty-sixth clause, according to the fifty-fourth clause, the method further includes: that the first condition is that the first error is within a first preset threshold range.

In a fifty-seventh clause, according to the fifty-fourth clause, the method further includes:
that the first condition is that a variation of the first error is within a second preset threshold range.

In a fifty-eighth clause, according to the fifty-third clause, determining the coefficients of the target filter according to the sample reference value in the first template and the sample reference value in the matching template includes:
determining an autocorrelation parameter according to the sample reference value in the matching template;
determining a cross-correlation parameter according to the sample reference value in the first template and the sample reference value in the matching template; and
determining the coefficients of the target filter according to the autocorrelation parameter and the cross-correlation parameter.

In a fifty-ninth clause, according to the fifty-third clause, the sample reference value includes at least one of: a sample reconstructed value, a sample gradient value, or sample position information.

In a sixty clause, according to the fifty-second clause, a number of the coefficients of the target filter is equal to a first preset value.

In a sixty-first clause, according to the fifty-second clause, the method further includes:
determining a number of the coefficients of the target filter; and
encoding the number of the coefficients of the target filter to signal obtained encoded bits into a bitstream.

In a sixty-second clause, according to the fifty-second clause, the target filter is a one-dimensional or two-dimensional filter of a preset shape.

In a sixty-third clause, according to the fifty-second clause, the method further includes:
determining a shape of the target filter; and
encoding the shape of the target filter to signal obtained encoded bits into a bitstream.

In a sixty-fourth clause, according to the fifty-second clause, performing filtering on the reference block according to the model parameters to determine the filtered reference block includes:
performing filtering on the reference block according to the model parameters to
determine a first output value of the target filter; and
determining the filtered reference block based on the first output value of the target filter.

In a sixty-fifth clause, according to the sixty-fourth clause, performing filtering on the reference block according to the model parameters to determine the first output value of the target filter includes:
calculating a product of a sample reconstructed value of the reference block and a corresponding coefficient of the target filter; and
setting the first output value of the target filter to be equal to a sum of n products, where n represents a number of the coefficients of the target filter, and n is a positive integer.

In a sixty-sixth clause, according to the sixty-fourth clause, performing filtering on the reference block according to the model parameters to determine the first output value of the target filter includes:
determining a first value of a sample reconstructed value of the reference block under a first mapping relationship;
calculating a product of the first value and a corresponding coefficient of the target filter; and
setting the first output value of the target filter to be equal to a sum of n products, where n represents a number of the coefficients of the target filter, and n is a positive integer.

In a sixty-seventh clause, according to the sixty-fourth clause, determining the filtered reference block based on the first output value of the target filter includes:
determining a first offset value; and
performing an addition operation according to the first output value and the first offset value to determine the filtered reference block.

In a sixty-eighth clause, according to the sixty-seventh clause, determining the first offset value includes:
setting the first offset value to be equal to a second preset value.

In a sixty-ninth clause, according to the sixty-seventh clause, determining the first offset value includes:
if a number of the coefficients of the target filter is n, determining an (n+1)th coefficient of the target filter; and
determining the first offset value according to the (n+1)th coefficient and a second offset value.

In a seventieth clause, according to the sixty-ninth clause, the method further includes:
setting the second offset value to be equal to a third preset value; or
setting the second offset value to be equal to a value of a sample reconstructed value of the reference block under a second mapping relationship.

In a seventy-first clause, according to the forty-first clause, determining the prediction value of the current block according to the filtered reference block includes:
performing first processing on the filtered reference block to obtain the prediction value of the current block.

In a seventy-second clause, according to the seventy-first clause, the method further includes:
that the first processing is that the prediction value of the current block is set to be equal to the filtered reference block.

In a seventy-third clause, according to the seventy-first clause, the method further includes:
that the first processing is a clipping operation that limits the filtered reference block within a preset value range.

In a seventy-forth clause, according to the forty-first clause, the method further includes:
determining a plurality of groups of model parameters according to the first template and the matching template;
constructing a plurality of filter models according to the plurality of groups of model parameters, and performing filtering on the reference block according to the plurality of filter models to determine a plurality of filtered reference blocks respectively; and
determining the prediction value of the current block according to the plurality of filtered reference blocks.

In a seventy-fifth clause, according to the seventy-fourth clause, determining the prediction value of the current block according to the plurality of filtered reference blocks includes:
performing a weighted calculation on the plurality of filtered reference blocks to determine the prediction value of the current block.

In a seventy-sixth clause, according to the seventy-fourth clause, the method further includes:
determining a target filter from the plurality of filter models; and
performing filtering on the reference block according to the target filter to determine the prediction value of the current block.

In a seventy-seventh clause, according to the seventy-sixth clause, the method further includes:
determining a target model index value, where the target model index value is used to indicate an index sequence number of the target filter in the plurality of filter models; and
encoding the target model index value to signal obtained encoded bits into a bitstream.

In a seventy-eighth clause, according to the seventy-sixth clause, determining the target filter from the plurality of filter models includes:
determining an original value of the current block;
performing a rate-distortion cost calculation according to the original value of the current block and a plurality of initial prediction values of the current block to determine respective rate-distortion cost values of the plurality of initial prediction values;
determining a minimum rate-distortion cost value from the respective rate-distortion cost values of the plurality of initial prediction values; and
using a filter model corresponding to the minimum rate-distortion cost value as the target filter.

In a seventy-ninth clause, according to the seventy-fourth clause, determining the plurality of groups of model parameters according to the first template and the matching template includes:
classifying reconstructed samples in the first template and reconstructed samples in the matching template according to a preset manner to obtain a plurality of groups of sub-templates and a plurality of groups of matching sub-templates respectively; and
determining the plurality of groups of model parameters according to the plurality of groups of sub-templates and the plurality of groups of matching sub-templates.

In an eightieth clause, according to the forty-first clause, the method further includes:
determining a value of first syntax element flag information, where the first syntax element flag information is used to indicate whether intra template matching is applied to the current block; and
encoding the value of the first syntax element flag information to signal obtained encoded bits into a bitstream.

In an eighty-first clause, according to the eightieth clause, determining the value of the first syntax element flag information includes:
if the intra template matching is applied to the current block, determining the value of the first syntax element flag information to be a first value; and
if the intra template matching is not applied to the current block, determining the value of the first syntax element flag information to be a second value.

In an eighty-second clause, according to the eightieth clause, in a case where the first syntax element flag information is used to indicate that the intra template matching is applied to the current block, the method further includes:
determining a value of second syntax element flag information, where the second syntax element flag information is used to indicate whether a filter model is applied to the current block;
and encoding the value of the second syntax element flag information to signal obtained encoded bits into a bitstream.

In a eighty-third clause, according to the eighty-second clause, determining the value of the second syntax element flag information includes:
if the filter model is applied to the current block, determining the value of the second syntax element flag information to be a first value; and
if the filter model is not applied to the current block, determining the value of the second syntax element flag information to be a second value.

In an eighty-fourth clause, according to the eighty-second clause, the method further includes:
if the filter model is applied to the current block, performing filtering on the reference block according to the model parameters to determine the filtered reference block; and determining the prediction value of the current block according to the filtered reference block; and
if the filter model is not applied to the current block, using a reconstructed sample value in the reference block as the prediction value of the current block.

In an eighty-fifth clause, according to any one of the forty-first clause to the eighty-fourth clause, determining the prediction residual of the current block according to the prediction value of the current block includes:
determining an original value of the current block; and
determining the prediction residual of the current block according to the original value of the current block and the prediction value of the current block.

In an eighty-sixth clause, embodiments of the present disclosure provide a bitstream. The bitstream is generated by bit encoding according to information to be encoded, where the information to be encoded includes at least one of:
a prediction residual of a current block, a number of coefficients of a target filter, a shape of the target filter, a value of first syntax element flag information, and a value of second syntax element flag information; where the first syntax element flag information is used to indicate whether intra template matching is applied to the current block, and the second syntax element flag information is used to indicate whether a filter model is applied to the current block. In an eighty-seventh clause, embodiments of the present disclosure provide an encoder. The encoder includes a first determining unit, a first filtering unit and a first predicting unit, where
the first determining unit is configured to determine a first template of a current block and to determine a matching template and a reference block, and is further configured to determine model parameters according to the first template and the matching template;
the first filtering unit is configured to perform filtering on the reference block according to the model parameters to determine a filtered reference block;
the first predicting unit is configured to determine a prediction value of the current block according to the filtered reference block; and
the first determining unit is further configured to determine a prediction residual of the current block according to the prediction value of the current block.

In an eighty-sixth clause, embodiments of the present disclosure provide an encoder, including a first memory and a first processor, where
the first memory is configured to store a computer program that is capable of running on the first processor; and
the first processor is configured to perform the method according to any one of the forty-first clause to the eighty-fifth clause when running the computer program.

In an eighty-eighth clause, embodiments of the present disclosure provides an encoder, comprising a first memory and a first processor, where
the first memory is configured to store a computer program that is capable of running on the first processor; and
the first processor is configured to perform the method according to any one of the forty-first clause to the eighty-fifth clause when running the computer program.

In an eighty-ninth clause, embodiments of the present disclosure provide a decoder, including a second determining unit, a second filtering unit and a second predicting unit, where
the second determining unit is configured to determine a first template of a current block, and to determine a matching template and a reference block, and is further configured to determine model parameters according to the first template and the matching template;
the second filtering unit is configured to perform filtering on the reference block according to the model parameters to determine a filtered reference block;
the second predicting unit is configured to determine a prediction value of the current block according to the filtered reference block; and
the second determining unit is further configured to determine a reconstructed value of the current block according to the prediction value of the current block.

In an ninetieth clause, embodiments of the present disclosure provide a decoder, including a second memory and a second processor, where
the second memory is configured to store a computer program that is capable of running on the second processor; and
the second processor is configured to perform the method according to any one of the first clause to the forty clause when running the computer program.

In a ninety-first clause, embodiments of the present disclosure provide a non-transitory computer-readable storage medium, where the non-transitory computer-readable storage medium has stored a computer program, and when the computer program is executed, the method according to any one of the first clause to the forty clause is implemented, or the method according to any one of the forty-first clause to the eighty-fifth clause is implemented.

In an embodiment of the present disclosure, referring to FIG. 6, a flowchart of a decoding method provided in the embodiments of the present disclosure is shown. As illustrated in FIG. 6, the method may include the following steps.

In S601, a first template of a current block is determined, and a matching template and a reference block are determined.

It should be noted that the decoding method in the embodiments of the present disclosure is applied to a decoder. In addition, the decoding method may specifically refer to an intra prediction method, and more specifically, refer to an intra prediction method of an intra template matching prediction based on filter-based linear model (Intra TMP-FLM). A video picture may be partitioned into a plurality of decoding blocks, and the current block in the embodiments of the present disclosure refers to a decoding block in the video picture that is currently to be intra-predicted. In addition, the decoding method in the embodiments of the present disclosure may be used not only to predict a luma component, but also to predict a chroma component, which is not specifically limited here.

It should also be noted that, in the embodiments of the present disclosure, it is first necessary to determine the first template of the current block, so that the matching template and the reference block may be determined according to the first template. In some embodiments, determining the first template of the current block may include:
determining a template type of the current block; and
determining the first template of the current block according to the template type of the current block.

The template type may be represented by refTemplateType. In some embodiments, determining the template type of the current block may include: determining the template type of the current block according to reference samples of the current block.

The reference samples of the current block include at least one of the following: left neighboring reference samples of the current block, top neighboring reference samples of the current block, top-left neighboring reference samples of the current block, bottom-left neighboring reference samples of the current block, or top-right neighboring reference samples of the current block.

That is, in the embodiments of the present disclosure, the reference samples of the current block are determined based on an adjacent reconstructed region of the current block. The adjacent reconstructed region of the current block includes at least one of the following: a left adjacent region, a top adjacent region, a top-left adjacent region, a bottom-left adjacent region, or a top-right adjacent region. For example, the left neighboring reference samples of the current block may be determined by at least one column of reconstructed samples in the left adjacent region, the top neighboring reference samples of the current block may be determined by at least one row of reconstructed samples in the top adjacent region, the bottom-left neighboring reference samples of the current block may be determined by at least one column of reconstructed samples in the bottom-left adjacent region, and so on, which are not specifically limited here.

Furthermore, template types may be classified according to whether the neighboring reference samples are available, and the template type of the current block may be determined. In some embodiments, determining the template type of the current block may include:
if the left neighboring reference samples of the current block, the top neighboring reference samples of the current block, and the top-left neighboring reference samples of the current block are all available, determining the template type of the current block to be a first value;
if the left neighboring reference samples of the current block are available, determining the template type of the current block to be a second value;
if the top neighboring reference samples of the current block are available, determining the template type of the current block to be a third value;
if both the left neighboring reference samples of the current block and the top-left neighboring reference samples of the current block are available, determining the template type of the current block to be a fourth value;
if both the left neighboring reference samples of the current block and the bottom-left neighboring reference samples of the current block are available, determining the template type of the current block to be a fifth value; or
if both the top neighboring reference samples of the current block and the top-right neighboring reference samples of the current block are available, determining the template type of the current block to be a sixth value.

In the embodiments of the present disclosure, the first value, the second value, the third value, the fourth value, the fifth value and the sixth value may be different. For example, the first value may be set to 1, the second value may be set to 2, the third value may be set to 3, the fourth value may be set to 4, the fifth value may be set to 5, and the sixth value may be set to 6. In addition, for these six template types, reference may be made to FIGS. 3A to 3F for details.

In some embodiments, determining the first template of the current block according to the template type of the current block may include: obtaining template samples of the current block according to the template type and a corresponding template size of the current block; and determining the template samples of the current block as the first template of the current block.

In the embodiments of the present disclosure, the template size may be set in advance, or may be determined according to the size of the current block, or may even be related to the template type of the current block, which is not specifically limited here.

For example, if the template type indicates that only the left template is to be obtained, the template width (templateW_size) may be set to 4; if the template type indicates that only the top template is to be obtained, the template height (templateH_size) may be set to 4.

In addition, which part of the reconstructed samples is obtained for the first template may be determined according to the value of the template type. For example, in a case where the value of refTemplateType is 1, the reconstructed samples on the left side of the current block, the top-left reconstructed samples of the current block and the top reconstructed samples of the current block are obtained; in a case where the value of refTemplateType is 2, only 4 columns of reconstructed samples on the left side of the current block are obtained; in a case where the value of refTemplateType is 3, only 4 rows of top reconstructed samples of the current block are obtained.

For the matching template and the reference block, in a possible implementation, determining the matching template and the reference block may include: decoding a bitstream to determine motion parameters; determining the reference block according to the motion parameters; and determining the matching template according to the first template and the reference block.

That is, the reference block of the current block may be determined according to the motion parameters (e.g., BV) obtained by decoding the bitstream, and the matching template may be determined by the reference block according to the first template of the current block.

For the matching template and the reference block, in another possible implementation, determining the matching template and the reference block may include: performing template matching within a preset search region according to the first template to determine the matching template; and determining the reference block according to the matching template.

In some embodiments, performing template matching within the preset search region according to the first template to determine the matching template may include: performing a search within the preset search region based on the first template to determine a target block vector; and determining the matching template according to the target block vector.

That is, the search may be performed within the preset search region according to the first template, and a matching template with the minimum cost may be searched out according to a preset cost function. By traversing all search points within the preset search region, one or more candidate block vectors may be obtained, and the one or more candidate block vectors may indicate one or more candidate matching templates; cost calculation is performed on the one or more candidate matching templates with the first template of the current block, then the search point with the minimum cost is obtained by comparison, and the candidate block vector corresponding to the search point with the minimum cost is the best block vector (i.e., the target block vector, BV_BEST); the candidate matching template corresponding to best block vector is the best matching template (i.e., the matching template described in the embodiments, T_BEST); and the reference block may be determined according to the best matching template.

In the embodiments of the present disclosure, the preset cost function may be the sum of absolute difference (SAD), the sum of absolute transformed difference (SATD), the mean square error (MSE), the sum of squared differences (SSD), the mean absolute deviation (MAD), the mean square differences (MSD), or the normalized correlation coefficient (NCC), which is not specifically limited here.

It can be understood that the search process within the preset search region may be a coarse search, or may be a fine search, or may be a search that a coarse search is performed first and then a fine search is performed; and the details are as follows.

In a possible implementation, performing the search within the preset search region based on the first template to determine the target block vector may include: performing a first search within the preset search region to determine the target block vector.

In another possible implementation, performing the search within the preset search region based on the first template to determine the target block vector may include: performing a second search within the preset search region to determine the target block vector.

In yet another possible implementation, performing the search within the preset search region based on the first template to determine the target block vector may include: performing a first search within the preset search region to determine a first block vector, and determining an initial matching template according to the first block vector; determining a first search region according to the initial matching template, and performing a second search within the first search region to determine the target block vector.

It should be noted that, in the embodiments of the present disclosure, a search step corresponding to the first search is greater than a search step corresponding to the second search. For example, the search step corresponding to the first search is 2, and the search step corresponding to the second search is 1. Alternatively, a downsampling factor corresponding to the first search is greater than a downsampling factor corresponding to the second search. For example, the downsampling factor corresponding to the first search is 4, and the downsampling factor corresponding to the second search is 2. That is, the first search is a coarse search, and the second search is a fine search. Features capable of reflecting that the first search is coarser than the second search are acceptable, which is not specifically limited here.

It should also be noted that, when the first search is performed first and then the second search is performed, not only is the search step corresponding to the first search greater than the search step corresponding to the second search, but also the first search region is smaller than the preset search region. The first search region is a search region near the initial matching template. For example, the best coarse matching template may be first determined within the preset search region with a size of 2, and then the best fine matching template (i.e., the final matching template) may be determined near the best coarse matching template with a size of 1.

In yet another possible implementation, the preset search region may include at least one search sub-region; and performing the search within the preset search region based on the first template to determine the target block vector may include:
performing the search within the at least one search sub-region to determine a best block vector of each search sub-region and a corresponding matching cost value;
determining a best block vector corresponding to a minimum matching cost value according to the best block vector of each search sub-region and the corresponding matching cost value; and
using the best block vector corresponding to the minimum matching cost value as the target block vector.

It should be noted that, in the embodiments of the present disclosure, the search region of the template of the current block may be the reconstructed part of a coding tree block (CTB) in which the current block is located, or may be another reconstructed CTB region. Here, the search region is actually a collection of all search points. Since a shape of the region cannot usually be represented by a single rectangular region, in an implementation, the search may be performed in a plurality of rectangular regions, and then the search results of different regions may be combined to obtain the final best reference block and the best block vector.

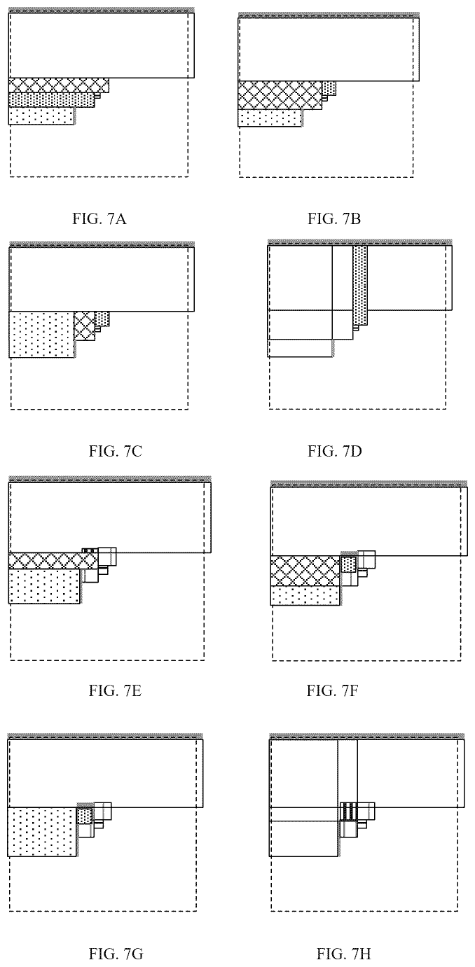

Referring to FIGS. 7A to 7H, it is a schematic diagram of partitioning a search region into different sub-regions provided in embodiments of the present disclosure. As illustrated in FIGS. 7A to 7H, eight different sub-region partition modes are shown. The background block filled with horizontal lines is the current block; in each of the five partition modes in FIG. 7A, FIG. 7B, FIG. 7C, FIG. 7D and FIG. 7F, the search region is partitioned into four search sub-regions, and in each of the three partition modes in FIG. 7E, FIG. 7G and FIG. 7H, the search region is partitioned into three search sub-regions, where a single different filling pattern represents one search sub-region. All available search ranges are considered in FIG. 7A, FIG. 7B, FIG. 7C and FIG. 7D, and the directly top region and the directly left region are not searched in FIG. 7E, FIG. 7F, FIG. 7G and FIG. 7H.

It should also be noted that, taking FIG. 7F as an example, the preset search region is partitioned into four search sub-regions, each of which is represented by regionId, and the value of regionId may be equal to 0, 1, 2, or 3. Through search points (iPosHor, iPox Ver) in each search sub-region, i.e., each block vector (BV, consisting of horizontal and vertical components: (pX, pY), where pX=iPosHor-xTbCmp, pY=iPosVer-yTbCmp, pX is between bvXMins and bvXMaxs, and pY is between bvYMins and bvYMaxs), a reference block that matches the current block may be found in the reconstructed region, and the neighboring reconstructed samples of the reference block are the matching template. Thus, the matching cost between the first template of the current block and the matching template may be calculated, which is represented as pDiff.

In this way, all search points in all search ranges (regionId=0, 1, 2, 3) are traversed, and a search point with the minimum matching cost (pDiff) is obtained by comparison; the matching cost corresponding to the search point is represented as pDiff_BEST, and the block vector corresponding to the search point is represented as the best block vector (BV_BEST, i.e., (pX_BEST, pY_BEST)), which is the target block vector described in the embodiments; the best matching template (T_BEST) corresponding to the best block vector is the matching template finally required.

In S602, model parameters are determined according to the first template and the matching template.

It should be noted that, in the embodiments of the present disclosure, the model parameters may include coefficients of a target filter. In some embodiments, the method may further include: determining the coefficients of the target filter according to a sample reference value in the first template and a sample reference value in the matching template.

It should also be noted that, in the embodiments of the present disclosure, the coefficients of the target filter may be determined by solving an optimization problem. Accordingly, in some embodiments, the method may further include: that the coefficients of the target filter are coefficients used by the target filter in a case where a first error between an output value of the sample reference value in the matching template after being processed by the target filter and the sample reference value in the first template meets a first condition.

It should be understood that, for the case that the first error meets the first condition, in a possible implementation, the first condition is that the first error is minimum. Alternatively, in another possible implementation, the first condition is that the first error is within a first preset threshold range. Alternatively, in yet another possible implementation, the first condition is that a variation of the first error is within a second preset threshold range.

It should also be understood that the first preset threshold range and the second preset threshold range are both measurement criteria set in advance by the decoding side for determining whether the first error meets the first condition. In addition, the first error may be the mean square error (MSE), or may be the sum of square error (SSE), or may be the sum of absolute difference (SAD), or may be the sum of absolute Hadamard transformed difference (SATD), or may be the mean absolute error (MAE), which is not specifically limited in the embodiments of the present disclosure.

In some embodiments, determining the coefficients of the target filter according to the sample reference value in the first template and the pixel reference value in the matching template may include:
determining an autocorrelation parameter according to the sample reference value in the matching template;
determining a cross-correlation parameter according to the sample reference value in the first template and the sample reference value in the matching template; and
determining the coefficients of the target filter according to the autocorrelation parameter and the cross-correlation parameter.

It should be noted that, in the embodiments of the present disclosure, the sample reference value includes at least one of the following: a sample reconstructed value, a sample gradient value, or sample position information.

That is, in the embodiments of the present disclosure, the target filter serves as a filter model in the embodiments of the present disclosure, and input information of the target filter is the sample reference value in the matching template. Here, the coefficients of the target filter may be represented by c_{k,l}, which may also be referred to as filter coefficients in the embodiments. The input information for calculating the filter coefficients may be available reconstructed samples in the matching template. Alternatively, a gradient of each reconstructed sample in the matching template may be calculated, and the calculated gradients are used as the input information for calculating the filter coefficients, where the gradients include but not limited to a horizontal gradient, a vertical gradient, etc. Alternatively, position information of each reconstructed sample is used as the input information for calculating the filter coefficients, where the position information may be absolute position information of each reconstructed sample in an entire picture, or relative position information of each reconstructed sample relative to a certain reference point, which is not specifically limited here.

In an embodiment, a reconstructed region (R) for calculating the filter coefficients is first determined, and then a group of filter coefficients may be derived by minimizing MSE between the reconstructed samples in the region (R) and the reconstructed samples in the first template. That is:

$$MSE = E [ {( predTemp [ i ] [ j ] - recTemp [ i ] [ j ] )}^{2} = E [ {( {\sum }_{k , l = - 1 ∼ 1} {c}_{k , l} \cdot refTemp [ i + k ] [ j + l ] - recTemp [ i ] [ j ] )}^{2} ] \qquad ( 3 )$$

where refTemp[i][j] represents reconstructed sample values that are input, recTemp[i][j] represents reconstructed sample values of the template of the current block, (i, j) represents coordinate positions, (i, j)∈R; k, I represents coordinate offsets of filter coefficient positions relative to the filter center position, where k and/are between −1 and 1, and the values of (k,l) may include (0, 0), (0,−1), (−1, 0), (0, 1), and (1, 0); and c_{k,l} represents filter coefficients that are required. In addition, E represents an operation for calculating a mean value, and in this case, the calculation formula is as follows:

$$MSE = \frac{1}{{N}_{pos}} {\sum }_{i} {\sum }_{j} {\vert predTemp [ i ] [ j ] - recTemp [ i ] [ j ] \vert}^{2} \qquad ( 4 )$$

where Nₚₒₛ refers to the number of (i, j) pairs involved in calculation for |predTemp[i][j]−recTemp[i][j]|². For example, if the number of (i, j) pairs involved in the calculation is 5, then the value of Nₚₒₛ is equal to 5.

Furthermore, the process of deriving the filter coefficients by minimizing MSE is as follows.

First, a partial derivative of c_{k,l} is calculated and is set to 0. That is:

$$\frac{\partial M S E}{\partial {c}_{m}} = E [ \text{} 2 \text{} ( {\sum }_{k , l = - 1 ∼ 1} {c}_{k , l} \cdot refTemp [ i + k ] [ j + l ] - \text{} recTemp [ i ] [ j ] ) \cdot refTemp [ i + \text{} m ] [ j + n ] ] \qquad ( 5 )$$

$$E [ \text{} 2 \text{} ( {\sum }_{k , l = - 1 ∼ 1} {c}_{k , l} \cdot refTemp [ i + k ] [ j + l ] - \text{} recTemp [ i ] [ j ] ) \cdot refTemp [ i + \text{} m ] [ j + n ] ] = 0 \qquad ( 6 )$$

where k and/are between −1 and 1, and m and n are between −1 and 1.

Second, according to formulas (5) and (6), it is obtained that:

$${\sum }_{k , l = - 1 ∼ 1} {c}_{k , l} \cdot E ( refTemp [ i + k ] [ j + l ] \cdot refTemp [ i + m ] [ j + n ] ) = E ( recTemp [ i ] [ j ] \cdot refTemp [ i + m ] [ j + n ] ) \qquad ( 7 )$$

Third, after the reconstructed region (R) is determined, the obtained equation (7) is expanded into a matrix form, as follows:

$$A \times [ \begin{matrix}{C}_{0 , 0} \\ {C}_{- 1 , 0} \\ ⋮ \\ {C}_{0 , 1}\end{matrix} ] = B \qquad ( 8 )$$

where for A, the sample reference value in the matching template is represented by refTemp[i][j], and A represents the autocorrelation parameter of refTemp[i][j], as follows:

$$A = [ \begin{matrix}E ( refTemp [ i ] [ j ] \cdot refTemp [ i ] [ j ] ) & E ( refTemp [ i - 1 ] [ j ] \cdot refTemp [ i ] [ j ] ) \\ E ( refTemp [ i ] [ j ] \cdot refTemp [ i - 1 ] [ j ] ) & E ( refTemp [ i - 1 ] [ j ] \cdot refTemp [ i - 1 ] [ j ] ) \\ ⋮ & ⋮ \\ E ( refTemp [ i ] [ j ] \cdot refTemp [ i ] [ j + 1 ] ) & E ( refTemp [ i - 1 ] [ j ] \cdot refTemp [ i ] [ j + 1 ] )\end{matrix} \qquad ( 9 )$$

$$\begin{matrix}… & E ( refTemp [ i ] [ j + 1 ] \cdot refTemp [ i ] [ j ] ) \\ … & E ( refTemp [ i ] [ j + 1 ] \cdot refTemp [ i - 1 ] [ j ] ) \\ ⋱ & ⋮ \\ … & E ( refTemp [ i ] [ j + 1 ] \cdot refTemp [ i ] [ j + 1 ] )\end{matrix} ]$$

for B, the sample reference value in the first template is represented by rec Temp[i][j], and B represents the cross-correlation parameter of recTemp[i][j] and refTemp[i][j], as follows:

$$B = [ \begin{matrix}{\sum }_{i ∈ R} ( recTemp [ i ] [ j ] \cdot refTemp [ i ] [ j ] ) \\ {\sum }_{i ∈ R} ( recTemp [ i ] [ j ] \cdot refTemp [ i - 1 ] [ j ] ) \\ ⋮ \\ {\sum }_{i ∈ R} ( recTemp [ i ] [ j ] \cdot refTemp [ i ] [ j + 1 ] )\end{matrix} ] \qquad ( 10 )$$

That is, since the autocorrelation matrix of refTemp in the reconstructed region (R) and the cross-correlation vector of refTemp and recTemp are known quantities, the filter coefficients c_{k,l} may be calculated by solving the equation group shown in equation (7). The filter coefficients c_{k,l} may be or may not be processed by point-fixing.

In the embodiments of the present disclosure, for the target filter, it is also necessary to determine the number of coefficients of the target filter and a shape of the target filter. The number of coefficients of the target filter and the shape of the target filter may be fixed values set in advance, or may be directly determined by decoding a bitstream.

In some embodiments, for the number of coefficients of the target filter, the method may further include: that the number of coefficients of the target filter is equal to a first preset value.

In some embodiments, for the number of coefficients of the target filter, the method may further include: decoding a bitstream to determine the number of coefficients of the target filter.

It should be noted that the number of coefficients of the target filter may be represented by n Tap. For example, the value of n Tap may be 4, 5, 6, 7, 8, or 9, which is not specifically limited.

It should also be noted that the number of coefficients of the target filter may also be referred to as the number of taps of the target filter. Here, the number of coefficients of the target filter may be a preset constant value, or may be determined by decoding a bitstream, or may even be determined according to syntax element flag information of the current block.

In some embodiments, for the shape of the target filter, the method may further include: that the target filter is a one-dimensional or two-dimensional filter of a preset shape.

In some embodiments, for the shape of the target filter, the method may further include: decoding a bitstream to determine the shape of the target filter.

In some embodiments, for the shape of the target filter, the method may further include: decoding a bitstream to determine a value of a filter shape parameter, where the filter shape parameter indicates the shape of the target filter.

It should be noted that the filter shape parameter may be represented by FilterIdx, and FilterIdx is used to indicate the shape of the target filter. For example, the target filter may be in a shape of a diamond, a rectangle, a cross, or a stripe, or may even be a one-dimensional filter or a two-dimensional filter, which is not specifically limited.

For example, if the value of FilterIdx is equal to 0, the shape of the target filter is determined to be the diamond; if the value of FilterIdx is equal to 1, the shape of the target filter is determined to be the cross; if the value of FilterIdx is equal to 2, the shape of the target filter is determined to be the rectangle.

It should also be noted that the shape of the target filter may be a preset shape, or may be determined by decoding a bitstream, or may even be determined according to syntax element flag information of the current block.

In S603, filtering is performed on the reference block according to the model parameters to determine a filtered reference block.

In S604, a prediction value of the current block is determined according to the filtered reference block.

It should be noted that, in the embodiments of the present disclosure, after the model parameters are determined, the prediction value of the current block may be determined according to the model parameters and the reference block. Optionally, the reference block is filtered according to the model parameters, and then the prediction value of the current block is determined according to the filtered reference block.

In some embodiments, performing filtering on the reference block according to the model parameters to determine the filtered reference block may include: performing filtering on the reference block according to the model parameters to determine a first output value of the target filter; and determining the filtered reference block based on the first output value of the target filter.

In the embodiments of the present disclosure, the first output value of the target filter may be calculated according to the sample reconstructed values of the reference block and the coefficients of the target filter in the model parameters, and then the filtered reference block may be determined according to the first output value of the target filter. Here, the target filter may be a linear filter model, or may be a nonlinear filter model, which is not specifically limited.

In a possible implementation, performing filtering on the reference block according to the model parameters to determine the first output value of the target filter may include:
calculating a product of a sample reconstructed value of the reference block and a corresponding coefficient of the target filter; and
setting the first output value of the target filter to be equal to a sum of n products, where n represents the number of coefficients of the target filter, and n is a positive integer.

It should be noted that the target filter in the embodiments of the present disclosure is a linear filter model. The first output value of the target filter may be calculated by the following formula:

$${Y}^{pred} [ i ] [ j ] = {\sum }_{k} {\sum }_{l} ref [ i + k ] [ j + l ] \times {C}_{k , l} \qquad ( 11 )$$

where ref[i+k][j+l] represents the sample reconstructed values of the reference block, and C_{k,l} represents the coefficients of the target filter.

In another possible implementation, performing filtering on the reference block according to the model parameters to determine the first output value of the target filter may include:
determining a first value of a sample reconstructed value of the reference block under a first mapping relationship;
calculating a product of the first value and a corresponding coefficient of the target filter; and
setting the first output value of the target filter to be equal to a sum of n products, where n represents the number of coefficients of the target filter, and n is a positive integer.

It should be noted that the target filter in the embodiments of the present disclosure is a nonlinear filter model. For example, in a case where MSE of the filter coefficients is minimized, the calculation formula is adjusted as follows:

$$MSE = E [ {( predTemp [ i ] [ j ] - recTemp [ i ] [ j ] )}^{2} ] = E [ {( {\sum }_{k , l = - 1 ∼ 1} {c}_{k , l} \cdot {( refTemp [ i + k ] [ j + l ] )}^{2} - recTemp [ i ] [ j ] )}^{2} ] \qquad ( 12 )$$

Then, the first output value of the target filter may be calculated by the following formula:

$${Y}^{pred} [ i ] [ j ] = {\sum }_{k} {\sum }_{l} {( ref [ i + k ] [ j + l ] )}^{2} \times {C}_{k , l} \qquad ( 13 )$$

where ref[i+k][j+l] represents the sample reconstructed values of the reference block, and C_{k,l} represents the coefficients of the target filter.

It should also be noted that, in the embodiments of the present disclosure, the filtered reference block is determined based on the first output value of the target filter, which may be that the first output value of the target filter is directly set as the filtered reference block, or first filtering is performed on the first output value of the target filter to obtain the filtered reference block. Here, the first filtering may be a low-pass filtering, an up/down sampling filtering, etc., which is not specifically limited here.

It should also be noted that, in the embodiments of the present disclosure, after the first output value of the target filter is determined, a first offset value (represented by bias) may be added to the first output value to determine the filtered reference block.

In some embodiments, determining the filtered reference block based on the first output value of the target filter may include: determining a first offset value; and performing an addition operation based on the first output value and the first offset value to determine the filtered reference block.

In a possible implementation, determining the first offset value may include: setting the first offset value to be equal to a second preset value.

In another possible implementation, determining the first offset value may include: if the number of coefficients of the target filter is n, determining an (n+1)th coefficient of the target filter; and determining the first offset value according to the (n+1)th coefficient and a second offset value.

In the embodiments of the present disclosure, for the second offset value, the method may further include: setting the second offset value to be equal to a third preset value; or setting the second offset value to be equal to a value of a sample reconstructed value of the reference block under a second mapping relationship.

It should be noted that, in the embodiments of the present disclosure, the calculated filter coefficients are used as the number of taps corresponding to the filter template. That is, the number of filter coefficients is equal to the number of taps (nTap) of the filter template. In addition, several bias terms (bias) may be added to the filter template. For example, in the embodiments of the present disclosure, when nTap=5, the filter coefficients are the tap coefficients co to C₄corresponding to the filter template, and the prediction value at the position (i, j) in the filtered reference block is calculated as follows:

$${Y}^{pred} [ i ] [ j ] = {\sum }_{n = 0}^{4} ref [ k ] [ l ] \times {C}_{n} \qquad ( 14 )$$

In this case, the bias term may be added to obtain the following formula:

$${Y}^{pred} [ i ] [ j ] = {\sum }_{n = 0}^{4} ref [ k ] [ l ] \times {C}_{n} + {C}_{5} \times Constant \qquad ( 15 )$$

In the embodiments of the present disclosure, cn=C_{i,j,k,l}. Here, Constant may be a fixed constant (for example, Constant=1<<(BitDepth−1)), or may be a number related to the reconstructed sample value at position (i, j) in the reference block (for example, Constant=f(ref[i][j])), or may be a number related to the reconstructed sample value corresponding to a tap in the filter template other than the position (i, j) (for example, Constant=f(ref[k][/])). Constant=f(ref[i][j]) or Constant=f(ref[k][l]) may be a linear mapping relationship, or may be a nonlinear mapping relationship. One or more bias items may be added, which is not specifically limited here.

Furthermore, in some embodiments, determining the prediction value of the current block according to the filtered reference block may include: performing first processing on the filtered reference block to obtain the prediction value of the current block.

In the embodiments of the present disclosure, for the first processing, the first processing may be that the prediction value of the current block is set to be equal to the filtered reference block. Alternatively, the first processing may be a clipping operation that limits the filtered reference block within a preset value range. Alternatively, the first processing may be any other operation, which is not specifically limited here.

Here, for the clipping operation, the preset value range may be a range from 0 to (1<<BitDepth)−1, where BitDepth represents a bit depth. If the value of the filtered reference block exceeds the preset value range, then a corresponding correction operation needs to be performed on the filtered reference block. For example, the filtered reference block may also be represented by Y^{pred}[i][j], and in this case, the correction operation can be performed on Y^{pred}[i][j], as follows: in a case where the value of Y^{pred}[i][j] is less than 0, it is set to 0;
in a case where the value of Y^{pred}[i][j] is greater than or equal to 0 and less than or equal to (1<<BitDepth)−1, it is equal to Y^{pred}[i][j]; and
in a case where the value of Y^{pred}[i][j] is greater than (1<<BitDepth)−1, it is set to (1<<BitDepth)−1.

In this way, after the correction operation is performed on Y^{pred}[i][j], it may be ensured that all sample values in the filtered reference block are between 0 and (1<<BitDepth)−1.

Furthermore, the number of filter models may be expanded. In addition to establishing only one filter model, a plurality of filter models may also be established. Therefore, in some embodiments, the method may further include:
determining a plurality of groups of model parameters according to the first template and the matching template;
constructing a plurality of filter models according to the plurality of groups of model parameters, and performing filtering on the reference block according to the plurality of filter models to determine a plurality of filtered reference blocks respectively; and
determining the prediction value of the current block according to the plurality of filtered reference blocks.

In some embodiments, determining the plurality of groups of model parameters according to the first template and the matching template may include: classifying reconstructed samples in the first template and reconstructed samples in the matching template according to a preset manner to obtain a plurality of groups of sub-templates and a plurality of groups of matching sub-templates respectively; and determining the plurality of groups of model parameters according to the plurality of groups of sub-templates and the plurality of groups of matching sub-templates.

It should be noted that, in the embodiments of the present disclosure, the preset manner here may be a size of the reconstructed sample value, or may be position information of the reconstructed sample, or may be a shape of the filter, which is not limited. After the classification is performed according to the preset manner, each group of sub-templates and corresponding matching sub-templates can be used to calculate a group of model parameters, and each group of model parameters can determine one filter model, so that the plurality of filter models may be constructed.

In a possible implementation, the method may further include: decoding a bitstream to determine a target model index value; determining a corresponding target filter from the plurality of filter models according to the target model index value; and performing filtering on the reference block according to the target filter to determine the prediction value of the current block.

In another possible implementation, the plurality of filtered reference blocks may be determined by performing filtering on the reference block according to the plurality of filter models respectively. In some embodiments, determining the prediction value of the current block based on the plurality of filtered reference blocks may include: performing a weighted calculation on the plurality of filtered reference blocks to determine the prediction value of the current block.

It should also be noted that, if the weight value of each filtered reference block is the same and equal to the inverse of the number of reference blocks, then the weighted calculation here may also be regarded as a mean value calculation. In other words, the mean value calculation is performed on the plurality of filtered reference blocks to determine the prediction value of the current block.

Exemplarily, the input information for calculating the filter coefficients is classified, and a filter model is established for each category of input information. For example, in a case where reconstructed information is used to establish filter models, one possible implementation is that classifying is performed through the mean value of the reconstructed information, the reconstructed information greater than the mean value is used to establish a filter model, and the reconstructed information less than the mean value is used to establish a filter model. Another possible implementation is that classifying is performed using the positions of the reconstructed information. For example, a filter model may be established using available reconstructed information on the left and top sides, and a second filter model may be established using available reconstructed information on the left and top-left sides, and so on. The encoding side determines which model to be used. One possible decision-making mode is that the encoding side determines which model to be used through rate-distortion optimization and transmits corresponding decoding parameters to the decoding side, so that the decoding side may clearly select which filter model. Yet another possible implementation is that classifying is performed using the shapes of filters, a plurality of filters with different shapes can be used, and a filter model is established for the filter of each shape. The encoding side determines which shape of filter to be used. One possible decision-making mode is that the decoding side determines which filter to be used through rate-distortion optimization and transmits corresponding decoding parameters to the decoding side, so that the decoding side may clearly select which filter model.

In S605, a reconstructed value of the current block is determined according to the prediction value of the current block.

It should be noted that, in the embodiments of the present disclosure, after the prediction value of the current block is determined, the reconstructed value of the current block may also be restored. In some embodiments, determining the reconstructed value of the current block according to the prediction value of the current block may include: decoding a bitstream to determine a prediction residual of the current block; and determining the reconstructed value of the current block according to the prediction value of the current block and the prediction residual of the current block.

In an embodiment, determining the reconstructed value of the current block according to the prediction value of the current block and the prediction residual of the current block may include: performing an addition operation on the prediction value of the current block and the prediction residual of the current block to determine the reconstructed value of the current block.

It should also be noted that, in the embodiments of the present disclosure, whether intra template matching is applied to the current block or whether a filter mode is applied to the current block may be determined by different syntax element flag information. In some embodiments, the method may further include: decoding a bitstream to determine a value of first syntax element flag information;
if the first syntax element flag information is used to indicate that intra template matching is applied to the current block, decoding the bitstream to determine a value of second syntax element flag information; and
if the second syntax element flag information is used to indicate that a filter model is applied to the current block, performing filtering on the reference block according to the model parameters to determine the filtered reference block; and determining the prediction value of the current block according to the filtered reference block.

Furthermore, in some embodiments, the method may further include: if the second syntax element flag information is used to indicate that the filter model is not applied to the current block, using the reconstructed sample value in the reference block as the prediction value of the current block.

In the embodiments of the present disclosure, for the first syntax element flag information, if the value of the first syntax element flag information is a first value, it is determined that the first syntax element flag information is used to indicate that the intra template matching is applied to the current block; or if the value of the first syntax element flag information is a second value, it is determined that the first syntax element flag information is used to indicate that the intra template matching is not applied to the current block.

In the embodiments of the present disclosure, for the second syntax element flag information, if the value of the second syntax element flag information is a first value, it is determined that the second syntax element flag information is used to indicate that the filter model is applied to the current block; or if the value of the second syntax element flag information is a second value, it is determined that the second syntax element flag information is used to indicate that the filter model is not applied to the current block.

It should be noted that, in the embodiments of the present disclosure, the first value is different from the second value, and the first value and the second value may be in parameter form, or may be in digital form. Optionally, the first syntax element flag information and the second syntax element flag information may be parameters written into a profile, or may be values of flag, which is not specifically limited here.

For example, for the first value and the second value, the first value may be set to 1, and the second value may be set to 0. Alternatively, the first value may be set to true, and the second value may be set to false, which is not specifically limited here.

It should also be noted that, in the embodiments of the present disclosure, whether the current block uses the filtered reference block as the final prediction value is determined by certain conditions, which is not limited to the following three modes. For example, the three modes may be as follows:
Mode 1: whether to perform filtering on the matching template is determined by comparing the distortion between the matching template and the template of the current block (e.g., SAD, or MSE, or SATD, or SSE) with the threshold T_Distortion1.
Mode 2: on the basis of using the filter model in mode 1, the distortion between the filtered matching template and the template of the current block (e.g., SAD, or MSE, or SATD, or SSE) and the threshold T_Distortion2 are used to determine whether to filter the reference block.
Mode 3: the encoding side transmits Flag to indicate whether the filter model is applied. tmpFlag indicates whether the intra template matching is applied to the current block, and filterFlag indicates whether the filter model is applied to the current block. When tmpFlag is 1, the encoding side determines whether to perform filtering on the reference block by comparing the distortion between the reference block and the current block before and after filtering, such as SAD, MSE, SATD, or SSE. If the distortion after filtering is less than the distortion before filtering, filterFlag is set to 1, and the current block uses the filtered reference block as the prediction block. Otherwise, filterFlag is set to 0, the current block uses the reference block before filtering as the prediction block, and the encoding side transmits filterFlag to the decoding side.

The embodiments provide a decoding method, and the method includes: determining a first template of a current block, and determining a matching template and a reference block; determining model parameters according to the first template and the matching template; performing filtering on the reference block according to the model parameters to determine a filtered reference block; determining a prediction value of the current block according to the filtered reference block; and determining a reconstructed value of the current block according to the prediction value of the current block. In this way, the model parameters are determined according to the first template and the matching template. The model parameters fully reflect a correlation between the matching template and the first template of the current block; and this correlation is applied to the reference block to filter and correct reconstructed samples of the reference block, and then the filtered reconstructed samples are used as predicted samples of the current block. Thus, it is possible to improve prediction accuracy, and save bit rate. In addition, encoding and decoding efficiency may also be improved, thereby improving encoding and decoding performance.

In another embodiment of the present disclosure, based on the decoding method described in the aforementioned embodiments, in the prediction process of the Intra TMP technology, it is proposed to correct the best matching reconstructed block (i.e., the reference block) and use the corrected reconstructed samples as the predicted samples of the current block. Optionally, a linear filter model is established using samples of the matching template and the template of the current block, the linear filter model is applied to the reference block, and the filtered samples are used as the final predicted pixels. The technical solution of the embodiments of the present disclosure may be referred as an intra template matching prediction based on filter-based linear model (Intra TMP-FLM).

The prediction process of the Intra TMP-FLM technology is introduced in detail below.

Input of the Intra TMP-FLM technology: a position of the current block (xTbCmp, yTbCmp), a width of the current block (nTbW), and a height of the current prediction block (nTbH).

Output of the Intra TMP-FLM technology: a prediction value of the current block (predSamples[x][y]), where x=0 . . . nTbW-1, y=0 . . . nTbH-1.

Optionally, the prediction process of the Intra TMP-FLM technology may be partitioned into five steps: determining a current template type; obtaining reconstructed samples of the current template; determining a block vector within a predefined search range; establishing a linear filter model; and generating a prediction value. It should be noted that the Intra TMP-FLM technology may be used to predict the luma component or the chroma component, and there is no specific limitation on this.

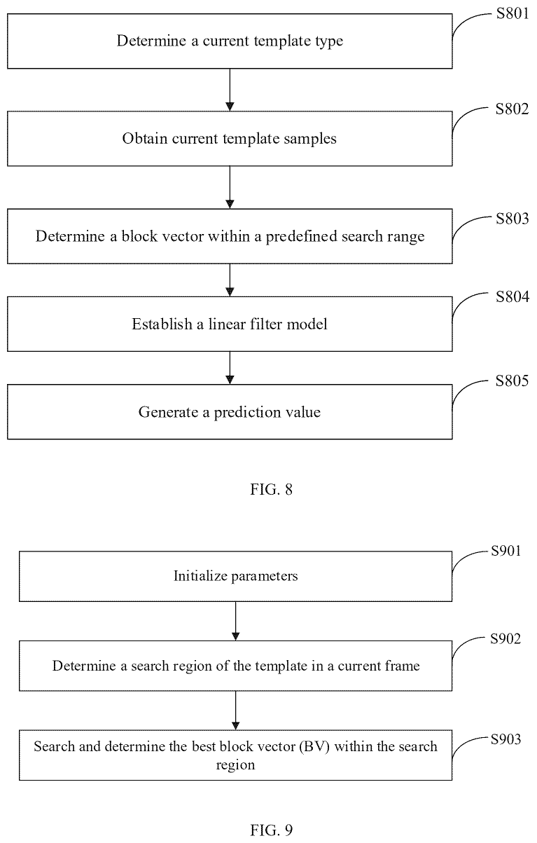

Referring to FIG. 8, it is a schematic diagram showing a prediction process based on the Intra TMP-FLM technology provided in the embodiments of the present disclosure. As illustrated in FIG. 8, the process may include the following steps.

In S801, a current template type is determined.

It should be noted that, the Intra TMP-FLM technology uses reconstructed samples adjacent to the current block as a template to search for a matching template within a predefined search region, where the neighboring reconstructed samples may be top reference samples, top-left reference samples, top-right reference samples, left reference samples or bottom-left reference samples of the current block. Therefore, the template type may be classified according to whether the neighboring reconstructed samples are available, and the corresponding template type may be determined.

It should also be noted that refTemplate Type may be used to represent the template type. As illustrated in FIGS. 3A to 3F, the block filled with grid is the current block, an adjacent region of the current block is the template T, and six template types are shown here.

By way of example, the six template types are as follows:
in a case where the top-left reference samples, the top reference samples, and the left reference samples are all available, the value of refTemplateType is 1, and the template shape is illustrated in FIG. 3A;
in a case where only the left reference samples are available, the value of refTemplateType is 2, and the template shape is illustrated in FIG. 3B;
in a case where only the top reference samples are available, the value of refTemplateType is 3, and the template shape is illustrated in FIG. 3C;
in a case where only the left reference samples and the top-left reference samples are available, the value of refTemplateType is 4, and the template shape is illustrated in FIG. 3D;
in a case where only the left reference samples and the bottom-left reference samples are available, the value of refTemplateType is 5, and the template shape is illustrated in (e) in FIG. 3; and
in a case where only the top reference samples and the top-right reference samples are available, the value of refTemplateType is 6, and the template shape is illustrated in FIG. 3F.

S802, current template samples are obtained.

It should be noted that the template of the Intra TMP-FLM technology may be composed of reconstructed samples in one or more regions of the top, top-right, left, bottom-left, and top-left regions of the current block. In addition, the template size may be set in advance. For example, when the left template is obtained, the template width (templateW_size) may be set to 4; or when the top template is obtained, the template height (templateH_size) may be set to 4.

It should also be noted that the value of refTemplateType may be used to determine which part of the reconstructed samples to be obtained. For example, in a case where the value of refTemplateType is 1, the reconstructed samples on the left, top-left and top sides of the current block are obtained; or in a case where the value of refTemplateType is 2, only four columns of reconstructed samples on the left side of the current block are obtained; or in a case where the value of refTemplateType is 3, only four rows of reconstructed samples on the top side of the current block are obtained.

S803, a block vector is determined within a predefined search range.

It should be noted that a search process of the Intra TMP-FLM technology is mainly partitioned into an initialization process, determining a search region of the template in the current frame, searching and determining the best block vector within the search region.

It should also be noted that, when the best matching template is searched within the search region, a search strategy of coarse search followed by fine search may be adopted, or only fine search may be performed, or only coarse search may be performed, which is not specifically limited here.

In the embodiments of the present disclosure, the coarse search may be that a first preset size (e.g., 2) is used to determine the best coarse matching template within the search region, or a downsampled template (e.g., a downsampling factor being 2) is used to determine the best coarse matching template within the search region.

In the embodiments of the present disclosure, the fine search may be that a second preset size (e.g., 1) is used to determine the best fine matching template within the search region, or the best fine matching template is determined near the best coarse matching template after the coarse search is performed.

Referring to FIG. 9, it is a schematic diagram showing a search process based on the Intra TMP technology provided in embodiments of the present disclosure. As illustrated in FIG. 9, the process may include the following steps.

In S901, parameters are initialized.

It should be noted that, uiPatchWidth is initialized to nTbW+templateW_size, and uiPatchHeight is initialized to nTbH+templateH_size, where templateW_size and templateH_size may be fixed constants, or may be dynamically adjusted according to the size of the current block. In addition, templateW_size may be equal or unequal to templateH_size. For example, templateW_size=4, templateH_size=4. Alternatively, in a case where the width of the current block is greater than 8, templateW_size is set to 4 (i.e., templateW_size=4); in a case where the width of the current block is less than or equal to 8, templateW_size is set to 2 (i.e., templateW_size =2); in a case where the height of the current block is greater than 8, templateH_size is set to 4 (i.e., templateH_size=4); in a case where the height of the current block is less than or equal to 8, templateH_size is set to 2 (i.e., templateH_size=2).

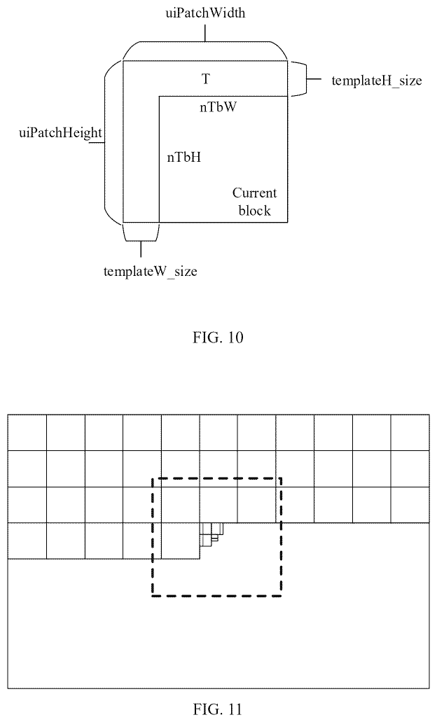

Exemplarily, FIG. 10 is a schematic diagram showing parameter definition of a current block and its template provided in embodiments of the present disclosure. As illustrated in FIG. 10, the specific meanings of the parameters are as follows: nTbW and nTbH represent the size of the current block, templateW_size and templateH_size represent the size of the template, and uiPatchWidth and uiPatchHeight represent the size of the block including the current block and its template.

Furthermore, the cost threshold between initialization templates is represented by diffThreshold. For example, in a case where the cost function is SAD, the threshold may be: diffThreshold=((1<<bitDepth)>>2)× (uiPatchHeight x uiPatchWidth-nTbH x nTbW). In a case where the picture bit depth (bitDepth) is 10, diffThreshold indicates that the maximum distortion of each sample in the template region is 256.

Furthermore, the position of the coding tree block (CTB) in which the current block (CB) is located is initialized as: ctbRsX, ctbRsY.

Furthermore, the position offset of the current block (CB) in the current CTB is initialized as: offsetLCBY=yTbCmp-ctbRsY, offsetLCBX=xTbCmp-ctbRsX.

Furthermore, iTemplateSizeH is initialized to be equal to templateH_size (i.e., iTemplateSizeH=templateH_size), iTemplateSizeW is initialized to be equal to templateW_size (i.e., iTemplateSizeW=templateW_size).

Furthermore, iBvShift is initialized, where iBvShift is the accuracy of the block vector (BV). For example, the accuracy of BV may be integer-pixel accuracy, and in this case, iBvShift is 0. The accuracy of BV may also be sub-pixel accuracy. For example, in a case where iBvShift is 1, it indicates half-pixel accuracy; and in a case where iBvShift is 2, it indicates quarter-pixel accuracy, which is not specifically limited here.

Furthermore, a preset search range of the template is initialized. The preset search range of the template may be set to a fixed size, or the search range may be dynamically adjusted according to the size of the coding block. For example, searchRangeWidth=TMP_SEARCH RANGE_MULT_FACTORxnTbW, searchRangeHeight=TMP_SEARCH RANGE_MULT FACTORxnTbH; where the value of TMP_SEARCH RANGE_MULT_FACTOR may be a preset value, such as 5.

In S902, a search region of the template in a current frame is determined.

It should be noted that the search region of the Intra TMP technology is the reconstructed part of the current picture and is limited by the size of the search range. As illustrated in FIG. 11, the background region filled with vertical lines is the reconstructed region, the background block filled with horizontal lines is the current block, and the dotted box is the search range window. Therefore, the search region of the Intra TMP technology does not exceed the overlap between the reconstructed region represented by the vertical lines background and the region marked by the dotted box.

It can be seen that the search region of the template of the current block may be the reconstructed part of CTB in which the current block is located, or may be any other reconstructed region of CTB. The search region here is actually the collection of all search points. Since the shape of the region cannot usually be represented by a single rectangular region, in an implementation, the search may be performed in a plurality of rectangular regions, and then the search results of different regions may be combined to obtain the final best matching block and the best block vector.

FIGS. 7A to 7H are taken as examples, eight different sub-region partition modes are shown here. The background block filled with horizontal lines is the current block; in each of the five partition modes in FIG. 7A, FIG. 7B, FIG. 7C, FIG. 7D and FIG. 7F, the search region is partitioned into four search sub-regions, and in each of the three partition modes in FIG. 7E, FIG. 7G and FIG. 7H, the search region is partitioned into three search sub-regions, where a single different filling pattern represents one search sub-region.

All available search ranges are considered in FIG. 7A, FIG. 7B, FIG. 7C and FIG. 7D, and the directly top region and the directly left region are not searched in FIG. 7E, FIG. 7F, FIG. G, FIG, H.

For example, it is assumed that different search sub-regions are represented by regionId; considering that the template samples of the current block need to be obtained in the picture reconstructed region and the reconstructed block samples corresponding to the template also need to be obtained in the reconstructed region, it is necessary to further determine the positions that can be searched in the search sub-regions represented by different regionId according to the position of the current block (xTbCmp, yTbCmp), the size of the current block (nTbW, nTbH), the size of the current picture (picWidth, picHeight), the size of CTB in which the current block is located (CtbSizeW, CtbSizeH), the preset search range of the template (searchRangeWidth, searchRangeHeight) and the position offset of the current block in the current CTB (offsetLCBY, offsetLCBX), and thus the block vector (BV) is determined. Specifically, iVerMin and i VerMax represent the absolute coordinate positions that can be searched at least and at most in the vertical direction respectively, and iHorMin and iHorMax represent the absolute coordinate positions that can be searched at least and at most in the horizontal direction respectively. The values of i VerMin, i VerMax, iHorMin, and iHorMax are different within the search regions represented by different regionId.

Taking FIG. 7F as an example, the search region is partitioned into four search sub-regions, and the implementation is as follows.

In a case where regionId is equal to 0, i VerMin, i VerMax, iHorMin, and iHorMax may be calculated as follows:

```
  iHorMax₀ = min( (xTbCmp + searchRangeWidth) << iBvShift,
((picWidth − nTbW) << iBvShift) );
  iHorMin₀ = max( (iTemplateSizeW) << iBvShift, (xTbCmp −
searchRangeWidth) << iBvShift );
  iVerMax₀ = (yTbCmp − nTbH − offsetLCBY) << iBvShift;
  iVerMin₀ = max( ((iTemplateSizeH) << iBvShift), ((yTbCmp −
searchRangeHeight) << iBvShift) ).
```

In a case where regionId is equal to 1, iVerMin, iVerMax, iHorMin, and iHorMax may be calculated as follows:

```
  iHorMin₁ = max( (iTemplateSizeW) << iBvShift, (xTbCmp −
searchRangeWidth) << iBvShift );
  iHorMax₁ = (xTbCmp − offsetLCBX − nTbW) << iBvShift;
  iVerMin₁ = (yTbCmp + 1) << iBvShift;
  iVerMax₁ = min(picHeight − nTbH, (yTbCmp − offsetLCBY +
CtbSizeH − nTbH) << iBvShift).
```

In a case where regionId is equal to 2, iVerMin, i VerMax, iHorMin, and iHorMax may be calculated as follows:

```
  iHorMax₂ = (xTbCmp − offsetLCBX − nTbW) << iBvShift;
  iHorMin₂ = max( (iTemplateSizeW) << iBvShift, (xTbCmp −
searchRangeWidth) << iBvShift );
  iVerMin₂ = max( (iTemplateSizeH) << iBvShift, (yTbCmp −
nTbH − offsetLCBY) << iBvShift );
  iVerMax₂ = (yTbCmp) << iBvShift.
```

In a case where regionId is equal to 3, iVerMin, iVerMax, iHorMin, and iHorMax may be calculated as follows:

```
  iHorMin₃ = max( (iTemplateSizeW) << iBvShift, (xTbCmp −
offsetLCBX − nTbW + 1) << iBvShift );
  iHorMax₃ = (xTbCmp − nTbW) << iBvShift;
  iVerMin₃ = max( ((iTemplateSizeH) << iBvShift), (yTbCmp −
offsetLCBY − nTbH + 1) << iBvShift );
  iVerMax₃ = (yTbCmp − nTbH) << iBvShift.
```

In actual applications, iHorMinregionId, iHorMaxregionId, iVerMinregionId, and i VerMaxregionId here represent the left edge, right edge, top edge, and bottom edge of different search sub-regions, respectively.

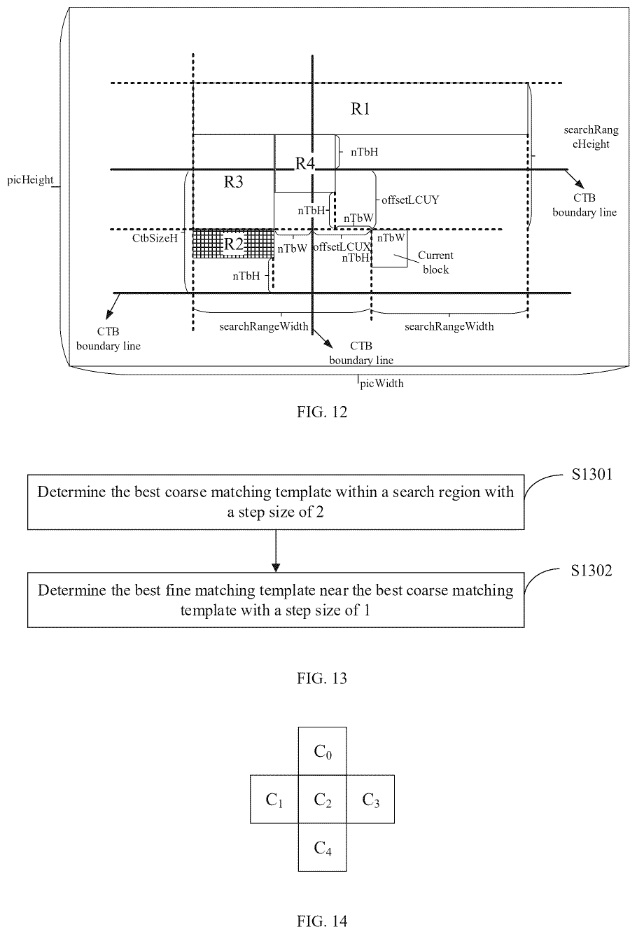

In order to visually describe different search sub-regions corresponding to different regionId, referring to FIG. 12, it shows a determination process of a specific search region provided in embodiments of the present disclosure. As illustrated in FIGS. 12, R1, R2, R3, and R4 represent four different search sub-regions. It should be noted that FIG. 12 is represented in terms of a sample range within which top-left corner samples of blocks can be aligned.

In S903, the best block vector (BV) is searched and determined within the search region.

It should be noted that, bvXMins represents the minimum offset of the block vector in the horizontal direction, and bvXMaxs represents the maximum offset of the block vector in the horizontal direction; bvYMins represents the minimum offset of the block vector in the vertical direction, and bvYMaxs represents the maximum offset of the block vector in the vertical direction.

bvXMins_{regionId}, bvXMaxS_{regionId}, bvYMins_{regionId}, and bvYMaxS_{regionId} may be calculated by iVerMin_{regionId}, iVerMax_{regionId}, iHorMin_{regionId}, and iHorMax_{regionId} determined in step S902:

bvXMins_{regionId} = iHorMin_{regionId} − xTbCmp;
bvXMaxs_{regionId} = iHorMax_{regionId} − xTbCmp;
bvYMins_{regionId} = iVerMin_{regionId} − yTbCmp;
bvYMaxs_{regionId} = iVerMax_{regionId} − yTbCmp.

The horizontal and vertical offset ranges of the search points relative to the current block (i.e., the range of the block vector (BV)) are determined by bvXMins_{regionId}, bvXMaxS_{regionId}, bvYMins_{regionId} and bvYMaxS_{regionId}.

It should also be noted that, through the search points (iPosHor, iPox Ver) in each search region, i.e., each block vector (BV, consisting of horizontal and vertical components: (pX, pY), where pX=iPosHor-xTbCmp, pY=iPos Ver-yTbCmp, pX is between bvXMins and bvXMaxs, and pY is between bvYMins and bvYMaxs. In this way, a matching reconstructed block of the current block may be found in the reconstructed region, and the neighboring reconstructed samples of the matching reconstructed block are the matching template (i.e., the second template mentioned above). Thus, the matching cost value between the neighboring template of the current block and the neighboring template of the matching reconstructed block may be calculated, which is represented as pDiff.

Furthermore, all search points in all search ranges (regionId-0, 1, 2, 3) are traversed, and a search point with the smallest matching cost value (pDiff) is obtained by comparison; the matching cost value corresponding to the search point is represented as pDiff_BEST, the block vector (BV) corresponding to the search point is represented as the best block vector (BV_BEST, i.e., (pX_BEST, pY_BEST)), and the matching template corresponding to the best block vector is the best matching template (T_BEST).

In a possible implementation, if the search strategy is that only a coarse search is performed, the implementation is as follows:
within a search range of each region in which pX is between bvXMins_{regionId} and bvXMaxS_{regionId}, and pY is between bvYMins_{regionId} and bvYMaxS_{regionId}, the coarse search is performed with a size greater than 1. For example, the coarse search is performed with a size of 2. The best matching cost value obtained by template matching is recorded as pDiff_BEST, and its corresponding block vector (BV) is recorded as the best block vector (BV_BEST, i.e., (pX_BEST, pY_BEST)).

In another possible implementation, if the search strategy is that only a fine search is performed, the implementation is as follows:
within a search range of each region in which pX is between bvXMins_{regionId} and bvXMaxS_{regionId}, and pY is between bvYMins_{regionId} and bvYMaxS_{regionId}, the fine search is performed with a size of 1 (here, 1 is only an example). The optimal matching cost value obtained by template matching is recorded as pDiff_BEST, and its corresponding block vector (BV) is recorded as the best block vector (BV_BEST, i.e., (pX_BEST, pY_BEST)).

In yet another possible implementation, if the search strategy is that a coarse search is first performed and then a fine search is performed, as illustrated in FIG. 13, the process is as follows.

In S1301, the best coarse matching template is determined within a search region with a size of 2.

In S1302, the best fine matching template is determined near the best coarse matching template with a size of 1.

It should be noted that, for step S1301, in the coarse search stage:
within a search range of each region in which pX is between bvXMins_{regionId} and bvXMaxS_{regionId}, and pY is between bvYMins_{regionId} and bvYMaxS_{regionId}, the coarse search is performed with a size greater than 1. For example, the coarse search is performed with a size of 2. The best matching cost obtained by template matching is record as pDiff1_BEST, its corresponding block vector (BV) is recorded as the best block vector (BV1_BEST, i.e., pX1_BEST and pY1_BEST), and the search region in which the best matching search point is located is recorded as bestRegionId.

It should also be noted that, for step S1302, in the fine search stage:
the search is further performed near the best block vector (BV1_BEST) obtained by the coarse search. Specifically, a refined search range (TmpRefineRange) is determined first, which may be in a fixed size or related to the size of the current block. For example, the refined search range may be set to min (nTbW, nTbH)/2. Then, a position of the best matching reconstructed block obtained by the coarse search is calculated as the reference position of the fine search region: BestPosX=xTbCmp+pX1_BEST, BestPosY=yTbCmp+pY1_BEST.

First, the values of iVerMinbestRegionId, i VerMaxbestRegionId, iHorMinbestRegionId, and iHorMaxbestRegionId calculated in step S902 are obtained according to the value of bestRegionId, and then the new search ranges i VerMinrefine, i VerMaxrefine, iHorMinrefine, and iHorMaxrefine are obtained according to the position of the best matching block obtained by the coarse search. The obtaining method is as follows:

iHorMin_{refine} = max(iHorMin_{bestRegionId}, BestPosX − TmpRefineRange);
iHorMax_{refine} = min(iHorMax_{bestRegionId}, BestPosX + TmpRefineRange);
iVerMin_{refine} = max(iVerMin_{bestRegionId}, BestPosY − TmpRefineRange);
iVerMax_{refine} = min(iVerMax_{bestRegionId}, BestPosY + TmpRefineRange).

Then, the adjusted block vectors (BV) bvXMins, bvXMaxs, bvYMins, and bvYMaxs may be calculated by i VerMin_{refine}, i VerMax_{refine}, iHorMin_{refine}, and iHorMax_{refine}:

bvXMins = iHorMin_{refine} − xTbCmp;
bvXMaxs = iHorMax_{refine} − xTbCmp;
bvYMins = iVerMin_{refine} − yTbCmp;
bvYMaxs = iVerMax_{refine} − yTbCmp.

In this way, the fine search is performed within the block vector range in which pX is between bvXMins_{refine} and bvXMaxS_{refine}, and pY is between bvYMins_{refine} and bv YMaxS_{refine}. For example, when the search is performed with a size of 1, the best matching cost obtained by template matching is recorded as pDiff_BEST, and its corresponding block vector (BV) is recorded as the best block vector (BV_BEST, i.e., (pX_BEST, pY_BEST)).

After the above processes are completed, the best block vector (BV_BEST, i.e., (pX_BEST, pY_BEST)) may be obtained, where pX_BEST is a horizontal offset of the best matching template relative to the template of the current block, and is a horizontal offset of the best matching reconstructed block relative to the current block; and pY_BEST is a vertical offset of the best matching template relative to the template of the current block, and is a vertical offset of the best matching reconstructed block relative to the current block.

In S804, a linear filter model is established.

It should be noted that the linear filter model is established using the best matching template obtained by searching in step S803 and the template of the current block. Establishing the linear filter model mainly includes the following two processes: determining a reconstructed region for calculating the filter coefficients and calculating the filter coefficients.

It should also be noted that the number of taps of the filter is defined as nTap. nTap may be a constant, or may be a variable. For example, the number of filter taps may be dynamically adjusted according to the size of the current block. In the embodiments of the present disclosure, filters of various shapes may be selected. For example, the filter of a fixed-shape as illustrated in FIG. 14 may be selected, where the number of filter taps (nTap) is 5 and the filter coefficients are C₀, C₁, C₂, C₃, and C₄.

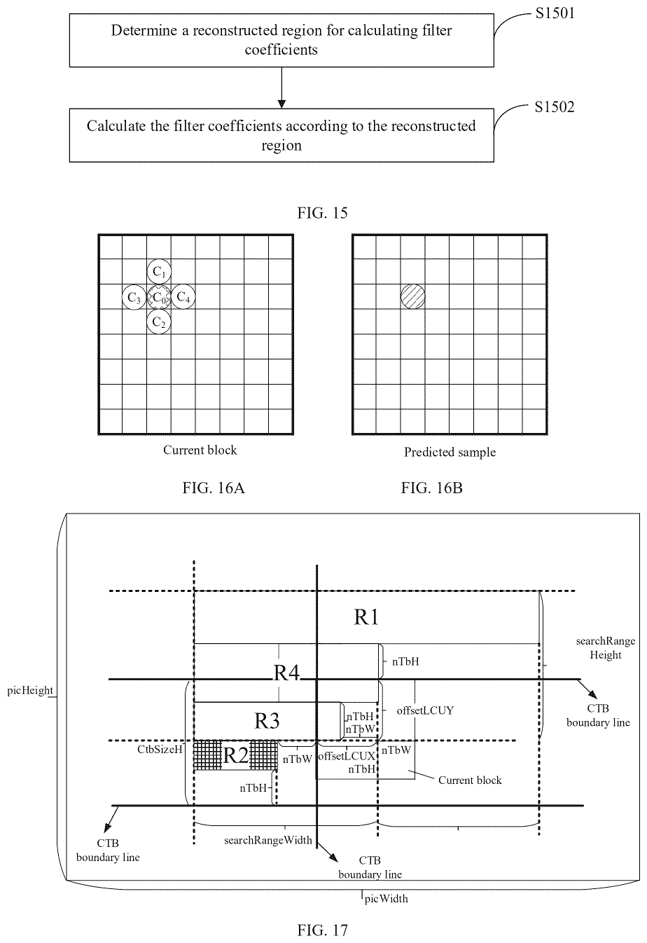

Referring to FIG. 15, it shows a schematic flowchart of calculating filter coefficients provided in embodiments of the present disclosure. As illustrated in FIG. 15, the process may include the following steps.

In S1501, a reconstructed region for calculating filter coefficients is determined.

It should be noted that, in the embodiments of the present disclosure, available reconstructed samples are determined according to the template type (refTemplateType). For example, in a case where the template type (refTemplateType) is 1, as illustrated in the aforementioned FIG. 10, it represents that left neighboring reconstructed samples, top-left neighboring reconstructed samples and top neighboring reconstructed samples are all available. In this case, the number of available reconstructed samples on the left side is templateW_size x nTbH, the number of available top reconstructed samples is templateH_size x nTbW, and the number of available reconstructed samples on the top-left side is templateW_size×templateH_size.

It should also be noted that, in the embodiments of the present disclosure, after the number of available reconstructed samples is determined, a reconstructed region for calculating the filter coefficients is determined based on the available reconstructed samples. This region may be referred to as R, and R generally includes all available reconstructed samples in the template. For example, in a case where refTemplateType is 1, R may include all available reconstructed samples on the left, the top-left, and the top sides.

In S1502, the filter coefficients are calculated according to the reconstructed region.

It should be noted that, in the embodiments of the present disclosure, after the reconstructed region (R) for calculating the filter coefficients is determined, a group of filter coefficients may be derived by minimizing MSE between the reconstructed samples in the reconstructed region (R) and the reconstructed samples in the template of the current block. That is:

$$\begin{matrix}MSE = E [ {( predTemp [ i ] [ j ] - recTemp [ i ] [ j ] )}^{2} ] \\ {= E [ {\sum }_{k , l = - 1 ∼ 1} {c}_{k , l} \cdot refTemp [ i + k ] [ j + l ] - recTemp [ i ] [ j ] )}^{2} ]\end{matrix} \qquad ( 16 )$$

where refTemp[i][j] represents reconstructed sample values that are input, recTemp[i][j] represents reconstructed sample values of the template of the current block, (i, j) represents coordinate positions, (i, j)∈R; k, l represents coordinate offsets of filter coefficient positions relative to the filter center position; taking FIG. 14 as an example, k and/are between −1 and 1, and the values of (k,l) may include (0, 0), (0,−1), (−1, 0), (0, 1), and (1, 0); and c_{k,l} represents filter coefficients that are required. In addition, E represents an operation for calculating a mean value, and in this case, the calculation formula is as follows:

$$MSE = \frac{1}{{N}_{p o s}} {\sum }_{i} {\sum }_{j} {\vert predTemp [ i ] [ j ] - recTemp [ i ] [ j ] \vert}^{2} \qquad ( 17 )$$

where Nₚₒₛ refers to the number of (i, j) pairs involved in calculating for |predTemp[i][j]-recTemp[i][j] |2. For example, still taking FIG. 14 as an example, if the number of (i, j) pairs involved in the calculation is 5, then the value of Nₚₒₛ is equal to 5.

Furthermore, the process of deriving the filter coefficients by minimizing MSE is as follows.

First, a partial derivative of C_{k,l} is calculated and is set to 0. That is:

$$\frac{\partial M S E}{\partial {c}_{m}} = E [ 2 ( {\sum }_{k , l = - 1 ∼ 1} {c}_{k , l} \cdot refTemp [ i + k ] [ j + l ] - recTemp [ i ] [ j ] ) \cdot refTemp [ i + m ] [ j + n ] ] \qquad ( 18 )$$

$$E [ 2 ( {\sum }_{k , l = - 1 ∼ 1} {c}_{k , l} \cdot refTemp [ i + k ] [ j + l ] - recTemp [ i ] [ j ] ) \cdot refTemp [ i + m ] [ j + n ] ] = 0 \qquad ( 19 )$$

where k and/are between −1 and 1, and m and n are between −1 and 1.

Here, according to formulas (18) and (19), it is obtained that:

$${\sum }_{k , l = - 1 ∼ 1} {c}_{k , l} \cdot E ( refTemp [ i + k ] [ j + l ] \cdot refTemp [ i + m ] [ j + n ] ) = E ( recTemp [ i ] [ j ] \cdot refTemp [ i + m ] [ j + n ] ) \qquad ( 20 )$$

Second, after the reconstructed region (R) is determined, the obtained equation is expanded into a matrix form, as follows:

$$[ \begin{matrix}E ( refTemp [ i ] [ j ] \cdot refTemp [ i ] [ j ] ) & E ( refTemp [ i - 1 ] [ j ] \cdot refTemp [ i ] [ j ] ) & … & E ( refTemp [ i ] [ j + 1 ] \cdot refTemp [ i ] [ j ] ) \\ E ( refTemp [ i ] [ j ] \cdot refTemp [ i - 1 ] [ j ] ) & E ( refTemp [ i - 1 ] [ j ] \cdot refTemp [ i - 1 ] [ j ] ) & … & E ( refTemp [ i ] [ j + 1 ] \cdot refTemp [ i - 1 ] [ j ] ) \\ ⋮ & ⋮ & ⋱ & ⋮ \\ E ( refTemp [ i ] [ j ] \cdot refTemp [ i ] [ j + 1 ] ) & E ( refTemp [ i - 1 ] [ j ] \cdot refTemp [ i ] [ j + 1 ] ) & … & E ( refTemp [ i ] [ j + 1 ] \cdot refTemp [ i ] [ j + 1 ] )\end{matrix} ] \times [ \begin{matrix}{c}_{0 , 0} \\ {c}_{- 1 , 0} \\ ⋮ \\ {c}_{0 , 1}\end{matrix} ] = [ \begin{matrix}{\sum }_{i ∈ R} ( refTemp [ i ] [ j ] \cdot refTemp [ i ] [ j ] ) \\ {\sum }_{i ∈ R} ( refTemp [ i ] [ j ] \cdot refTemp [ i - 1 ] [ j ] ) \\ ⋮ \\ {\sum }_{i ∈ R} ( refTemp [ i ] [ j ] \cdot refTemp [ i ] [ j + 1 ] )\end{matrix} ] \qquad ( 21 )$$

Third, the autocorrelation matrix of refTemp in the reconstructed region (R) and the cross-correlation vector of refTemp and recTemp are known quantities, and the filter coefficients c_{k,l} may be calculated by solving the equation group of formula (20). The filter coefficients c_{k,l} may be or may not be processed by point-fixing.

It should also be noted that, in the process of solving the equation group, the autocorrelation matrix of the reconstructed samples (refTemp) in the reconstructed region (R) is first calculated, and then the cross-correlation vector between refTemp and the reconstructed samples (recTemp) in the current template is calculated. Then, the autocorrelation matrix is subjected to Cholesky decomposition or LDL decomposition, and finally, each filter coefficient cn is calculated in sequence by reverse recursion. The group of filter coefficients may be or may not be processed by point-fixing.

In S805, a prediction value is generated.

It should be noted that, for each current block, a group of filter coefficients may be obtained through the above manner, and the group of filter coefficients is co, C₁, C₂ . . . . C_{nTap-1}. Then, the best matching reconstructed block is filtered according to the filter shape and filter coefficients. That is, the current samples to be predicted are obtained by performing a weighted sum on the filter coefficients and the reference samples at the corresponding positions. ref represents the best matching reconstructed block, which is defined as follows:

$$r e f [ i ] [ j ] = recSamples [ i + pX\_BEST ] [ j + pY\_BEST ] \qquad ( 22 )$$

where i=0, . . . , nTbW−1, j=0, . . . , nTbH−1, recSamples represents the reconstructed samples of the current picture, and pX_BEST and pY_BEST are the of the best block vector.

It should also be noted that the specific calculation process of the prediction value is as follows:
assuming the number of filter taps (nTap) is 5, a shape of the filter (which is also referred to as “filter template”) is illustrated in FIG. 16A, where C₀ to C₄ are the tap coefficients of the filter. The dot filled with grid corresponding to the tap coefficient C₀ is the reconstructed sample ref[i][j] at the corresponding position of the current sample Y^{pred}[i][j] to be predicted in the best matching block (i.e., the reference block mentioned above); the other dots filled with white are reconstructed samples adjacent to the current spatial position in the best matching block. Thus, according to the filter of FIG. 16A, the predicted sample Y^{pred}[i][j] finally obtained is shown as the dot filled with diagonal lines in FIG. 16B.

The calculation process of the prediction value is as follows:

For each current sample (i, j) to be predicted, the pixel position in the filter template is defined as (k,l), the corresponding reconstructed sample in the best matching block during filtering is defined as ref[i+k][j+/], and each filter coefficient at the position (k, I) in the filter template is defined as c_{k,l}:

$$\begin{matrix}{c}_{k , l} = {c}_{n} \\ where n = 0 , … , nTap - 1 , k and l are between - 1 and 1.\end{matrix} \qquad ( 23 )$$

For i=0, . . . , nTbW−1, j=0, . . . , nTbH−1:

$${Y}^{Pred} [ i ] [ j ] = {\sum }_{k} {\sum }_{l} r e f [ i + k ] [ j + l ] \times {c}_{k , l} \qquad ( 24 )$$

Furthermore, a clipping operation that sets Y^{pred}[i][j] to be within a preset value range may be performed to obtain the final predicted sample. The details are as follows:

$$predSamples [ i ] [ j ] = Clip 3 ( 0 , ( 1 << BitDepth ) - 1 , {Y}^{pred} [ i ] [ j ] ) \qquad ( 25 )$$

where for the clip function, the details are as follows:

$$Clip 3 ( x , y , z ) = \{ \begin{matrix}x ; z < x \\ y ; z > y \\ z ; otherwise\end{matrix} \qquad ( 26 )$$

It can be understood that, in the embodiments of the present disclosure, the linear filter model is established between the best matching template obtained by search and the template of the current block, the filter coefficient is obtained by minimizing MSE between the prediction template (prediction template=filter coefficient × matching template) and the template of the current block, the best matching block is filtered and corrected, and the filtered reconstructed samples are used as the final predicted samples.

In some embodiments, the input information for calculating the filter coefficients in the aforementioned embodiments may be expanded. The input information for calculating the filter coefficients may be available reconstructed samples in the matching template. Alternatively, the gradient of each sample in the matching template may be calculated, and the calculated gradients are used as the input information for calculating the filter coefficients, where the gradients include but not limited to a horizontal gradient, a vertical gradient, etc. Alternatively, position information of each sample may be used as the input information for calculating the filter coefficients. The position information may be absolute position information of each sample in an entire picture, or may be relative position information of each sample relative to a certain reference point.

In some embodiments, the implementation for calculating the filter coefficients in the aforementioned embodiments may be expanded. The filter coefficients finally calculated are the tap coefficients corresponding to the filter template. That is, the number of filter coefficients is equal to the number of taps (nTap) of the filter template. In addition, several bias items (bias) may be added to the filter template. For example, in the above embodiments, when nTap=5, the filter coefficients are the tap coefficients (c₀ to c₄) corresponding to the filter template, and the prediction value obtained by calculating the position (i, j) is:

$${Y}^{pred} [ i ] [ j ] = {\sum }_{n = 0}^{4} ref [ k ] [ l ] \times {c}_{n} \qquad ( 27 )$$

In this case, the bias term may be added to obtain the following formula:

$${Y}^{pred} [ i ] [ j ] = {\sum }_{n = 0}^{4} r e f [ k ] [ l ] \times {c}_{n} + {C}_{5} \times Constant \qquad ( 28 )$$

where cₙ=C_{i,j,k,l}. In addition, Constant may be a fixed constant (for example, Constant =1<< (BitDepth-1)); or Constant may be a number related to the reconstructed sample value at the position (i, j) in the reference block (for example, Constant=f(ref[i][j])); or Constant may be a number related to the reconstructed sample value corresponding to a tap in the filter template other than the position (i, j) (for example, Constant=f(ref[k][/])). Constant=f(ref[i][j]) or Constant=f(ref[k][/]) may be a linear mapping relationship, or may be a nonlinear mapping relationship. One or more bias terms may be added.

In some embodiments, the number of filter models in the aforementioned embodiments may be expanded. Only one linear filter model may be established, or a plurality of linear filter models may be established. Here, the input information for calculating the filter coefficients is classified, and a filter model is established for each category of input information. For example, in a case where reconstructed information is used to establish filter models, one possible implementation is classifying the reconstructed information by its mean value, the reconstructed information greater than the mean value is used to establish a model, and the reconstructed information less than the mean value is used to establish a model.

Another possible implementation is that classifying is performed using the positions of the reconstructed information. For example, a model may be established using the available reconstructed information on the left and top sides, and a second model may be established using the available reconstructed information on the left and top-left sides, and so on. The encoding side determines which model to be used. One possible decision-making mode is that the encoding side determines which model to be used through rate-distortion optimization and transmits the corresponding decoding parameters (e.g., flag (Flag)) to the decoding side.

Yet another possible implementation is that classifying is performed using the shapes of filters. A plurality of filters with different shapes may be used, and a filter model is established for the filter of each shape. The encoding side determines which shape of filter to be used. One possible decision-making mode is that the encoding side determines which filter to be used by rate-distortion optimization and transmits corresponding decoding parameters (e.g., flag (Flag)) to the decoding side.

In some embodiments, the types of filter models in the aforementioned embodiments may be expanded. A linear filter model may be established, or a nonlinear filter model may be established for filtering. One possible implementation is that a quadratic term is introduced to establish the nonlinear filter model. For example, when MSE of the filter coefficients is minimized, the calculation formula is changed to the following:

$$\begin{matrix}MSE = E [ {( predTemp [ i ] [ j ] - recTemp [ i ] [ j ] )}^{2} ] \\ = E [ {( {\sum }_{k , l = - 1 ∼ 1} {c}_{k , l} \cdot {( refTemp [ i + k ] [ j + l ] )}^{2} - recTemp [ i ] [ j ] )}^{2} ]\end{matrix} \qquad ( 29 )$$

In this case, the calculation formula for calculating the prediction value is modified as follows:

$${Y}^{pred} [ i ] [ j ] = {\sum }_{k} {\sum }_{l} {( r e f [ i + k ] [ j + l ] )}^{2} \times {C}_{k , l} \qquad ( 30 )$$

In some embodiments, partial expansion may be performed on the calculation of the prediction value in the aforementioned embodiments. Whether the current block uses the filtered reference block as the final prediction value is determined by certain conditions. For example, there are several modes:

Mode 1: whether to perform filtering on the matching template is determined by comparing the distortion between the matching template and the template of the current block (e.g., SAD, or MSE, or SATD, or SSE) with the threshold T_Distortion1;

Mode 2: on the basis of using the filter model in mode 1, the distortion between the filtered matching template and the template of the current block (e.g., SAD, or MSE, or SATD, or SSE) and the threshold T_Distortion2 are used to determine whether to filter the reference block.

Mode 3: the encoding side transmits Flag to indicate whether the filter model is applied. tmpFlag indicates whether the intra template matching is applied to the current block, and filterFlag indicates whether the filter model is applied to the current block. When tmpFlag is 1, the encoding side determines whether to perform filtering on the reference block by comparing the distortion between the reference block and the original block before and after filtering, such as SAD, MSE, SATD, or SSE. If the distortion after filtering is less than the distortion before filtering, filterFlag is set to 1, and the current block uses the filtered reference block as the prediction block. Otherwise, filterFlag is set to 0, the current block uses the reference block before filtering as the prediction block, and the encoding side transmits filterFlag to the decoding side.

In some embodiments, the implementation in FIG. 7A is performed, which is implemented by partitioning the search region into four search sub-regions.

In a case where regionId is equal to 0, iVerMin, iVerMax, iHorMin, and iHorMax may be calculated as follows:

```
  iHorMax = min( (xTbCmp + searchRangeWidth) << iBvShift,
((picWidth − nTbW) << iBvShift) );
  iHorMin = max( (iTemplateSizeW) << iBvShift, (xTbCmp −
searchRangeWidth) << iBvShift );
  iVerMax = (yTbCmp − nTbH − offsetLCBY) << iBvShift;
  iVerMin = max( ((iTemplateSizeH) << iBvShift), ((yTbCmp −
searchRangeHeight) << iBvShift) ).
```

In a case where regionId is equal to 1, iVerMin, iVerMax, iHorMin, and iHorMax may be calculated as follows:

```
  iHorMin = max( (iTemplateSizeW) << iBvShift, (xTbCmp −
searchRangeWidth) << iBvShift );
  iHorMax = (xTbCmp − offsetLCBX − nTbW) << iBvShift;
  iVerMin = (yTbCmp + 1) << iBvShift;
  iVerMax = min(picHeight − nTbH, (yTbCmp − offsetLCBY +
CtbSizeH − nTbH) << iBvShift ).
```

In a case where regionId is equal to 2, iVerMin, iVerMax, iHorMin, and iHorMax may be calculated as follows:

```
  iHorMax = (xTbCmp − nTbW) << iBvShift;
  iHorMin = max( (iTemplateSizeW) << iBvShift, (xTbCmp −
searchRangeWidth) << iBvShift );
  iVerMin = max( (iTemplateSizeH) << iBvShift, (yTbCmp − nTbH) <<
  iBvShift );
  iVerMax = (yTbCmp) << iBvShift.
```

In a case where regionId is equal to 3, iVerMin, i VerMax, iHorMin, and iHorMax may be calculated as follows:

```
  iHorMin = max( (iTemplateSizeW) << iBvShift, (xTbCmp −
searchRangeWidth) << iBvShift );
  iHorMax = (xTbCmp) << iBvShift;
  iVerMin = max( ((iTemplateSizeH) << iBvShift), (yTbCmp −
offsetLCBY − nTbH + 1) << iBvShift );
  iVerMax = (yTbCmp − nTbH) << iBvShift.
```

In actual applications, iHorMin, iHorMax, iVerMin, and i VerMax here represent the left edge, right edge, top edge, and bottom edge of different search regions, respectively.

In order to visually describe different search sub-regions corresponding to different regionId, referring to FIG. 17, it shows another determination process of a specific search region provided in embodiments of the present disclosure. As illustrated in FIGS. 17, R1, R2, R3, and R4 represent four different search sub-regions. It should be noted that FIG. 17 is represented in terms of a sample range within which the top-left corner samples of blocks may be aligned.

In some embodiments, the search region for the template in the current frame provided here may be different from the search region for the template, determined in the existing Intra TMP technology, in the current frame. Another implementation in FIG. 7B is performed, which is implemented by partitioning the search region into four sub-regions.

In a case where regionId is equal to 0, i VerMin, iVerMax, iHorMin, and iHorMax may be calculated as follows:

```
  iHorMax = min( (xTbCmp + searchRangeWidth) << iBvShift,
((picWidth − nTbW) << iBvShift) );
  iHorMin = max( (iTemplateSizeW) << iBvShift, (xTbCmp −
searchRangeWidth) << iBvShift );
  iVerMax = (yTbCmp − nTbH − offsetLCBY) << iBvShift;
  iVerMin = max( ((iTemplateSizeH) << iBvShift), ((yTbCmp −
searchRangeHeight) << iBvShift) ).
```

In a case where regionId is equal to 1, iVerMin, i VerMax, iHorMin, and iHorMax may be calculated as follows:

```
  iHorMin = max( (iTemplateSizeW) << iBvShift, (xTbCmp −
searchRangeWidth) << iBvShift );
  iHorMax = (xTbCmp − offsetLCBX − nTbW) << iBvShift;
  iVerMin = (yTbCmp + 1) << iBvShift;
  iVerMax = min(picHeight − nTbH, (yTbCmp − offsetLCBY +
CtbSizeH − nTbH) << iBvShift ).
```

In a case where regionId is equal to 2, iVerMin, i VerMax, iHorMin, and iHorMax may be calculated as follows:

```
  iHorMax = (xTbCmp − nTbW) << iBvShift;
  iHorMin = max( (iTemplateSizeW) << iBvShift, (xTbCmp −
searchRangeWidth) << iBvShift );
  iVerMin = max( (iTemplateSizeH) << iBvShift, (yTbCmp − nTbH −
offsetLCBY) << iBvShift );
  iVerMax = (yTbCmp) << iBvShift.
```

In a case where regionId is equal to 3, iVerMin, iVerMax, iHorMin, and iHorMax may be calculated as follows:

```
  iHorMin = max( (iTemplateSizeW) << iBvShift, (xTbCmp − nTbW +
  1) << iBvShift );
  iHorMax = (xTbCmp) << iBvShift;
  iVerMin = max( ((iTemplateSizeH) << iBvShift), (yTbCmp −
offsetLCBY − nTbH + 1) << iBvShift );
  iVerMax = (yTbCmp − nTbH) << iBvShift.
```

In actual applications, iHorMin, iHorMax, iVerMin, and i VerMax here represent the left edge, right edge, top edge, and bottom edge of different search regions, respectively.

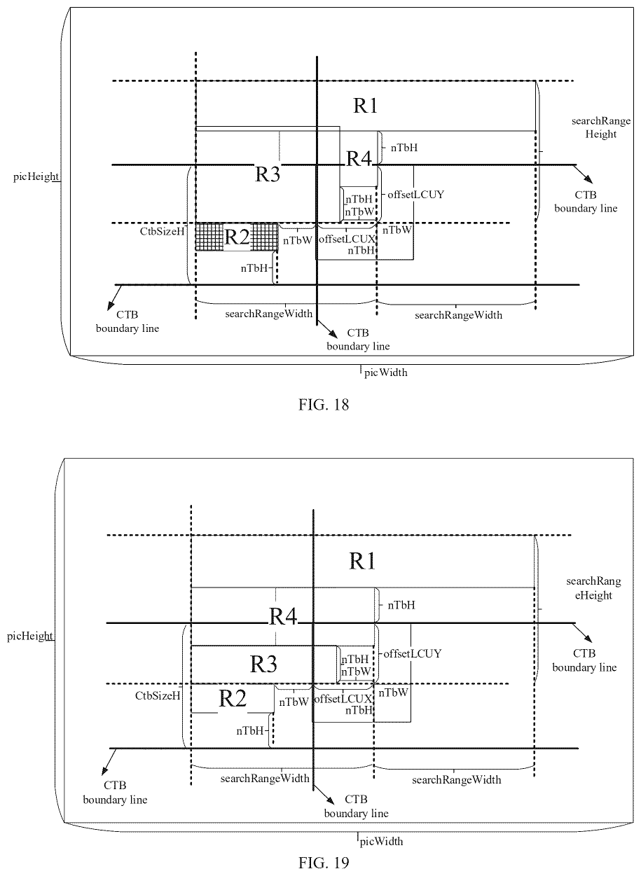

In order to visually describe different search sub-regions corresponding to different regionId, referring to FIG. 18, it shows yet another determination process of a specific search region provided in embodiments of the present disclosure. As illustrated in FIGS. 18, R1, R2, R3, and R4 represent four different search sub-regions. It should be noted that FIG. 18 is represented in terms of a sample range within which the top-left corner samples of blocks may be aligned.

In some embodiments, a coarse search process may be consistent with the aforementioned embodiments, and in a fine search process, the method of each region boundary may be used. That is, the technical solution of cross-boundary fine search between various search regions is expanded here. In the embodiments of the present disclosure, the method may further include:
performing a first search within at least one search sub-region to determine a best block vector of each search sub-region and a corresponding second search region;
performing a region determination according to the best block vector of each search sub-region and the corresponding second search region to determine at least two target search sub-regions participating in a second search;
performing the second search within the at least two target search sub-regions to determine a best block vector corresponding to the at least two target search sub-regions; and
using the best block vector corresponding to the at least two target search sub-regions as the target block vector.

For example, taking FIG. 7A as an example, another implementation is provided here, which is implemented by partitioning the search region into four search sub-regions.

In a case where regionId is equal to 0, i VerMin, i VerMax, iHorMin, and iHorMax may be calculated as follows:

```
  iHorMax₀ = min( (xTbCmp + searchRangeWidth) << iBvShift,
((picWidth − nTbW) << iBvShift) );
  iHorMin₀ = max( (iTemplateSizeW) << iBvShift, (xTbCmp −
searchRangeWidth) << iBvShift );
  iVerMax₀ = (yTbCmp − nTbH − offsetLCBY) << iBvShift;
  iVerMin₀ = max( ((iTemplateSizeH) << iBvShift), ((yTbCmp −
searchRangeHeight) << iBvShift) ).
```

In a case where regionId is equal to 1, iVerMin, i VerMax, iHorMin, and iHorMax may be calculated as follows:

```
  iHorMin₁ = max( (iTemplateSizeW) << iBvShift, (xTbCmp −
searchRangeWidth) << iBvShift );
  iHorMax₁ = (xTbCmp − offsetLCBX − nTbW) << iBvShift;
  iVerMin₁ = (yTbCmp + 1) << iBvShift;
  iVerMax₁ = min(picHeight − nTbH, (yTbCmp − offsetLCBY +
CtbSizeH − nTbH) << iBvShift ).
```

In a case where regionId is equal to 2, iVerMin, i VerMax, iHorMin, and iHorMax may be calculated as follows:

```
  iHorMax₂ = (xTbCmp − nTbW) << iBvShift;
  iHorMin₂ = max( (iTemplateSizeW) << iBvShift, (xTbCmp −
searchRangeWidth) << iBvShift );
  iVerMin₂ = max( (iTemplateSizeH) << iBvShift, (yTbCmp − nTbH) <<
  iBvShift );
  iVerMax₂ = (yTbCmp) << iBvShift.
```

In a case where regionId is equal to 3, iVerMin, iVerMax, iHorMin, and iHorMax may be calculated as follows:

```
  iHorMin₃ = max( (iTemplateSizeW) << iBvShift, (xTbCmp −
searchRangeWidth) << iBvShift );
  iHorMax₃ = (xTbCmp) << iBvShift;
  iVerMin₃ = max( ((iTemplateSizeH) << iBvShift), (yTbCmp −
offsetLCBY − nTbH + 1) << iBvShift );
  iVerMax₃ = (yTbCmp − nTbH) << iBvShift.
```

In actual applications, iHorMin, iHorMax, iVerMin, and iVerMax here represent the left edge, right edge, top edge, and bottom edge of different search regions, respectively.

In order to visually describe different search sub-regions corresponding to different regionId, referring to FIG. 19, it shows still another determination process of a specific search region provided in embodiments of the present disclosure. As illustrated in FIGS. 19, R1, R2, R3, and R4 represent four different search sub-regions, and the fine search is performed across the boundaries of the search sub-regions. It should be noted that FIG. 19 is represented in terms of a sample range within which the top-left corner samples of blocks may be aligned.

In the fine search stage, a search is performed near each block vector obtained by the coarse search.

Furthermore, the search is performed near the best block vector (BV1_BESTₖ) obtained by the coarse search. Specifically, a refined search range (TmpRefineRange) is first determined, which may be in a fixed size or related to the size of the current block. For example, the refined search range may be set to min (nTbW, nTbH)/2. Then, a position of the best matching reconstructed block obtained by the coarse search is calculated as the reference position of the fine search region: BestPosXk=xTbCmp+pX1_BESTk, BestPosYk=yTbCmp+pY1_BESTk.

Furthermore, the fine search implemented according to each BestPosXk may be performed across a plurality of regions:
determining a value of bestRegionId involved in the calculation: for regionId=0, 1, 2, 3, making determination in turn:

```
  if BestPosYₖ − TmpRefineRange >= iVerMin_{regionId}, and BestPosYₖ −
TmpRefineRange <= iVerMax_{regionId}, or
  BestPosYₖ + TmpRefineRange >= iVerMin_{regionId}, and BestPosYₖ+
TmpRefineRange <= iVerMax_{regionId}, or
  BestPosYₖ − TmpRefineRange <= iVerMin_{regionId}, and BestPosYₖ+
TmpRefineRange >= iVerMax_{regionId},
  then a corresponding bestSearchFlag_{regionId} is set to 1 for this regionId.
```

For each of search regions with the value of bestSearchFlagregionId being 1, bestRegionId is set to regionId of the region in turn, and the following fine search is performed, as follows:

First, the values of i VerMinbestRegionId, i VerMaxbestRegionId, iHorMinbestRegionId, and iHorMaxbestRegionla calculated above are obtained according to the value of bestRegionId, and then the new search ranges i VerMin_{refine}, i VerMax_{refine}, iHorMin_{refine}, and iHorMax_{refine} are obtained according to the position of the best matching block obtained by the coarse search. The obtaining method is as follows:

iHorMin_{refine} = max(iHorMin_{bestRegionId}, BestPosX − TmpRefineRange);
iHorMax_{refine} = min(iHorMax_{bestRegionId}, BestPosX + TmpRefineRange);
iVerMin_{refine} = max(iVerMin_{bestRegionId}, BestPosY − TmpRefineRange);
iVerMax_{refine} = min(iVerMax_{bestRegionId}, BestPosY + TmpRefineRange).

Then, the adjusted block vectors (BV) bvXMins, bvXMaxs, bvYMins, and bvYMaxs may be calculated by i VerMin_{refine}, i VerMax_{refine}, iHorMin_{refine}, and iHorMax_{refine}:

bvXMins = iHorMin_{refine} − xTbCmp;
bvXMaxs = iHorMax_{refine} − xTbCmp;
bvYMins = iVerMin_{refine} − yTbCmp;
bvYMaxs = iVerMax_{refine} − yTbCmp.

In this way, the fine search is performed within the block vector range in which pX is between bvXMins_{refine} and bvXMaxs_{refine} and pY is between bvYMins_{refine} and bvYMaxS_{refine}. For example, when the search is performed with a size of 1, the best matching cost obtained by template matching is recorded as pDiff_BEST, and its corresponding block vector (BV) is recorded as the best block vector (BV_BEST, i.e., (pX_BEST, pY_BEST)), so as to obtain a total best block vector of the plurality of regions participating in the search.

After the above processes are completed, the best block vector (BV_BEST, i.e., (pX_BEST, pY_BEST)) may be obtained, where pX_BEST is a horizontal offset of the best matching template relative to the template of the current block, and is a horizontal offset of the best matching block relative to the current block; and pY_BEST is a vertical offset of the best matching template relative to the template of the current block, and is a vertical offset of the best matching block relative to the current block.

In summary, the embodiments of the present disclosure proposes the intra template matching prediction based on filter-based linear model (Intra TMP-FLM) technology, in which a linear filter model is established using information of the matching template and the template of the current block, correlation between the matching template and the template of the current coding block is fully used, reconstructed samples of the best matching block (i.e., the reference block) are filtered and corrected, and the filtered reconstructed samples are used as predicted samples. Thus, the prediction accuracy is improved to a certain extent, and the problem of linear changes between the best matching block and the current block is effectively solved.

In the embodiments of the present disclosure, the implementation of the aforementioned embodiments is described in detail through the above embodiments, from which it can be seen that, according to the technical solution of the aforementioned embodiments, the prediction value of the intra template matching technology may be effectively corrected, thereby improving the prediction accuracy. Specifically, the linear filter model is established between the best matching template obtained by search and the template of the current block, and the filter coefficient is calculated by minimizing MSE between the prediction template (prediction template=filter coefficient X matching template) and the template of the current coding block. The filter coefficients fully reflect the correlation between the matching template and the template of the current block; this correlation is applied to the best matching block to filter and correct reconstructed samples of the best matching block, and finally, the filtered reconstructed samples are used as predicted samples, thereby improving the prediction accuracy.

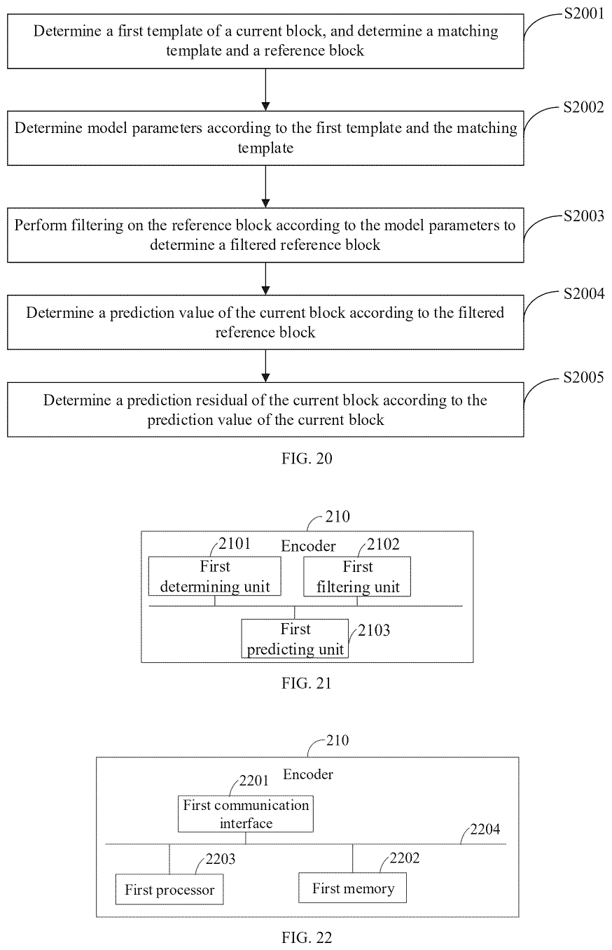

In yet another embodiment of the present disclosure, referring to FIG. 20, it shows a schematic flowchart of an encoding method provided in embodiments of the present disclosure. As illustrated in FIG. 20, the method may include the following steps.

In S2001, a first template of a current block is determined, and a matching template and a reference block are determined.

It should be noted that the encoding method in the embodiments of the present disclosure is applied to an encoder. In addition, the encoding method may specifically refer to an intra prediction method, and more specifically, refer to an intra prediction method based on the Intra TMP-FLM technology. A video picture may be partitioned into a plurality of coding blocks, and the current block in the embodiments of the present disclosure refers to a coding block in the video picture that is currently to be intra-predicted. In addition, the encoding method in the embodiments of the present disclosure may be used not only to predict a luma component, but also to predict a chroma component, which is not specifically limited here.

It should also be noted that, in the embodiments of the present disclosure, it is necessary to first determine the first template of the current block. In some embodiments, determining the first template of the current block may include:
determining a template type of the current block; and
determining the first template of the current block according to the template type of the current block.

The template type may be represented by refTemplateType. In some embodiments, determining the template type of the current block may include: determining the template type of the current block according to reference samples of the current block.

The reference samples of the current block include at least one of the following: left neighboring reference samples of the current block, top neighboring reference samples of the current block, top-left neighboring reference samples of the current block, bottom-left neighboring reference samples of the current block, or top-right neighboring reference samples of the current block.

Furthermore, template types may be classified according to whether the neighboring reference samples are available, and the template type of the current block may be determined. In some embodiments, determining the template type of the current block may include:
if the left neighboring reference samples of the current block, the top neighboring reference samples of the current block, and the top-left neighboring reference samples of the current block are all available, determining the template type of the current block to be a first value;
if the left neighboring reference samples of the current block are available, determining the template type of the current block to be a second value;
if the top neighboring reference samples of the current block are available, determining the template type of the current block to be a third value;
if both the left neighboring reference samples of the current block and the top-left neighboring reference samples of the current block are available, determining the template type of the current block to be a fourth value;
if both the left neighboring reference samples of the current block and the bottom-left neighboring reference samples of the current block are available, determining the template type of the current block to be a fifth value; or if both the top neighboring reference samples of the current block and the top-right neighboring reference samples of the current block are available, determining the template type of the current block to be a sixth value.

In the embodiments of the present disclosure, the first value, the second value, the third value, the fourth value, the fifth value and the sixth value may be different. For example, the first value may be set to 1, the second value may be set to 2, the third value may be set to 3, the fourth value may be set to 4, the fifth value may be set to 5, and the sixth value may be set to 6. In addition, for these six template types, reference may be made to FIGS. 3A to 3F for details.

In some embodiments, determining the first template of the current block according to the template type of the current block may include: obtaining template samples of the current block according to the template type and a corresponding template size of the current block; and determining the template samples of the current block as the first template of the current block.

In the embodiments of the present disclosure, the template size may be set in advance, or may be determined according to the size of the current block, or may even be related to the template type of the current block, which is not specifically limited here. For example, if the template type indicates that only the left template is to be obtained, the template width (templateW_size) may be set to 4; if the template type indicates that only the top template is to be obtained, the template height (templateH_size) may be set to 4.

In the embodiments of the present disclosure, which part of the reconstructed samples is obtained for the first template may be determined according to the value of the template type. For example, in a case where the value of refTemplateType is 1, the reconstructed samples on the left side of the current block, the reconstructed samples on the top-left side of the current block and the reconstructed samples on the upper side of the current block are obtained; in a case where the value of refTemplateType is 2, only 4 columns of reconstructed samples on the left side of the current block are obtained; in a case where the value of refTemplateType is 3, only 4 rows of reconstructed samples on the top side of the current block are obtained.

For the matching template and the reference block, in a possible implementation, determining the matching template and the reference block may include: determining motion parameters and a corresponding reference block; and determining the matching template according to the first template and the reference block.

Accordingly, in some embodiments, the method may further include: encoding the motion parameters to signal obtained encoded bits into a bitstream. That is, after the encoding side determines the motion parameters (e.g., BV), the motion parameters may be written into a bitstream. Subsequently, the decoding side may directly determine the motion parameters by decoding the bitstream, and then determine the reference block of the current block; and then the matching template is determined through the reference block according to the first template of the current block.

For the matching template and the reference block, in another possible implementation, determining the matching template and the reference block may include: performing template matching within a preset search region according to the first template to determine the matching template; and determining the reference block according to the matching template.

In some embodiments, performing template matching within the preset search region according to the first template to determine the matching template may include: performing a search within the preset search region based on the first template to determine a target block vector; and determining the matching template according to the target block vector.

That is, the search may be performed within the preset search region according to the first template, and a matching template with the minimum cost may be searched out according to a preset cost function. By traversing all search points within the preset search region, one or more candidate block vectors may be obtained, and the one or more candidate block vectors may indicate one or more candidate matching templates; cost calculation is performed on the one or more candidate matching templates with the first template of the current block, then the search point with the minimum cost is obtained by comparison, and the candidate block vector corresponding to the search point with the minimum cost is the best block vector (i.e., the target block vector, BV_BEST); the candidate matching template corresponding to best block vector is the best matching template (i.e., the matching template described in the embodiments, T_BEST); and the reference block may be determined according to the best matching template.

In the embodiments of the present disclosure, the preset cost function may be the sum of absolute difference (SAD), the sum of absolute transformed difference (SATD), the mean square error (MSE), the sum of squared differences (SSD), the mean absolute deviation (MAD), the mean square differences (MSD), or the normalized correlation coefficient (NCC), which is not specifically limited here.

It can be understood that the search process within the preset search region may be a coarse search, or may be a fine search, or may be a search that a coarse search is performed first and then a fine search is performed; and the details are as follows.

In a possible implementation, performing the search within the preset search region based on the first template to determine the target block vector may include: performing a first search within the preset search region to determine the target block vector.

In another possible implementation, performing the search within the preset search region based on the first template to determine the target block vector may include: performing a second search within the preset search region to determine the target block vector.

In yet another possible implementation, performing the search within the preset search region based on the first template to determine the target block vector may include: performing a first search within the preset search region to determine a first block vector, and determining an initial matching template according to the first block vector; determining a first search region according to the initial matching template, and performing a second search within the first search region to determine the target block vector.

It should be noted that, in the embodiments of the present disclosure, a search step corresponding to the first search is greater than a search step corresponding to the second search. For example, the search step corresponding to the first search is 2, and the search step corresponding to the second search is 1. Alternatively, a downsampling factor corresponding to the first search is greater than a downsampling factor corresponding to the second search. For example, the downsampling factor corresponding to the first search is 4, and the downsampling factor corresponding to the second search is 2. That is, the first search is a coarse search, and the second search is a fine search. Features capable of reflecting that the first search is coarser than the second search are acceptable, which is not specifically limited here.

It should also be noted that, when the first search is performed first and then the second search is performed, not only is the search step corresponding to the first search greater than the search step corresponding to the second search, but also the first search region is smaller than the preset search region. The first search region is a search region near the initial matching template. For example, the best coarse matching template may be first determined within the preset search region with a size of 2, and then the best fine matching template (i.e., the final matching template) may be determined near the best coarse matching template with a size of 1.

In yet another possible implementation, the preset search region may include at least one search sub-region; and performing the search within the preset search region based on the first template to determine the target block vector may include:
performing the search within the at least one search sub-region to determine a best block vector of each search sub-region and a corresponding matching cost value;
determining a best block vector corresponding to a minimum matching cost value according to the best block vector of each search sub-region and the corresponding matching cost value; and
using the best block vector corresponding to the minimum matching cost value as the target block vector.

In still another possible implementation, the preset search region may include at least one search sub-region; and performing the search within the preset search region based on the first template to determine the target block vector may include:
performing a first search within the at least one search sub-region to determine a best block vector of each search sub-region and a corresponding second search region;
performing a region determination according to the best block vector of each search sub-region and the corresponding second search region to determine at least two target search sub-regions participating in a second search;
performing the second search within the at least two target search sub-regions to determine a best block vector corresponding to the at least two target search sub-regions; and
using the best block vector corresponding to the at least two target search sub-regions as the target block vector.

It should be noted that, in the embodiments of the present disclosure, the search region of the template of the current block may be the reconstructed part of CTB in which the current block is located, or may be another reconstructed CTB region. Here, the search region is actually a collection of all search points. Since a shape of the region cannot usually be represented by a single rectangular region, in an implementation, the search may be performed in a plurality of rectangular regions, and then the search results of different regions may be combined to obtain the final best reference block and the best block vector.

It should also be noted that, in the embodiment of the present disclosure, taking FIG. 7F as an example, the preset search region is partitioned into four search sub-regions, each of which is represented by regionId, and the value of regionId may be equal to 0, 1, 2, or 3. Through search points (iPosHor, iPox Ver) in each search sub-region, i.e., each block vector (BV, consisting of horizontal and vertical components: (pX, pY), where pX=iPosHor-xTbCmp, pY=iPosVer-yTbCmp, pX is between bvXMins and bvXMaxs, and pY is between bvYMins and bvYMaxs), a reference block that matches the current block may be found in the reconstructed region, and the neighboring reconstructed samples of the reference block are the matching template. Thus, the matching cost between the first template of the current block and the matching template may be calculated, which is represented as pDiff.

In this way, all search points in all search ranges (regionId=0, 1, 2, 3) are traversed, and a search point with the minimum matching cost (pDiff) is obtained by comparison; the matching cost corresponding to the search point is represented as pDiff_BEST, and the block vector corresponding to the search point is represented as the best block vector (BV_BEST, i.e., (pX_BEST, pY_BEST)), which is the target block vector described in the embodiments; the best matching template (T_BEST) corresponding to the best block vector is the matching template finally required.

In S2002, model parameters are determined according to the first template and the matching template.

It should be noted that, in the embodiments of the present disclosure, the model parameters may include coefficients of a target filter. In some embodiments, the method may further include: determining the coefficients of the target filter according to a sample reference value in the first template and a sample reference value in the matching template.

It should also be noted that, in the embodiments of the present disclosure, the coefficients of the target filter may be determined by solving an optimization problem. Accordingly, in some embodiments, the method may further include: that the coefficients of the target filter are coefficients used by the target filter in a case where a first error between an output value of the sample reference value in the matching template after being processed by the target filter and the sample reference value in the first template meets a first condition.

It should be understood that, for the case that the first error meets the first condition, in a possible implementation, the first condition is that the first error is minimum. Alternatively, in another possible implementation, the first condition is that the first error is within a first preset threshold range. Alternatively, in yet another possible implementation, the first condition is that a variation of the first error is within a second preset threshold range.

It should also be understood that the first preset threshold range and the second preset threshold range are both measurement criteria set in advance by the decoding side for determining whether the first error meets the first condition. In addition, the first error may be the mean square error (MSE), or may be the sum of square error (SSE), or may be the sum of absolute difference (SAD), or may be the sum of absolute Hadamard transformed difference (SATD), or may be the mean absolute error (MAE), which is not specifically limited in the embodiments of the present disclosure.

In some embodiments, determining the coefficients of the target filter according to the sample reference value in the first template and the sample reference value in the matching template may include:
determining an autocorrelation parameter according to the sample reference value in the matching template;
determining a cross-correlation parameter according to the sample reference value in the first template and the sample reference value in the matching template; and
determining the coefficients of the target filter according to the autocorrelation parameter and the cross-correlation parameter.

It should be noted that, in the embodiments of the present disclosure, the sample reference value includes at least one of the following: a sample reconstructed value, a sample gradient value, or sample position information.

That is, in the embodiments of the present disclosure, the target filter serves as a filter model in the embodiments of the present disclosure, and input information of the target filter is the sample reference value in the matching template. Here, the coefficients of the target filter may be represented by c_{k,l}, which may also be referred to as filter coefficients in the embodiments. The input information for calculating the filter coefficients may be available reconstructed samples in the matching template. Alternatively, a gradient of each reconstructed sample in the matching template may be calculated, and the calculated gradients are used as the input information for calculating the filter coefficients, where the gradients include but not limited to a horizontal gradient, a vertical gradient, etc. Alternatively, position information of each reconstructed sample is used as the input information for calculating the filter coefficients, where the position information may be absolute position information of each reconstructed sample in an entire picture, or relative position information of each reconstructed sample relative to a certain reference point, which is not specifically limited here.

In an embodiment, a reconstructed region (R) for calculating the filter coefficients is first determined, and then a group of filter coefficients may be derived by minimizing MSE between the reconstructed samples in the region (R) and the reconstructed samples in the first template, which is described in the above-mentioned formulas (3) and (4).

Furthermore, the process of deriving the filter coefficients by minimizing MSE is as follows.

First, a partial derivative of c_{k,l} is calculated and is set to 0, which is described in the above-mentioned formulas (5) and (6); k and/are between −1 and 1, and m and n are between −1 and 1.

Second, according to formulas (5) and (6), the equation (7) is obtained.

Third, after the reconstructed region (R) is determined, the equation (7) is expanded into a matrix form, which is described in the above-mentioned formulas (8) to (10).

In this way, since the autocorrelation matrix of refTemp in the reconstructed region (R) and the cross-correlation vector of refTemp and recTemp are known quantities, the filter coefficients c_{k,l} may be calculated by solving the equation group shown in equation (7). The filter coefficients c_{k,l} may be or may not be processed by point-fixing.

In addition, in the embodiments of the present disclosure, for the target filter, it is also necessary to determine the number of coefficients of the target filter and a shape of the target filter. The number of coefficients of the target filter and the shape of the target filter may be fixed values set in advance, or may be associated with the size of the current block.

In some embodiments, for the number of coefficients of the target filter, the method may further include: that the number of coefficients of the target filter is equal to a first preset value.

In some embodiments, for the number of coefficients of the target filter, the method may further include: determining the number of coefficients of the target filter; encoding the number of coefficients of the target filter to signal obtained encoded bits into a bitstream.

It should be noted that the number of coefficients of the target filter may be represented by n Tap. For example, the value of n Tap may be 4, 5, 6, 7, 8, or 9, which is not specifically limited.

It should also be noted that the number of coefficients of the target filter may also be referred to as the number of taps of the target filter. Here, the number of coefficients of the target filter may be a preset constant value, or may be determined according to the size of the current block, which is not specifically limited here.

In some embodiments, for the shape of the target filter, the method may further include: that the target filter is a one-dimensional or two-dimensional filter of a preset shape.

In some embodiments, for the shape of the target filter, the method may further include: determining the shape of the target filter; encoding the shape of the target filter to signal obtained encoded bits into a bitstream.

In some embodiments, the method may further include: determining a value of a filter shape parameter, where the filter shape parameter indicates the shape of the target filter. Furthermore, the method may further include: encoding the value of the filter shape parameter to signal obtained encoded bits into a bitstream.

It should be noted that the filter shape parameter may be represented by FilterIdx, and FilterIdx is used to indicate the shape of the target filter. For example, the target filter may be in a shape of a diamond, a rectangle, a cross, or a stripe, or may even be a one-dimensional filter or a two-dimensional filter, which is not specifically limited.

For example, if the value of FilterIdx is equal to 0, the shape of the target filter is determined to be the diamond; if the value of FilterIdx is equal to 1, the shape of the target filter is determined to be the cross; if the value of FilterIdx is equal to 2, the shape of the target filter is determined to be the rectangle.

It should also be noted that the shape of the target filter may be a preset shape, or may be determined by the value of the filter shape parameter, or may even be determined according to the size of the current block, which is not specifically limited here.

In S2003, filtering is performed on the reference block according to the model parameters to determine a filtered reference block.

In S2004, a prediction value of the current block is determined according to the filtered reference block.

It should be noted that, in the embodiments of the present disclosure, after the model parameters are determined, the prediction value of the current block may be determined according to the model parameters and the reference block. Optionally, the reference block is filtered according to the model parameters, and then the prediction value of the current block is determined according to the filtered reference block.

In some embodiments, performing filtering on the reference block according to the model parameters to determine the filtered reference block may include: performing filtering on the reference block according to the model parameters to determine a first output value of the target filter; and determining the filtered reference block based on the first output value of the target filter.

In the embodiments of the present disclosure, the first output value of the target filter may be calculated according to the sample reconstructed values of the reference block and the coefficients of the target filter in the model parameters, and then the filtered reference block may be determined according to the first output value of the target filter. Here, the target filter may be a linear filter model, or may be a nonlinear filter model, which is not specifically limited.

In a possible implementation, performing filtering on the reference block according to the model parameters to determine the first output value of the target filter may include:
calculating a product of a sample reconstructed value of the reference block and a corresponding coefficient of the target filter; and
setting the first output value of the target filter to be equal to a sum of n products, where n represents the number of coefficients of the target filter, and n is a positive integer.

It should be noted that the target filter in the embodiments of the present disclosure is a linear filter model. The first output value of the target filter may be calculated using the above-mentioned formula (11).

In another possible implementation, performing filtering on the reference block according to the model parameters to determine the first output value of the target filter may include:
determining a first value of a sample reconstructed value of the reference block under a first mapping relationship;
calculating a product of the first value and a corresponding coefficient of the target filter; and
setting the first output value of the target filter to be equal to a sum of n products, where n represents the number of coefficients of the target filter, and n is a positive integer.

It should be noted that the target filter in the embodiments of the present disclosure is a nonlinear filter model. For example, in a case where MSE of the filter coefficients is minimized, it may be calculated by the above-mentioned formulas (12) and (13).

It should also be noted that, in the embodiments of the present disclosure, the filtered reference block is determined based on the first output value of the target filter, which may be that the first output value of the target filter is directly set as the filtered reference block, or first filtering is performed on the first output value of the target filter to obtain the filtered reference block. Here, the first filtering may be a low-pass filtering, an up/down sampling filtering, etc., which is not specifically limited here.

It should also be noted that, in the embodiments of the present disclosure, after the first output value of the target filter is determined, a first offset value (represented by bias) may be added to the first output value to determine the filtered reference block.

In some embodiments, determining the filtered reference block based on the first output value of the target filter may include: determining a first offset value; and performing an addition operation according to the first output value and the first offset value to determine the filtered reference block.

In a possible implementation, determining the first offset value may include: setting the first offset value to be equal to a second preset value.

In another possible implementation, determining the first offset value may include: if the number of coefficients of the target filter is n, determining an (n+1)th coefficient of the target filter; and determining the first offset value according to the (n+1)th coefficient and a second offset value.

In the embodiments of the present disclosure, for the second offset value, the method may further include: setting the second offset value to be equal to a third preset value; or setting the second offset value to be equal to a value of a sample reconstructed value of the reference block under a second mapping relationship.

It should be noted that, in the embodiments of the present disclosure, the calculated filter coefficients are used as the number of taps corresponding to the filter template. That is, the number of filter coefficients is equal to the number of taps (nTap) of the filter template. In addition, several bias terms (bias) may be added to the filter template. For example, in the embodiments of the present disclosure, when nTap=5, the filter coefficients are the tap coefficients c₀ to c₄ corresponding to the filter template, and the prediction value at the position (i, j) in the filtered reference block is calculated, and the calculation is shown in the above-mentioned formulas (14) and (15).

Furthermore, in some embodiments, determining the prediction value of the current block according to the filtered reference block may include: performing first processing on the filtered reference block to obtain the prediction value of the current block.

In the embodiments of the present disclosure, for the first processing, the first processing may be that the prediction value of the current block is set to be equal to the filtered reference block. Alternatively, the first processing may be a clipping operation that limits the filtered reference block within a preset value range. Alternatively, the first processing may be any other operation, which is not specifically limited here.

Herein, for the clipping operation, the preset value range may be a range from 0 to (1<<BitDepth)−1, where BitDepth represents a bit depth. If the value of the filtered reference block exceeds the preset value range, then a corresponding correction operation needs to be performed on the filtered reference block. For example, the filtered reference block may also be represented by Y^{pred}[i][j], and in this case, the correction operation can be performed on Y^{pred}[i][j], as follows:

```
  in a case where the value of Y^{pred}[i][j] is less than 0, it is set to 0;
  in a case where the value of Y^{pred}[i][j] is greater than or equal to 0 and
less than or equal to (1<<BitDepth)−1, it is equal to Y^{pred}[i][j]; and
  in a case where the value of Y^{pred}[i][j] is greater than (1<<BitDepth)−1,
it is set to (1<<BitDepth)−1.
```

In this way, after the correction operation is performed on Y^{pred}[i][j], it may be ensured that all sample values in the filtered reference block are between 0 and (1<<BitDepth)−1.

Furthermore, the number of filter models may be expanded. In addition to establishing only one filter model, a plurality of filter models may also be established. Therefore, in some embodiments, the method may further include:
determining a plurality of groups of model parameters according to the first template and the matching template;
constructing a plurality of filter models according to the plurality of groups of model parameters, and performing filtering on the reference block according to the plurality of filter models to determine a plurality of filtered reference blocks respectively; and
determining the prediction value of the current block according to the plurality of filtered reference blocks.

In some embodiments, determining the plurality of groups of model parameters according to the first template and the matching template may include: classifying reconstructed samples in the first template and reconstructed samples in the matching template according to a preset manner to obtain a plurality of groups of sub-templates and a plurality of groups of matching sub-templates respectively; and determining the plurality of groups of model parameters according to the plurality of groups of sub-templates and the plurality of groups of matching sub-templates.

It should be noted that, in the embodiments of the present disclosure, the preset manner here may be a size of the reconstructed sample value, or may be position information of the reconstructed sample, or may be a shape of the filter, which is not limited. After the classification is performed according to the preset manner, each group of sub-templates and corresponding matching sub-templates can be used to calculate a group of model parameters, and each group of model parameters can determine one filter model, so that the plurality of filter models may be constructed.

In a possible implementation, the method may further include: determining a target filter from the plurality of filter models; and performing filtering on the reference block according to the target filter to determine the prediction value of a current block.

Furthermore, in some embodiments, the method may further include: determining a target model index value, where the target model index value is used to indicate an index sequence number of the target filter in the plurality of filter models; encoding the target model index value to signal obtained encoded bits into a bitstream.

Furthermore, in some embodiments, determining the target filter from the plurality of filter models may include: determining an original value of the current block; performing a rate-distortion cost calculation according to the original value of the current block and a plurality of initial prediction values of the current block to determine respective rate-distortion cost values of the plurality of initial prediction values; determining a minimum rate-distortion cost value from the respective rate-distortion cost values of the plurality of initial prediction values; and using a filter model corresponding to the minimum rate-distortion cost value as the target filter.

In another possible implementation, the plurality of filtered reference blocks may be determined by performing filtering on the reference block according to the plurality of filter models respectively. In some embodiments, determining the prediction value of the current block according to the plurality of filtered reference blocks may include: performing a weighted calculation on the plurality of filtered reference blocks to determine the prediction value of the current block.

It should be noted that, if the weight value of each filtered reference block is the same and equal to the inverse of the number of reference blocks, then the weighted calculation here may also be regarded as a mean value calculation. In other words, the mean value calculation is performed on the plurality of filtered reference blocks to determine the prediction value of the current block.

Exemplarily, the input information for calculating the filter coefficients is classified, and a filter model is established for each category of input information. For example, in a case where reconstructed information is used to establish filter models, one possible implementation is that classifying is performed through the mean value of the reconstructed information, the reconstructed information greater than the mean value is used to establish a filter model, and the reconstructed information less than the mean value is used to establish a filter model. Another possible implementation is that classifying is performed using the positions of the reconstructed information. For example, a filter model may be established using available reconstructed information on the left and top sides, and a second filter model may be established using available reconstructed information on the left and top-left sides, and so on. The encoding side determines which model to be used. One possible decision-making mode is that the encoding side determines which model to be used through rate-distortion optimization and transmits corresponding decoding parameters to the decoding side, so that the decoding side may clearly select which filter model. Yet another possible implementation is that classifying is performed using the shapes of filters, a plurality of filters with different shapes can be used, and a filter model is established for the filter of each shape. The encoding side determines which shape of filter to be used. One possible decision-making mode is that the decoding side determines which filter to be used through rate-distortion optimization and transmits corresponding decoding parameters to the decoding side, so that the decoding side may clearly select which filter model.

In S2005, a prediction residual of the current block is determined according to the prediction value of the current block.

It should be noted that, in the embodiments of the present disclosure, after the prediction value of the current block is determined, the prediction residual of the current block may also be calculated. In some embodiments, determining the prediction residual of the current block according to the prediction value of the current block may include: determining an original value of the current block; and determining the prediction residual of the current block according to the original value of the current block and the prediction value of the current block.

In an embodiment, determining the prediction residual of the current block according to the original value of the current block and the prediction value of the current block may include: performing a subtraction operation on the original value of the current block and the prediction value of the current block to determine the prediction residual of the current block.

It should also be noted that, in the embodiments of the present disclosure, whether intra template matching is applied to the current block or whether a filter model is applied to the current block may be determined by different syntax element flag information. In some embodiments, the method may further include: determining a value of first syntax element flag information, where the first syntax element flag information is used to indicate whether intra template matching is applied to the current block; and encoding the value of the first syntax element flag information to signal obtained encoded bits into a bitstream.

In the embodiments of the present disclosure, determining the value of the first syntax element flag information may include: if the intra template matching is applied to the current block, determining the value of the first syntax element flag information to be a first value; or if the intra template matching is not applied to the current block, determining the value of the first syntax element flag information to be a second value.

Furthermore, in some embodiments, in a case where the first syntax element flag information is used to indicate that the intra template matching is applied to the current block, the method may further include: determining a value of the second syntax element flag information, where the second syntax element flag information is used to indicate whether the a filter model is applied to the current block; and encoding the value of the second syntax element flag information to signal obtained encoded bits into a bitstream.

In the embodiments of the present disclosure, determining the value of the second syntax element flag information may include: if the filter model is applied to the current block, determining the value of the second syntax element flag information to be a first value; or if the filter model is not applied to the current block, determining the value of the second syntax element flag information to be a second value.

Furthermore, in some embodiments, the method may further include:
if the filter model is applied to the current block, performing filtering on the reference block according to the model parameters to determine the filtered reference block; and determining the prediction value of the current block according to the filtered reference block; and
if the filter model is not applied to the current block, using a reconstructed sample value in the reference block as the prediction value of the current block.

It should be noted that, in the embodiments of the present disclosure, the first value is different from the second value, and the first value and the second value may be in parameter form, or may be in digital form. Optionally, the first syntax element flag information and the second syntax element flag information may be parameters written into a profile, or may be values of flag, which is not specifically limited here. For example, for the first value and the second value, the first value may be set to 1, and the second value may be set to 0. Alternatively, the first value may be set to true, and the second value may be set to false, which is not specifically limited here.

It should also be noted that, in the embodiments of the present disclosure, whether the current block uses the filtered reference block as the final prediction value is determined by certain conditions, which is not limited to the following three modes. For example, the three modes may be as follows:

Mode 1: whether to perform filtering on the matching template is determined by comparing the distortion between the matching template and the template of the current block (e.g., SAD, or MSE, or SATD, or SSE) with the threshold T_Distortion1;

Mode 2: on the basis of using the filter model in mode 1, the distortion between the filtered matching template and the template of the current block (e.g., SAD, or MSE, or SATD, or SSE) and the threshold T_Distortion2 are used to determine whether to filter the reference block.

Mode 3: the encoding side transmits Flag to indicate whether the filter model is applied. tmpFlag indicates whether the intra template matching is applied to the current block, and filterFlag indicates whether the filter model is applied to the current block. When tmpFlag is 1, the encoding side determines whether to perform filtering on the reference block by comparing the distortion between the reference block and the current block before and after filtering, such as SAD, MSE, SATD, or SSE. If the distortion after filtering is less than the distortion before filtering, filterFlag is set to 1, and the current block uses the filtered reference block as the prediction block. Otherwise, filterFlag is set to 0, the current block uses the reference block before filtering as the prediction block, and the encoding side transmits filterFlag to the decoding side.

Furthermore, embodiments of the present disclosure further provide a bitstream. The bitstream is generated by bit encoding according to information to be encoded. The information to be encoded includes at least one of the following: a prediction residual of a current block, the number of coefficients of a target filter, a shape of the target filter, a value of first syntax element flag information, and a value of second syntax element flag information.

In the embodiments of the present disclosure, the first syntax element flag information is used to indicate whether intra template matching is applied to the current block, and the second syntax element flag information is used to indicate whether a filter model is applied to the current block.

The embodiments provide an encoding method, and the method includes: determining a first template of the current block, and determining a matching template and a reference block; determining model parameters according to the first template and the matching template; performing filtering on the reference block according to the model parameters to determine a filtered reference block; determining a prediction value of the current block according to the filtered reference block; and determining a prediction residual of the current block according to the prediction value of the current block. In this way, the model parameters are determined according to the first template and the matching template. The model parameters fully reflect a correlation between the matching template and the first template of the current block; and this correlation is applied to the reference block to filter and correct reconstructed samples of the reference block, and then the filtered reconstructed samples are used as predicted samples of the current block. Thus, it is possible to improve prediction accuracy, and save bit rate. In addition, encoding and decoding efficiency may also be improved, thereby improving encoding and decoding performance.

In yet another embodiment of the present disclosure, based on the same inventive concept as the aforementioned embodiments, referring to FIG. 21, it shows a component structure of an encoder provided in embodiments of the present disclosure. As illustrated in FIG. 21, the encoder 210 may include: a first determining unit 2101, a first filtering unit 2102, and a first predicting unit 2103.

The first determining unit 2101 is configured to determine a first template of a current block and to determine a matching template and a reference block, and is further configured to determine model parameters according to the first template and the matching template.

The first filtering unit 2102 is configured to perform filtering on the reference block according to the model parameters to determine a filtered reference block.

The first predicting unit 2103 is configured to determine a prediction value of the current block according to the filtered reference block.

The first determining unit 2101 is further configured to determine a prediction residual of the current block according to the prediction value of the current block.

In some embodiments, the first determining unit 2101 is further configured to: determine a template type of the current block; and determine the first template of the current block according to the template type of the current block.

In some embodiments, the first determining unit 2101 is further configured to determine the template type of the current block according to reference samples of the current block. The reference samples of the current block include at least one of the following: left neighboring reference samples of the current block, top neighboring reference samples of the current block, top-left neighboring reference samples of the current block, bottom-left neighboring reference samples of the current block, or top-right neighboring reference samples of the current block.

In some embodiments, the first determining unit 2101 is further configured to: determine the template type of the current block to be a first value if the left neighboring reference samples of the current block, the top neighboring reference samples of the current block, and the top-left neighboring reference samples of the current block are all available; determine the template type of the current block to be a second value if the left neighboring reference samples of the current block are available; determine the template type of the current block to be a third value if the top neighboring reference samples of the current block are available; determine the template type of the current block to be a fourth value if both the left neighboring reference samples of the current block and the top-left neighboring reference samples of the current block are available; determine the template type of the current block to be a fifth value if both the left neighboring reference samples of the current block and the bottom-left neighboring reference samples of the current block are available; and determine the template type of the current block to be a sixth value if both the top neighboring reference samples of the current block and the top-right neighboring reference samples of the current block are available.

In some embodiments, the first determining unit 2101 is further configured to: perform template matching within a preset search region according to the first template to determine the matching template; and determine the reference block according to the matching template.

In some embodiments, the first determining unit 2101 is further configured to: perform a search within the preset search region based on the first template to determine a target block vector, and determine the matching template according to the target block vector.

In some embodiments, the first determining unit 2101 is further configured to: determine motion parameters and a corresponding reference block; determine the matching template according to the first template and the reference block; and encode the motion parameters to signal obtained encoded bits into a bitstream.

In some embodiments, the first determining unit 2101 is further configured to: perform a first search within the preset search region to determine the target block vector; or perform a second search within the preset search region to determine the target block vector. A search step corresponding to the first search is greater than a search step corresponding to the second search.

In some embodiments, the first determining unit 2101 is further configured to: perform a first search within the preset search region to determine a first block vector and determine an initial matching template according to the first block vector; and determine a first search region according to the initial matching template and perform a second search within the first search region to determine the target block vector. A search step corresponding to the first search is greater than a search step corresponding to the second search, and the first search region is smaller than the preset search region.

In some embodiments, the preset search region includes at least one search sub-region; the first determining unit 2101 is further configured to: perform the search within the at least one search sub-region to determine a best block vector of each search sub-region and a corresponding matching cost value; determine a best block vector corresponding to a minimum matching cost value according to the best block vector of each search sub-region and the corresponding matching cost value; and use the best block vector corresponding to the minimum matching cost value as the target block vector.

In some embodiments, the first determining unit 2101 is further configured to: perform a first search within the at least one search sub-region to determine a best block vector of each search sub-region and a corresponding second search region; perform a region determination according to the best block vector of each search sub-region and the corresponding second search region to determine at least two target search sub-regions participating in a second search; perform the second search within the at least two target search sub-regions to determine a best block vector corresponding to the at least two target search sub-regions; and use the best block vector corresponding to the at least two target search sub-regions as the target block vector.

In some embodiments, the first determining unit 2101 is further configured such that the model parameters include coefficients of a target filter.

In some embodiments, the first determining unit 2101 is further configured to determine the coefficients of the target filter according to a sample reference value in the first template and a sample reference value in the matching template.

In some embodiments, the first determining unit 2101 is further configured such that the coefficients of the target filter are coefficients used by the target filter in a case where a first error between an output value of the sample reference value in the matching template after being processed by the target filter and the sample reference value in the first template meets a first condition.

In some embodiments, the first determining unit 2101 is further configured such that the first condition is that the first error is minimum.

In some embodiments, the first determining unit 2101 is further configured such that the first condition is that the first error is within a first preset threshold range.

In some embodiments, the first determining unit 2101 is further configured such that the first condition is that a variation of the first error is within a second preset threshold range.

In some embodiments, the first determining unit 2101 is further configured to: determine an autocorrelation parameter according to the sample reference value in the matching template; determine a cross-correlation parameter according to the sample reference value in the first template and the sample reference value in the matching template; and determine the coefficients of the target filter according to the autocorrelation parameter and the cross-correlation parameter.

In some embodiments, the first determining unit 2101 is further configured such that the sample reference value includes at least one of: a sample reconstructed value, a sample gradient value, or sample position information.

In some embodiments, the first determining unit 2101 is further configured such that the number of the coefficients of the target filter is equal to a first preset value.

In some embodiments, the first determining unit 2101 is further configured to: determine the number of the coefficients of the target filter; and encode the number of the coefficients of the target filter to signal obtained encoded bits into a bitstream.

In some embodiments, the first determining unit 2101 is further configured such that the target filter is a one-dimensional or two-dimensional filter of a preset shape.

In some embodiments, the first determining unit 2101 is further configured to: determine a shape of the target filter; and encode the shape of the target filter to signal obtained encoded bits into a bitstream.

In some embodiments, the first filtering unit 2102 is further configured to: perform filtering on the reference block according to the model parameters to determine a first output value of the target filter; and determine the filtered reference block based on the first output value of the target filter.

In some embodiments, the first filtering unit 2102 is further configured to: calculate a product of a sample reconstructed value of the reference block and a corresponding coefficient of the target filter; and set the first output value of the target filter to be equal to a sum of n products, where n represents the number of the coefficients of the target filter, and n is a positive integer.

In some embodiments, the first filtering unit 2102 is further configured to: determine a first value of a sample reconstructed value of the reference block under a first mapping relationship; calculate a product of the first value and a corresponding coefficient of the target filter; and set the first output value of the target filter to be equal to a sum of n products, where n represents the number of the coefficients of the target filter, and n is a positive integer.

In some embodiments, the first filtering unit 2102 is further configured to: determine a first offset value; and perform an addition operation according to the first output value and the first offset value to determine the filtered reference block.

In some embodiments, the first filtering unit 2102 is further configured to set the first offset value to be equal to a second preset value.

In some embodiments, the first filtering unit 2102 is further configured to: determine an (n+1)th coefficient of the target filter if the number of the coefficients of the target filter is n; and determine the first offset value according to the (n+1)th coefficient and a second offset value.

In some embodiments, the first filtering unit 2102 is further configured to: set the second offset value to be equal to a third preset value; or set the second offset value to be equal to a value of a sample reconstructed value of the reference block under a second mapping relationship.

In some embodiments, the first predicting unit 2103 is further configured to perform first processing on the filtered reference block to obtain the prediction value of the current block.

In some embodiments, the first predicting unit 2103 is further configured such that the first processing is that the prediction value of the current block is set to be equal to the filtered reference block.

In some embodiments, the first predicting unit 2103 is further configured such that the first processing is a clipping operation that limits the filtered reference block within a preset value range.

In some embodiments, the first predicting unit 2103 is further configured to: determine a plurality of groups of model parameters according to the first template and the matching template; construct a plurality of filter models according to the plurality of groups of model parameters, and perform filtering on the reference blocks according to the plurality of filter models to determine a plurality of filtered reference blocks respectively; and determine the prediction value of the current block according to the plurality of filtered reference blocks.

In some embodiments, the first predicting unit 2103 is further configured to perform a weighted calculation on the plurality of filtered reference blocks to determine the prediction value of the current block.

In some embodiments, the first predicting unit 2103 is further configured to determine a target filter from the plurality of filter models; and perform filtering on the reference block according to the target filter to determine the prediction value of the current block.

In some embodiments, the first predicting unit 2103 is further configured to: determine a target model index value, where the target model index value is used to indicate an index sequence number of the target filter in the plurality of filter models; and encode the target model index value to signal obtained encoded bits into a bitstream.

In some embodiments, the first predicting unit 2103 is further configured to: determine an original value of the current block; perform a rate-distortion cost calculation according to the original value of the current block and a plurality of initial prediction values of the current block to determine respective rate-distortion cost values of the plurality of initial prediction values; determine a minimum rate-distortion cost value from the respective rate-distortion cost values of the plurality of initial prediction values; and use a filter model corresponding to the minimum rate-distortion cost value as the target filter.

In some embodiments, the first predicting unit 2103 is further configured to: classify reconstructed samples in the first template and reconstructed samples in the matching template according to a preset manner to obtain a plurality of groups of sub-templates and a plurality of groups of matching sub-templates respectively; and determine the plurality of groups of model parameters according to the plurality of groups of sub-templates and the plurality of groups of matching sub-templates.

In some embodiments, the first determining unit 2101 is further configured to: determine a value of first syntax element flag information, where the first syntax element flag information is used to indicate whether intra template matching is applied to the current block; and encode the value of the first syntax element flag information to signal obtained encoded bits into a bitstream.

In some embodiments, the first determining unit 2101 is further configured to: determine the value of the first syntax element flag information to be a first value if the intra template matching is applied to the current block; and determine the value of the first syntax element flag information to be a second value if the intra template matching is not applied to the current block.

In some embodiments, the first determining unit 2101 is further configured to determine a value of second syntax element flag information, where the second syntax element flag information is used to indicate whether a filter model is applied to the current block; and encode the value of the second syntax element flag information to signal obtained encoded bits into a bitstream.

In some embodiments, the first determining unit 2101 is further configured to: determine the value of the second syntax element flag information to be a first value if the filter model is applied to the current block; and determine the value of the second syntax element flag information to be a second value if the filter model is not applied to the current block.

In some embodiments, the first determining unit 2101 is further configured to: if the filter model is applied to the current block, execute a step of performing filtering on the reference block according to the model parameters to determine the filtered reference block and determining the prediction value of the current block according to the filtered reference block; and if the filter model is not applied to the current block, use a reconstructed sample value in the reference block as the prediction value of the current block.

In some embodiments, the first determining unit 2101 is further configured to: determine an original value of the current block; and determine the prediction residual of the current block according to the original value of the current block and the prediction value of the current block.

It can be understood that, in the embodiments of the present disclosure, the “unit” may be a part of a circuit, a part of a processor, a part of a program or software, or the like. Of course, the “unit” may also be a module, or it may be non-modular. Furthermore, various components in the embodiments may be integrated into one processing unit, or various units may be physically present separately, or two or more units may be integrated in one unit. The above integrated unit may be implemented in the form of hardware or in the form of software function modules.

The integrated unit, if implemented in the form of software functional modules and sold or used as a non-independent product, may be stored in a non-transitory computer-readable storage medium. With such understanding, the technical solutions of the embodiments may be embodied in the form of a software product in essence, or a part of the technical solutions that contributes to the prior art or a part of the technical solutions may be embodied in the form of a software product. The computer software product is stored in a non-transitory storage medium and includes a number of instructions for enabling a computer device (which may be a personal computer, a server, or a network device) or a processor to perform all or some of the steps of the method described in the embodiments. The non-transitory storage medium includes a U disk, a mobile hard disk, a read-only memory (ROM), a random access memory (RAM), a magnetic disk, an optical disk, or any medium capable of storing program codes.

Therefore, embodiments of the present disclosure provide a non-transitory computer-readable storage medium, which is applied to the encoder 210. The non-transitory computer-readable storage medium has stored a computer program. The computer program, when executed by a first processor, implements the encoding method described in any one of the aforementioned embodiments.

Based on the component of the encoder 210 and the non-transitory computer-readable storage medium, referring to FIG. 22, it shows a specific hardware structure of the encoder 210 provided in the embodiments of the present disclosure. As illustrated in FIG. 22, the encoder 210 may include: a first communication interface 2201, a first memory 2202, and a first processor 2203. The various components are coupled together via a first bus system 2204. It can be understood that the first bus system 2204 is configured to implement connection and communication between these components. The first bus system 2204 includes not only a data bus but also a power bus, a control bus and a status signal bus. However, for the sake of clarity, various buses are marked as the first bus system 2204 in FIG. 22.

The first communication interface 2201 is configured to receive and transmit signals during a process of receiving and transmitting information with other external network elements.

The first memory 2202 is configured to store a computer program that is capable of running on the first processor 2103.

The first processor 2203 is configured to, when running the computer program, perform: determining a first template of a current block, and determining a matching template and a reference block;
determining model parameters according to the first template and the matching template;
performing filtering on the reference block according to the model parameters to determine a filtered reference block;
determining a prediction value of the current block according to the filtered reference block; and
determining a prediction residual of the current block according to the prediction value of the current block.

It can be understood that, the first memory 2202 in the embodiments of the present disclosure may be a volatile memory or a non-volatile memory, or may include both volatile and non-volatile memories. The non-volatile memory may be a read-only memory (ROM), a programmable ROM (PROM), an erasable PROM (EPROM), an electrically EPROM (EEPROM), or a flash memory. The volatile memory may be a random access memory (RAM), which serves as an external cache. As an example, but not as a limitation, many forms of RAMs are available, such as a static RAM (SRAM), a dynamic RAM (DRAM), a synchronous DRAM (SDRAM), a double data rate SDRAM (DDR SDRAM), an enhanced SDRAM (ESDRAM), a synchlink DRAM (SLDRAM), and a direct rambus RAM (DR RAM). The first memory 2202 in the system and method described in the present disclosure is intended to include, but is not limited to, these and any other suitable type of memories.

The first processor 2203 may be an integrated circuit chip with signal processing capability. During implementation, each step of the above methods may be completed by an integrated logic circuit of hardware in the first processor 2203 or by instructions in a software form. The first processor 2203 may be a general-purpose processor, a digital signal processor (DSP), an application specific integrated circuit (ASIC), a field programmable gate array (FPGA) or another programmable logic device, a discrete gate or transistor logic device, or a discrete hardware component. The first processor 2203 may implement or perform various methods, steps and logic diagrams disclosed in the embodiments of the present disclosure. The general-purpose processor may be a microprocessor, or the processor may be any conventional processor. The steps of the methods disclosed in combination with the embodiments of the present disclosure may be directly embodied by execution of a hardware decoding processor, or by execution of a combination of hardware and software modules in a decoding processor. The software modules may be located in a non-transitory storage medium commonly used in the art, such as a random access memory, a flash memory, a read-only memory, a programmable read-only memory or an electrically erasable programmable memory, or a register. The non-transitory storage medium is located in the first memory 2202, and the first processor 2203 reads information in the first memory 2202 and completes the steps of the above methods in combination with hardware of the first memory 2202.

It can be understood that, the embodiments described in the present disclosure may be implemented by hardware, software, firmware, middleware, microcode, or a combination thereof. For hardware implementation, the processing unit may be implemented in one or more application specific integrated circuits (ASIC), digital signal processors (DSP), digital signal processing devices (DSPD), programmable logic devices (PLD), field programmable gate arrays (FPGA), general-purpose processors, controllers, microcontrollers, microprocessors, other electronic units for performing the functions described in the present disclosure, or combinations thereof. For software implementation, the technology described in the present disclosure may be implemented through modules (such as procedures, or functions) that perform the functions described in the present disclosure. The software codes may be stored in a memory and executed by a processor. The memory may be implemented within the processor or external to the processor.

Optionally, as another embodiment, the first processor 2203 is further configured to perform the encoding method described in any one of the aforementioned embodiments when running the computer program.

The embodiments provide an encoder, and for the encoder, model parameters are determined according to a first template and a matching template. The model parameters fully reflect a correlation between the matching template and a first template of a current block, and the correlation is applied to a reference block, which may effectively correct a prediction value of the intra template matching technology, thereby improving prediction accuracy and saving bit rat. In addition, encoding and decoding efficiency may also be improved, thereby improving encoding and decoding performance.

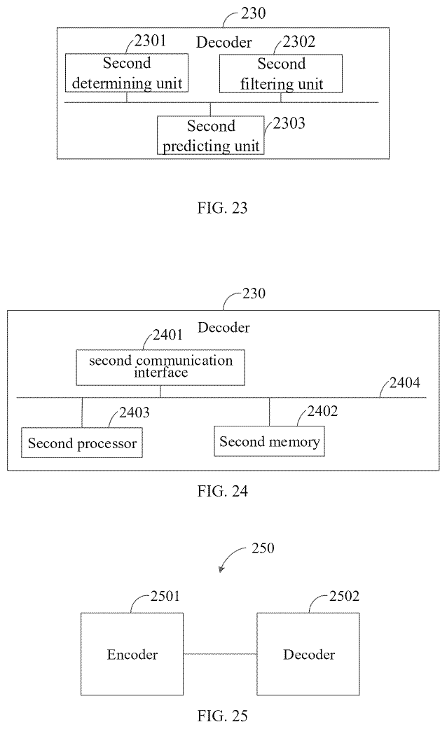

In yet another embodiment of the present disclosure, based on the same inventive concept as the aforementioned embodiments, referring to FIG. 23, it shows a component structure of a decoder 230 provided in embodiments of the present disclosure. As illustrated in FIG. 23, the decoder 230 may include: a second determining unit 2301, a second filtering unit 2302, and a second predicting unit 2303.

The second determining unit 2301 is configured to determine a first template of a current block and determine a matching template and a reference block, and is further configured to determine model parameters according to the first template and the matching template.

The second filtering unit 2302 is configured to perform filtering on the reference block according to the model parameters to determine a filtered reference block.

The second predicting unit 2303 is configured to determine a prediction value of the current block according to the filtered reference block.

The second determining unit 2301 is further configured to determine a reconstructed value of the current block according to the prediction value of the current block.

In some embodiments, the second determining unit 2301 is further configured to: determine a template type of the current block; and determine the first template of the current block according to the template type of the current block.

In some embodiments, the second determining unit 2301 is further configured to determine the template type of the current block according to reference samples of the current block, where the reference samples of the current block include at least one of: left neighboring reference samples of the current block, top neighboring reference samples of the current block, top-left neighboring reference samples of the current block, bottom-left neighboring reference samples of the current block, or top-right neighboring reference samples of the current block.

In some embodiments, the second determining unit 2301 is further configured to: determine the template type of the current block to be a first value if the left neighboring reference samples of the current block, the top neighboring reference samples of the current block, and the top-left neighboring reference samples of the current block are all available; determine the template type of the current block to be a second value if the left neighboring reference samples of the current block are available; determine the template type of the current block to be a third value if the top neighboring reference samples of the current block are available; determine the template type of the current block to be a fourth value if both the left neighboring reference samples of the current block and the top-left neighboring reference samples of the current block are available; determine the template type of the current block to be a fifth value if both the left neighboring reference samples of the current block and the bottom-left neighboring reference samples of the current block are available; and determine the template type of the current block to be a sixth value if both the top neighboring reference samples of the current block and the top-right neighboring reference samples of the current block are available.

In some embodiments, the second determining unit 2301 is further configured to: perform template matching within a preset search region according to the first template to determine the matching template; and determine the reference block according to the matching template.

In some embodiments, the second determining unit 2301 is further configured to: perform a search within the preset search region based on the first template to determine a target block vector, and determine the matching template according to the target block vector.

In some embodiments, the second determining unit 2301 is further configured to: decode a bitstream to determine motion parameters; determine the reference block according to the motion parameters; and determine the matching template according to the first template and the reference block.

In some embodiments, the second determining unit 2301 is further configured to: perform a first search within the preset search region to determine the target block vector; or perform a second search within the preset search region to determine the target block vector. A search step corresponding to the first search is greater than a search step corresponding to the second search.

In some embodiments, the second determining unit 2301 is further configured to: perform a first search within the preset search region to determine a first block vector and determine an initial matching template according to the first block vector; and determine a first search region according to the initial matching template, and perform a second search within the first search region to determine the target block vector. A search step corresponding to the first search is greater than a search step corresponding to the second search, and the first search region is smaller than the preset search region.

In some embodiments, the preset search region includes at least one search sub-region; the second determining unit 2301 is further configured to: perform the search within the at least one search sub-region to determine a best block vector of each search sub-region and a corresponding matching cost value; determine a best block vector corresponding to a minimum matching cost value according to the best block vector of each search sub-region and the corresponding matching cost value; and use the best block vector corresponding to the minimum matching cost value as the target block vector.

In some embodiments, the second determining unit 2301 is further configured to: perform a first search within the at least one search sub-region to determine a best block vector of each search sub-region and a corresponding second search region; perform a region determination according to the best block vector of each search sub-region and the corresponding second search region to determine at least two target search sub-regions participating in a second search; perform the second search within the at least two target search sub-regions to determine a best block vector corresponding to the at least two target search sub-regions; and use the best block vector corresponding to the at least two target search sub-regions as the target block vector.

In some embodiments, the second determining unit 2301 is further configured such that the model parameters include coefficients of the target filter.

In some embodiments, the second determining unit 2301 is further configured to determine the coefficients of the target filter according to a sample reference value in the first template and a sample reference value in the matching template.

In some embodiments, the second determining unit 2301 is further configured such that the coefficients of the target filter are coefficients used by the target filter in a case where a first error between an output value of the sample reference value in the matching template after being processed by the target filter and the sample reference value in the first template meets a first condition.

In some embodiments, the second determining unit 2301 is further configured such that the first condition is that the first error is minimum.

In some embodiments, the second determining unit 2301 is further configured such that the first condition is that the first error is within a first preset threshold range.

In some embodiments, the second determining unit 2301 is further configured such that the first condition is that a variation of the first error is within a second preset threshold range.

In some embodiments, the second determining unit 2301 is further configured to: determine an autocorrelation parameter according to the sample reference value in the matching template; determine a cross-correlation parameter according to the sample reference value in the first template and the sample reference value in the matching template; and determine the coefficients of the target filter according to the autocorrelation parameter and the cross-correlation parameter.

In some embodiments, the second determining unit 2301 is further configured such that the sample reference value includes at least one of: a sample reconstructed value, a sample gradient value, or sample position information.

In some embodiments, the second determining unit 2301 is further configured such that the number of the coefficients of the target filter is equal to a first preset value.

In some embodiments, the second determining unit 2301 is further configured to decode a bitstream to determine the number of the coefficients of the target filter.

In some embodiments, the second determining unit 2301 is further configured such that the target filter is a one-dimensional or two-dimensional filter of a preset shape.

In some embodiments, the second determining unit 2301 is further configured to decode a bitstream to determine a shape of the target filter.

In some embodiments, the second filtering unit 2302 is further configured to: perform filtering on the reference block according to the model parameters to determine a first output value of the target filter; and determine the filtered reference block based on the first output value of the target filter.

In some embodiments, the second filtering unit 2302 is further configured to: calculate a product of a sample reconstructed value of the reference block and a corresponding coefficient of the target filter; and set the first output value of the target filter to be equal to a sum of n products, where n represents the number of the coefficients of the target filter, and n is a positive integer.

In some embodiments, the second filtering unit 2302 is further configured to: determine a first value of a sample reconstructed value of the reference block under a first mapping relationship; calculate a product of the first value and a corresponding coefficient of the target filter; and set the first output value of the target filter to be equal to a sum of n products, where n represents the number of the coefficients of the target filter, and n is a positive integer.

In some embodiments, the second filtering unit 2302 is further configured to: determine a first offset value; and perform an addition operation according to the first output value and the first offset value to determine the filtered reference block.

In some embodiments, the second filtering unit 2302 is further configured to set the first offset value to be equal to a second preset value.

In some embodiments, the second filtering unit 2302 is further configured to: determine an (n+1)th coefficient of the target filter if the number of the coefficients of the target filter is n; and determine the first offset value according to the (n+1)th coefficient and a second offset value.

In some embodiments, the second filtering unit 2302 is further configured to: set the second offset value to be equal to a third preset value; or set the second offset value to be equal to a value of a sample reconstructed value of the reference block under a second mapping relationship.

In some embodiments, the second predicting unit 2303 is further configured to perform first processing on the filtered reference block to obtain the prediction value of the current block.

In some embodiments, the second predicting unit 2303 is further configured such that the first processing is that the prediction value of the current block is set to be equal to the filtered reference block.

In some embodiments, the second predicting unit 2303 is further configured such that the first processing is a clipping operation that limits the filtered reference block within a preset value range.

In some embodiments, the second predicting unit 2303 is further configured to: determine a plurality of groups of model parameters according to the first template and the matching template; and construct a plurality of filter models according to the plurality of groups of model parameters, and perform filtering on the reference block according to the plurality of filter models to determine a plurality of filtered reference blocks respectively; and determine the prediction value of the current block according to the plurality of filtered reference blocks.

In some embodiments, the second predicting unit 2303 is further configured to perform a weighted calculation on the plurality of filtered reference blocks to determine the prediction value of the current block.

In some embodiments, the second predicting unit 2303 is further configured to: decode a bitstream to determine a target model index value; determine a corresponding target filter from the plurality of filter models according to the target model index value; and perform filtering on the reference block according to the target filter to determine the prediction value of the current block.

In some embodiments, the second predicting unit 2303 is further configured to: classify reconstructed samples in the first template and reconstructed samples in the matching template according to a preset manner to obtain a plurality of groups of sub-templates and a plurality of groups of matching sub-templates respectively; and determine the plurality of groups of model parameters according to the plurality of groups of sub-templates and the plurality of groups of matching sub-templates.

In some embodiments, the second determining unit 2301 is further configured to: decode a bitstream to determine a value of first syntax element flag information; if the first syntax element flag information is used to indicate that intra template matching is applied to the current block, decode the bitstream to determine a value of second syntax element flag information; and if the second syntax element flag information is used to indicate that a filter model is applied to the current block, execute a step of performing filtering on the reference block according to the model parameters to determine the filtered reference block and determining the prediction value of the current block according to the filtered reference block.

In some embodiments, the second determining unit 2301 is further configured to use a reconstructed sample value in the reference block as the prediction value of the current block if the second syntax element flag information is used to indicate that the filter model is not applied to the current block.

In some embodiments, the second determining unit 2301 is further configured to: decode a bitstream to determine a prediction residual of the current block; and determine the reconstructed value of the current block according to the prediction value of the current block and the prediction residual of the current block.

It can be understood that, in the embodiments, the “unit” may be a part of a circuit, a part of a processor, a part of a program or software, or the like. Of course, the “unit” may also be a module, or it may be non-modular. Furthermore, various components in the embodiments may be integrated into one processing unit, or various units may be physically present separately, or two or more units may be integrated in one unit. The above integrated unit may be implemented in the form of hardware or in the form of software function modules.

The integrated unit, if implemented in the form of software functional modules and sold or used as a non-independent product, may be stored in a non-transitory computer-readable storage medium. With such understanding, the embodiments provide a non-transitory computer-readable storage medium, which is applied to the decoder 230. The computer-readable storage medium has stored a computer program. The computer program, when executed by a second processor, implements the decoding method described in any one of the aforementioned embodiments.

Based on the component of the decoder 230 and the non-transitory computer-readable storage medium, referring to FIG. 24, it shows a specific hardware structure of the decoder 230 provided in embodiments of the present disclosure. As illustrated in FIG. 24, the decoder 230 may include: a second communication interface 2401, a second memory 2402, and a second processor 2403. The various components are coupled together via a second bus system 2404. It can be understood that the second bus system 2404 is configured to implement connection and communication between these components. The second bus system 2404 includes not only a data bus but also a power bus, a control bus and a status signal bus. However, for the sake of clarity, various buses are marked as the second bus system 2404 in FIG. 24.

The second communication interface 2401 is configured to receive and transmit signals during a process of receiving and transmitting information with other external network elements.

The second memory 2402 is configured to store a computer program that is capable of running on the second processor 2403.

The second processor 2403 is configured to, when running the computer program, perform:
determining a first template of a current block, and determining a matching template and a reference block;
determining model parameters according to the first template and the matching template;
performing filtering on the reference block according to the model parameters to determine a filtered reference block;
determining a prediction value of the current block according to the filtered reference block; and
determining a reconstructed value of the current block according to the prediction value of the current block.

Optionally, as another embodiment, the second processor 2403 is further configured to perform the decoding method described in any one of the aforementioned embodiments when running the computer program.

It can be understood that, the hardware functions of the second memory 2402 are similar to those of the first memory 2202, and the hardware functions of the second processor 2403 are similar to those of the first processor 2203, which will not be described in detail here.

The embodiments provide a decoder, and for the decoder, model parameters are determined according to a first template and a matching template. The model parameters fully reflect a correlation between the matching template and a first template of a current block, and the correlation is applied to a reference block, which may effectively correct a prediction value of the intra template matching technology, thereby improving prediction accuracy and saving bit rat. In addition, encoding and decoding efficiency may also be improved, thereby improving encoding and decoding performance.

In yet another embodiment of the present disclosure, referring to FIG. 25, it shows a component structure of an encoding and decoding system provided in embodiments of the present disclosure. As illustrated in FIG. 25, the encoding and decoding system 250 may include an encoder 2501 and a decoder 2502.

In the embodiments of the present disclosure, the encoder 2501 may be the encoder described in any one of the aforementioned embodiments, and the decoder 2502 may be the decoder described in any one of the aforementioned embodiments.

It should be noted that, in the present disclosure, the terms “comprise” and “include” or other variations thereof are intended to cover non-exclusive inclusions, so that a process, method, product or apparatus including a series of elements not only includes these elements, but also includes other elements not explicitly listed, or further includes elements inherent to such process, method, product or apparatus. Without more constraints, an element defined by the phrase “comprises a . . . ” does not exclude the existence of other identical elements in the process, method, product or apparatus including the element.

The serial numbers of the embodiments of the present disclosure are for description only and do not represent the advantages or disadvantages of the embodiments.

The methods disclosed in several method embodiments provided in the present disclosure may be arbitrarily combined without conflict to obtain new method embodiments.

The features disclosed in several product embodiments provided in the present disclosure may be arbitrarily combined without conflict to obtain new product embodiments.

The features disclosed in several method or device embodiments provided in the present disclosure may be arbitrarily combined without conflict to obtain new method embodiments or device embodiments.

The foregoing descriptions are merely implementations of the present disclosure, but the protection scope of the present disclosure is not limited thereto. Variations or replacements that any person skilled in the art could readily conceive of within the technical scope disclosed in the present disclosure shall be included in the protection scope of the present disclosure. Therefore, the protection scope of the present disclosure should be subject to the protection scope of the claims.

### INDUSTRIAL APPLICABILITY

In the embodiments of the present disclosure, whether it is the encoding side or the decoding side, the first template of the current block is determined, as well as the matching template and the reference block are determined; the model parameters are determined according to the first template and the matching template; filtering is performed on the reference block according to the model parameters to determine the filtered reference block; and the prediction value of the current block is determined according to the filtered reference block. In this way, the encoding side may determine the prediction residual of the current block according to the prediction value of the current block, so that the decoding side may determine the reconstructed value of the current block according to the prediction value of the current block. That is, the model parameters are determined according to the first template and the matching template, and the model parameters fully reflect a correlation between the matching template and the first template of the current block; and this correlation is applied to the reference block to filter and correct reconstructed samples of the reference block, and then the filtered reconstructed samples are used as predicted samples of the current block. Thus, it is possible to improve prediction accuracy and save bit rate. In addition, encoding and decoding efficiency may also be improved, thereby improving encoding and decoding performance.

What is claimed is:

1. A decoding method, applied to a decoder, wherein the method comprises:
determining a first template of a current block, and determining a matching template and a reference block;
determining model parameters according to the first template and the matching template;
performing filtering on the reference block according to the model parameters to determine a filtered reference block;
determining a prediction value of the current block according to the filtered reference block; and
determining a reconstructed value of the current block according to the prediction value of the current block.

2. The method according to claim 1, wherein determining the first template of the current block comprises:
determining a template type of the current block; and
determining the first template of the current block according to the template type of the current block.

3. The method according to claim 2, wherein determining the template type of the current block comprises:
determining the template type of the current block according to reference samples of the current block, wherein
the reference samples of the current block comprise at least one of: left neighboring reference samples of the current block, top neighboring reference samples of the current block, top-left neighboring reference samples of the current block, bottom-left neighboring reference samples of the current block, or top-right neighboring reference samples of the current block.

4. The method according to claim 3, wherein determining the template type of the current block comprises:
if the left neighboring reference samples of the current block, the top neighboring reference samples of the current block, and the top-left neighboring reference samples of the current block are all available, determining the template type of the current block to be a first value;
if the left neighboring reference samples of the current block are available, determining the template type of the current block to be a second value; or
if the top neighboring reference samples of the current block are available, determining the template type of the current block to be a third value.

5. The method according to claim 1, wherein determining the matching template and the reference block comprises:
performing template matching within a preset search region according to the first template to determine the matching template; and
determining the reference block according to the matching template.

6. The method according to claim 5, wherein performing template matching within the preset search region according to the first template to determine the matching template comprises:
performing a search within the preset search region based on the first template to determine a target block vector, and determining the matching template according to the target block vector.

7. The method according to claim 6, wherein performing the search within the preset search region based on the first template to determine the target block vector comprises:
performing a first search within the preset search region according to a search step corresponding to the first search, to determine the target block vector.

8. The method according to claim 6, wherein performing the search within the preset search region based on the first template to determine the target block vector comprises:
performing a first search within the preset search region according to a search step corresponding to the first search, to determine a first block vector, and determining an initial matching template according to the first block vector; and
determining a first search region according to the initial matching template, and performing a second search within the first search region according to a search step corresponding to the second search, to determine the target block vector, wherein
a search step corresponding to the first search is greater than a search step corresponding to the second search, and the first search region is smaller than the preset search region.

9. The method according to claim 1, further comprising:
the model parameters comprising coefficients of a target filter; and
determining the coefficients of the target filter according to a sample reference value in the first template and a sample reference value in the matching template.

10. The method according to claim 9, further comprising:
that the coefficients of the target filter are coefficients used by the target filter in a case where a first error between an output value of the sample reference value in the matching template after being processed by the target filter and the sample reference value in the first template meets a first condition.

11. The method according to claim 9, wherein determining the coefficients of the target filter according to the sample reference value in the first template and the sample reference value in the matching template comprises:
determining an autocorrelation parameter according to the sample reference value in the matching template;
determining a cross-correlation parameter according to the sample reference value in the first template and the sample reference value in the matching template; and
determining the coefficients of the target filter according to the autocorrelation parameter and the cross-correlation parameter.

12. The method according to claim 9, wherein performing filtering on the reference block according to the model parameters to determine the filtered reference block comprises:
performing filtering on the reference block according to the model parameters to determine a first output value of the target filter; and
determining the filtered reference block based on the first output value of the target filter.

13. The method according to claim 12, wherein performing filtering on the reference block according to the model parameters to determine the first output value of the target filter comprises:
calculating a product of a sample reconstructed value of the reference block and a corresponding coefficient of the target filter; and
setting the first output value of the target filter to be equal to a sum of n products, wherein n represents a number of the coefficients of the target filter, and n is a positive integer.

14. The method according to claim 12, wherein performing filtering on the reference block according to the model parameters to determine the first output value of the target filter comprises:
determining a first value of a sample reconstructed value of the reference block under a first mapping relationship;
calculating a product of the first value and a corresponding coefficient of the target filter; and
setting the first output value of the target filter to be equal to a sum of n products, wherein n represents a number of the coefficients of the target filter, and n is a positive integer.

15. The method according to claim 12, wherein determining the filtered reference block based on the first output value of the target filter comprises:
determining a first offset value; and
performing an addition operation according to the first output value and the first offset value to determine the filtered reference block.

16. The method according to claim 1, wherein determining the prediction value of the current block according to the filtered reference block comprises:
performing a clipping operation on the filtered reference block to determine the prediction value of the current block.

17. A encoding method, applied to an encoder, wherein the method comprises:
determining a first template of the current block, and determining a matching template and a reference block;
determining model parameters according to the first template and the matching template;
performing filtering on the reference block according to the model parameters to determine a filtered reference block;
determining a prediction value of the current block according to the filtered reference block; and
determining a prediction residual of the current block according to the prediction value of the current block.

18. The method according to claim 17, further comprising:
the model parameters comprising coefficients of a target filter; and
determining the coefficients of the target filter according to a sample reference value in the first template and a sample reference value in the matching template.

19. The method according to claim 18, wherein performing filtering on the reference block according to the model parameters to determine the filtered reference block comprises:
performing filtering on the reference block according to the model parameters to determine a first output value of the target filter; and
determining the filtered reference block based on the first output value of the target filter.

20. A non-transitory computer-readable storage medium, wherein the non-transitory computer-readable storage medium has stored a computer program and a bitstream, and the computer program which, when executed by a processor, implements the encoding method according to claim 17 to generate the bitstream.
